(19) United States
(12) Patent Application Publication
(10) Pub. No.: US 2024/0163016 A1
(43) Pub. Date: May 16, 2024

(54) SIDELINK CARRIER AGGREGATION WITH CROSS-CARRIER HARQ FEEDBACK

(71) Applicant: QUALCOMM Incorporated, San Diego, CA (US)

(72) Inventors: Qing LI, Princeton Junction, NJ (US); Hong CHENG, Basking Ridge, NJ (US); Kapil GULATI, Belle Mead, NJ (US); Seyedkianoush HOSSEINI, San Diego, CA (US); Junyi LI, Fairless Hills, PA (US); Ozcan OZTURK, San Diego, CA (US); Gabi SARKIS, San Diego, CA (US); Stelios STEFANATOS, San Diego, CA (US)

(21) Appl. No.: 18/282,773

(22) PCT Filed: May 20, 2022
(86) PCT No.: PCT/US2022/030379

§ 371 Date: Sep. 18, 2023

(30) Foreign Application Priority Data
Jun. 4, 2021 (GR) 20210100364

(51) Int. Cl. H04L 1/1812; H04L 5/00; H04W 72/25; H04W 92/18

(52) U.S. Cl. CPC H04L 1/1812; H04L 5/0098; H04W 72/25; H04W 92/18

(57) ABSTRACT

Apparatus, methods, and computer-readable media for facilitating sidelink carrier aggregation with cross-carrier feedback are disclosed herein. An example method for wireless communication at a first wireless device includes receiving, from a second wireless device, a first sidelink message including a first transport block (TB) on a first carrier. The example method also includes generating a first Hybrid Automatic Repeat Request (HARQ) feedback for the first TB. The example method also includes determining a first feedback carrier to transmit cross-carrier feedback. The example method also includes mapping the first HARQ feedback for the first TB to the first feedback carrier, the first feedback carrier being different than the first carrier. The example method also includes transmitting the first HARQ feedback on the first feedback carrier to the second wireless device.

### CROSS-REFERENCE TO RELATED APPLICATION

This application claims the benefit of Greek Patent Application Serial No. 20210100364, entitled “SIDELINK CARRIER AGGREGATION WITH CROSS-CARRIER HARQ FEEDBACK” and filed on Jun. 4, 2021, which is expressly incorporated by reference herein in its entirety.

### INTRODUCTION

The present disclosure relates generally to communication systems, and more particularly, to wireless communication using sidelink.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method of wireless communication at a first wireless device is provided. The method may include receiving, from a second wireless device, a first sidelink message including a first transport block (TB) on a first carrier. The example method may also include generating a first Hybrid Automatic Repeat Request (HARQ) feedback for the first TB. The example method may also include determining a first feedback carrier to transmit cross-carrier feedback. The example method may also include mapping the first HARQ feedback for the first TB to the first feedback carrier, the first feedback carrier being different than the first carrier. The example method may also include transmitting the first HARQ feedback on the first feedback carrier to the second wireless device.

In another aspect of the disclosure, an apparatus for wireless communication is provided. The apparatus may be a first wireless device that includes a memory and at least one processor coupled to the memory, the memory and the at least one processor configured to receive, from a second wireless device, a first sidelink message including a first TB on a first carrier. The memory and the at least one processor may also be configured to generate a first HARQ feedback for the first TB. The memory and the at least one processor may also be configured to determine a first feedback carrier to transmit cross-carrier feedback. The memory and the at least one processor may also be configured to map the first HARQ feedback for the first TB to the first feedback carrier, the first feedback carrier being different than the first carrier. The memory and the at least one processor may also be configured to transmit the first HARQ feedback on the first feedback carrier to the second wireless device.

In another aspect of the disclosure, an apparatus for wireless communication at a first wireless device is provided. The apparatus may include means for receiving, from a second wireless device, a first sidelink message including a first TB on a first carrier. The example apparatus may also include means for generating a first HARQ feedback for the first TB. The example apparatus may also include means for determining a first feedback carrier to transmit cross-carrier feedback. The example apparatus may also include means for mapping the first HARQ feedback for the first TB to the first feedback carrier, the first feedback carrier being different than the first carrier. The example apparatus may also include means for transmitting the first HARQ feedback on the first feedback carrier to the second wireless device.

In another aspect of the disclosure, a non-transitory computer-readable storage medium storing computer executable code for wireless communication at a first wireless device is provided. The code, when executed, may cause a processor to receive, from a second wireless device, a first sidelink message including a first TB on a first carrier. The example code, when executed, may also cause the processor to generate a first HARQ feedback for the first TB. The example code, when executed, may also cause the processor to determine a first feedback carrier to transmit cross-carrier feedback. The example code, when executed, may also cause the processor to map the first HARQ feedback for the first TB to the first feedback carrier, the first feedback carrier being different than the first carrier. The example code, when executed, may also cause the processor to transmit the first HARQ feedback on the first feedback carrier to the second wireless device.

In an aspect of the disclosure, a method of wireless communication with a first wireless device at a second wireless device is provided. The method may include transmitting a first sidelink message including a first TB on a first carrier to the first wireless device. The example method may also include receiving a first feedback on a first feedback carrier. Additionally, the example method may include receiving a first demapping indicator with the first feedback from the first wireless device. The example method may also include determining at least a first HARQ entity for the first TB based on the first demapping indicator. Additionally, the example method may include forwarding the first feedback to the first HARQ entity of a medium access control (MAC) layer of the second wireless device.

In another aspect of the disclosure, an apparatus for wireless communication between a first wireless device and a second wireless device is provided. The apparatus may be a second wireless device that includes a memory and at least one processor coupled to the memory, the memory and the at least one processor configured to transmit a first sidelink message including a first TB on a first carrier to the first wireless device. The memory and the at least one processor may also be configured to receive a first feedback on a first feedback carrier. Additionally, the memory and the at least one processor may be configured to receive a first demapping indicator with the first feedback from the first wireless device. The memory and the at least one processor may also be configured to determine at least a first HARQ entity for the first TB based on the first demapping indicator. Additionally, the memory and the at least one processor may be configured to forward the first feedback to the first HARQ entity of a MAC layer of the second wireless device.

In another aspect of the disclosure, an apparatus for wireless communication with a first wireless device at a second wireless device is provided. The apparatus may include means for transmitting a first sidelink message including a first TB on a first carrier to the first wireless device. The example apparatus may also include means for receiving a first feedback on a first feedback carrier. Additionally, the example apparatus may include means for receiving a first demapping indicator with the first feedback from the first wireless device. The example apparatus may also include means for determining at least a first HARQ entity for the first TB based on the first demapping indicator. Additionally, the example apparatus may include means for forwarding the first feedback to the first HARQ entity of a MAC layer of the second wireless device.

In another aspect of the disclosure, a non-transitory computer-readable storage medium storing computer executable code for wireless communication with a first wireless device at a second wireless device is provided. The code, when executed, may cause a processor to transmit a first sidelink message including a first TB on a first carrier to the first wireless device. The example code, when executed, may also cause the processor to receive a first feedback on a first feedback carrier. Additionally, the example code, when executed, may cause the processor to receive a first demapping indicator with the first feedback from the first wireless device. The example code, when executed, may also cause the processor to determine at least a first HARQ entity for the first TB based on the first demapping indicator.

Additionally, the example code, when executed, may cause the processor to forward the first feedback to the first HARQ entity of a MAC layer of the second wireless device.

In an aspect of the disclosure, a method of wireless communication at a first wireless device is provided. The method may include receiving, from a second wireless device, a first sidelink message including a first TB on a first carrier. The example method may also include transmitting, to the second wireless device on a first feedback carrier, a first HARQ feedback for the first TB, the first feedback carrier being different than the first carrier. The example method may also include transmitting, to the second wireless device, an indicator on the first feedback carrier, the indicator indicating at least one of the first TB and the first carrier associated with the first TB.

In another aspect of the disclosure, an apparatus for wireless communication is provided. The apparatus may be a first wireless device that includes a memory and at least one processor coupled to the memory, the memory and the at least one processor configured to receive, from a second wireless device, a first sidelink message including a first TB on a first carrier. The memory and the at least one processor may also be configured to transmit, to the second wireless device on a first feedback carrier, a first HARQ feedback for the first TB, the first feedback carrier being different than the first carrier. The memory and the at least one processor may also be configured to transmit, to the second wireless device, an indicator on the first feedback carrier, the indicator indicating at least one of the first TB and the first carrier associated with the first TB.

In another aspect of the disclosure, an apparatus for wireless communication at a first wireless device is provided. The apparatus may include means for receiving, from a second wireless device, a first sidelink message including a first TB on a first carrier. The example apparatus may also include means for transmitting, to the second wireless device on a first feedback carrier, a first HARQ feedback for the first TB, the first feedback carrier being different than the first carrier. The example apparatus may also include means for transmitting, to the second wireless device, an indicator on the first feedback carrier, the indicator indicating at least one of the first TB and the first carrier associated with the first TB.

In another aspect of the disclosure, a non-transitory computer-readable storage medium storing computer executable code for wireless communication at a first wireless device is provided. The code, when executed, may cause a processor to receive, from a second wireless device, a first sidelink message including a first TB on a first carrier. The example code, when executed, may also cause the processor to transmit, to the second wireless device on a first feedback carrier, a first HARQ feedback for the first TB, the first feedback carrier being different than the first carrier. The example code, when executed, may also cause the processor to transmit, to the second wireless device, an indicator on the first feedback carrier, the indicator indicating at least one of the first TB and the first carrier associated with the first TB.

In an aspect of the disclosure, a method of wireless communication with a first wireless device at a second wireless device is provided. The method may include transmitting, to the first wireless device, a first sidelink message including a first TB on a first carrier. The example method may also include receiving, from the first wireless device, first feedback on a first feedback carrier, the first feedback carrier being different than the first carrier. Additionally, the example method may include receiving, from the first wireless device, an indicator on the first feedback carrier, the indicator indicating at least one of the first TB and the first carrier associated with the first feedback. The example method may also include forwarding, based on the indicator, the first feedback to a first HARQ entity of a MAC layer of the second wireless device, the first HARQ entity associated with processing of the first TB on the first carrier.

In another aspect of the disclosure, an apparatus for wireless communication between a first wireless device and a second wireless device is provided. The apparatus may be a second wireless device that includes a memory and at least one processor coupled to the memory, the memory and the at least one processor configured to transmit, to the first wireless device, a first sidelink message including a first TB on a first carrier. The memory and the at least one processor may also be configured to receive, from the first wireless device, first feedback on a first feedback carrier, the first feedback carrier being different than the first carrier. Additionally, the memory and the at least one processor may be configured to receive, from the first wireless device, an indicator on the first feedback carrier, the indicator indicating at least one of the first TB and the first carrier associated with the first feedback. The memory and the at least one processor may also be configured to forward, based on the indicator, the first feedback to a first HARQ entity of a MAC layer of the second wireless device, the first HARQ entity associated with processing of the first TB on the first carrier.

In another aspect of the disclosure, an apparatus for wireless communication with a first wireless device at a second wireless device is provided. The apparatus may include means for transmitting, to the first wireless device, a first sidelink message including a first TB on a first carrier. The example apparatus may also include means for receiving, from the first wireless device, first feedback on a first feedback carrier, the first feedback carrier being different than the first carrier. Additionally, the example apparatus may include means for receiving, from the first wireless device, an indicator on the first feedback carrier, the indicator indicating at least one of the first TB and the first carrier associated with the first feedback. The example apparatus may also include means for forwarding, based on the indicator, the first feedback to a first HARQ entity of a MAC layer of the second wireless device, the first HARQ entity associated with processing of the first TB on the first carrier.

In another aspect of the disclosure, a non-transitory computer-readable storage medium storing computer executable code for wireless communication with a first wireless device at a second wireless device is provided. The code, when executed, may cause a processor to transmit, to the first wireless device, a first sidelink message including a first TB on a first carrier. The example code, when executed, may also cause the processor to receive, from the first wireless device, first feedback on a first feedback carrier, the first feedback carrier being different than the first carrier. Additionally, the example code, when executed, may cause the processor to receive, from the first wireless device, an indicator on the first feedback carrier, the indicator indicating at least one of the first TB and the first carrier associated with the first feedback. The example code, when executed, may also cause the processor to forward, based on the indicator, the first feedback to a first HARQ entity of a MAC layer of the second wireless device, the first HARQ entity associated with processing of the first TB on the first carrier.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 illustrates example aspects of a sidelink slot structure, in accordance with various aspects of the present disclosure.

FIG. 3 is a diagram illustrating an example of a first device and a second device involved in sidelink communication.

FIG. 4 illustrates an example of sidelink communication between wireless devices, in accordance with one or more of the teachings disclosed herein.

FIG. 5 is a diagram illustrating an example of cross-carrier communication between a first wireless device and a second wireless device, in accordance with one or more of the teachings disclosed herein.

FIG. 6 illustrates an example sidelink user plane architecture facilitating carrier aggregation, in accordance with one or more of the teachings disclosed herein.

FIG. 7A illustrates an example downlink user plane architecture facilitating carrier aggregation on a Uu interface, in accordance with one or more of the teachings disclosed herein.

FIG. 7B illustrates another example downlink user plane architecture facilitating carrier aggregation on a Uu interface, in accordance with one or more of the teachings disclosed herein.

FIG. 8 illustrates an example communication flow between a first wireless device and a second wireless device, in accordance with one or more of the teachings disclosed herein.

FIG. 9A illustrates an example communication flow between a first wireless device and a second wireless device employing cross-carrier HARQ feedback, in accordance with one or more of the teachings disclosed herein.

FIG. 9B illustrates an example communication flow between a first wireless device and a second wireless device employing cross-carrier HARQ feedback, in accordance with one or more of the teachings disclosed herein.

FIG. 10A illustrates another example communication flow between a first wireless device and a second wireless device employing cross-carrier HARQ feedback, in accordance with one or more of the teachings disclosed herein.

FIG. 10B illustrates another example communication flow between a first wireless device and a second wireless device employing cross-carrier HARQ feedback, in accordance with one or more of the teachings disclosed herein.

FIG. 11 illustrates an example communication flow between a first wireless device and a second wireless device, in accordance with one or more of the teachings disclosed herein.

FIG. 12 illustrates an example communication flow between a first wireless device and a second wireless device employing cross-carrier feedback, in accordance with one or more of the teachings disclosed herein.

FIG. 13 illustrates an example communication flow between a first wireless device, a second wireless device, and a third wireless device employing cross-carrier feedback, in accordance with one or more of the teachings disclosed herein.

FIG. 14 illustrates an example communication flow between a first wireless device, a second wireless device, and a third wireless device employing cross-carrier feedback, in accordance with one or more of the teachings disclosed herein.

FIG. 15 is a flowchart of a method of wireless communication at a first wireless device, in accordance with the teachings disclosed herein.

FIG. 16 is a flowchart of a method of wireless communication at a first wireless device, in accordance with the teachings disclosed herein.

FIG. 17 is a flowchart of a method of wireless communication at a first wireless device, in accordance with the teachings disclosed herein.

FIG. 18 is a diagram illustrating an example of a hardware implementation for an example apparatus, in accordance with the teachings disclosed herein.

FIG. 19 is a flowchart of a method of wireless communication at a second wireless device, in accordance with the teachings disclosed herein.

FIG. 20 is a flowchart of a method of wireless communication at a second wireless device, in accordance with the teachings disclosed herein.

FIG. 21 is a flowchart of a method of wireless communication at a first wireless device, in accordance with the teachings disclosed herein.

FIG. 22 is a diagram illustrating an example of a hardware implementation for an example apparatus, in accordance with the teachings disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

A link between a UE and a base station may be established as an access link, for example, using a Uu interface. Other communication may be exchanged between wireless devices based on sidelink. For example, some UEs may communicate with each other directly using a device-to-device (D2D) communication link, such as sidelink. Some examples of sidelink communication may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications. Sidelink communication may be based on V2X or other D2D communication, such as Proximity Services (ProSe), etc. Sidelink communication may be exchanged based on a PC5 interface, for example.

As capabilities of UEs advance, so to do expectations of the UEs. For example, in V2X scenarios, vehicles, pedestrians (e.g., a vulnerable road user (VRU), the infrastructure (e.g., an RSU), and the network are expected to cooperate with each other to increase traffic efficiency, increase road safety, and reduce the number of accidents. In order to achieve these goals, UEs gather information about their surroundings, process information, predict potential hazards, and perform protective maneuvers. For example, a vehicle may detect an obstruction in the ground and perform a detour maneuver based on the detected obstruction. The vehicle may also transmit detour information, such as the detected obstruction, the detour maneuver, location information on a map, etc. Although examples are provided for vehicular sidelink communication to illustrate the concept, the aspects presented here are applicable to non-vehicular sidelink-capable devices and are not limited to a vehicle application.

In the above example, in one aspect, the detour information may be graphics-based information. Such detour information may be an example of advanced V2X services that are associated with ultra-reliable and low latency communications (URLLC). For example, the detour information may be transmitted in a short time period after occurring (e.g., low latency) and with high reliability. In some examples, having high bandwidth availability to transmit the detour information may facilitate transmitting with low latency. In some examples, transmitting the information one or more times may facilitate transmitting with reliability. Additionally, having high bandwidth availability may facilitate transmitting the information one or more times.

Carrier aggregation may allow for higher layer applications and/or advanced services that use higher data throughput. Carrier aggregation allows the UE to use multiple carriers to transmit data, thereby increasing the bandwidth available to transmit the data. When a UE is configured for carrier aggregation and supports advanced services, the UE may be configured with a set of carriers to perform the advanced service. For example, an advanced service may be mapped to four different carriers.

To accommodate traffic associated with high reliability and low latency (e.g., advanced services associated with high data throughput), the transmitting UE may use carriers associated with higher frequency ranges, such as FR2 and/or unlicensed frequencies. In such examples, the conditions on the carriers may be changing and/or undeterministic. For example, conditions (e.g., channel conditions) associated with a first carrier may be acceptable when the transmitting device transmits a first transport block, but the conditions associated with the first carrier may be unacceptable or the channel may be unavailable when the receiving device transmits a first ACK/NACK message on the first carrier. In such examples, the transmitting device may not receive the first ACK/NACK message and, thus, may be unable to determine whether to retransmit the first transport block. In some examples, the channel may be stable or reliable with less interference or congestion. For example, if a measurement of the channel (e.g., a reference signal received power (RSRP) measurement, a received signal strength indicator (RSSI) measurement, and/or a channel busy ratio (CBR) measurement) is below a threshold, the channel may be determined to be associated with acceptable conditions. The channel may also, or alternatively, be determined to be available if sensing for channel access or listen-before-talk (LBT) is successful (e.g., an energy measured on the channel is below a threshold). Additionally, in examples in which the HARQ entities are configured to transmit NACK-only feedback (e.g., no HARQ feedback is provided if decoding of the respective transport block is successful), the absence of the first ACK/NACK message at the first HARQ entity may result in the first HARQ entity determining to forego retransmitting the first transport block.

Thus, to improve resource utilization over carriers for HARQ-enabled transmissions and to facilitate reliable and timely HARQ feedback (e.g., for advanced V2X services with more performance demands), examples disclosed herein provide techniques for implementing cross-carrier HARQ feedback in contrast to in-carrier feedback. For example, a transmitting UE may transmit a first transport block on a first carrier. A receiving UE may generate feedback (e.g., an ACK/NACK message) based on the first transport block. The receiving UE may then transmit the feedback to the transmitting UE. In scenarios employing in-carrier feedback, the same carrier is used to transmit the traffic (e.g., the first transport block from the first wireless device to the second wireless device) and to transmit any corresponding feedback (e.g., the ACK/NACK message based on the first transport block). In scenarios employing cross-carrier HARQ feedback, as disclosed herein, the carrier used to transmit the traffic and the carrier used to transmit the feedback are different. For example, aspects disclosed herein provide for a receiving UE to map one or more ACK/NACK messages generated for transport blocks received on respective traffic carriers on to a feedback carrier that is different than the respective carriers. In some examples, different ACK/NACK messages associated with respective traffic carriers may be mapped on to feedback carriers that are different than the respective traffic carriers. For example, the receiving UE may transmit a first ACK/NACK message, that is associated with a first transport block on a first traffic carrier, on a first feedback carrier that is different than the first traffic carrier. The receiving UE may also transmit a second ACK/NACK message, that is associated with a second transport block on a second traffic carrier, on a second feedback carrier that is different than the second traffic carrier. In other examples, different ACK/NACK messages may be aggregated and mapped on to a same feedback carrier. For example, the receiving UE may aggregate the first ACK/NACK message and the second ACK/NACK message and transmit the aggregated ACK/NACK messages on a first feedback carrier that is different than the first traffic carrier and the second traffic carrier.

Examples disclosed herein provide techniques for the transmitting UE to process the cross-carrier HARQ feedback to recover the ACK/NACK message(s) and to forward the ACK/NACK message(s) to the correct HARQ entity (or entities). For example, the cross-carrier HARQ feedback may include an ACK/NACK message associated with a first carrier that is different than the feedback carrier. The transmitting UE may receive the cross-carrier HARQ feedback on the feedback carrier and determine that the cross-carrier HARQ feedback includes the ACK/NACK message associated with the first carrier. The transmitting UE may then forward the ACK/NACK message to the HARQ entity associated with the first carrier to determine whether to retransmit the respective transport block.

The feedback carrier may be associated with relatively more stable (e.g., reliable) conditions (e.g., channel conditions such as interference and/or congestion) than the carriers for which the ACK/NACK messages were generated. For example, when the wireless devices are configured with inter-band carriers, the carriers used to transmit the transport blocks may be associated with higher frequencies (e.g., FR2) and the feedback carrier(s) may be associated with lower frequencies (e.g., FR1). In other examples, the carriers used to transmit the transport blocks may be associated with the unlicensed frequency spectrum and the feedback carrier(s) may be associated with the licensed frequency spectrum. In other examples in which the wireless devices are configured with intra-band carriers, the carriers used to transmit the transport blocks may be associated with higher operating bands and the feedback carrier(s) may be associated with lower operating bands within the same frequency range.

In some examples, the wireless devices may be preconfigured with the feedback carrier to use for the cross-carrier HARQ feedback. In some examples, the wireless devices may be configured with the feedback carrier to use for the cross-carrier HARQ feedback. In some examples, the feedback carrier may be semi-statically selected and activated. For example, the receiving UE may be configured with a carrier configuration including a list of feedback carriers and then receive an activation indication to start using one or more of the feedback carriers of the carrier configuration. In some examples, the feedback carrier may be dynamically selected and indicated. For example, the receiving UE may receive information regarding the feedback carrier to use along with a transport block. The receiving UE may receive the carrier configuration, the activation indication, and/or the information regarding the feedback carrier from the transmitting UE, or another wireless device, such as an RSU, a base station, a group lead, a cluster head, and/or a scheduling UE.

To facilitate the transmitting UE to recover the ACK/NACK message(s) of the cross-carrier HARQ feedback, the receiving UE may transmit an indicator along with the cross-carrier HARQ ACK/NACK feedback. The indicator may indicate the ACK/NACK message(s) included in the cross-carrier HARQ feedback is associated with the carrier(s) for transmitting the transport block(s) or is associated with the transport block(s) received. For example, the indicator may indicate that the cross-carrier HARQ feedback includes a first ACK/NACK message associated with a first carrier or a first transport block and a second ACK/NACK message associated with a second carrier or a second transport block. The transmitting UE may use the indicator to determine the respective HARQ entities associated with the ACK/NACK messages (e.g., determine a first HARQ entity for a first ACK/NACK associated to a first carrier or a first transport block) and to forward the respective ACK/NACK messages to the correct HARQ entities, which may then determine whether to retransmit the corresponding transport block.

As described above, support for advanced services, such as advanced V2X services, may be based on higher bandwidth availability. To provide the higher bandwidth availability, the advanced services may be configured to use higher frequency ranges for communicating traffic. Thus, while a transmitting UE using a carrier associated with a higher frequency range to transmit traffic may receive higher data throughput for the traffic, it may be possible that channel conditions associated with the carrier may not be suitable for carrying feedback associated with the traffic. In such examples, when the feedback is transmitted on the same carrier as the traffic (e.g., as described in connection with in-carrier feedback), the transmitting UE may not receive the feedback, which may negatively impact reliability and latency performance for communications between the transmitting UE and the receiving UE. However, channels associated with narrow bandwidth may be more reliability (e.g., with respect to availability, interference, and/or congestion) than channels associated with the higher frequency ranges (e.g., wide bandwidth). By employing cross-carrier HARQ feedback, as described herein, aspects provide techniques for facilitating reliable and timely HARQ feedback. For example, the receiving UE may transmit the feedback on a feedback carrier that is different than the carrier on which the corresponding traffic is received. While the feedback carrier may be associated with a narrow bandwidth and, thus, a lower data throughput compared to the traffic carrier, the feedback carrier may also be associated with more stable channel conditions, which may improve resource utilization over carriers for HARQ-enabled transmissions and to facilitate reliable and timely HARQ feedback.

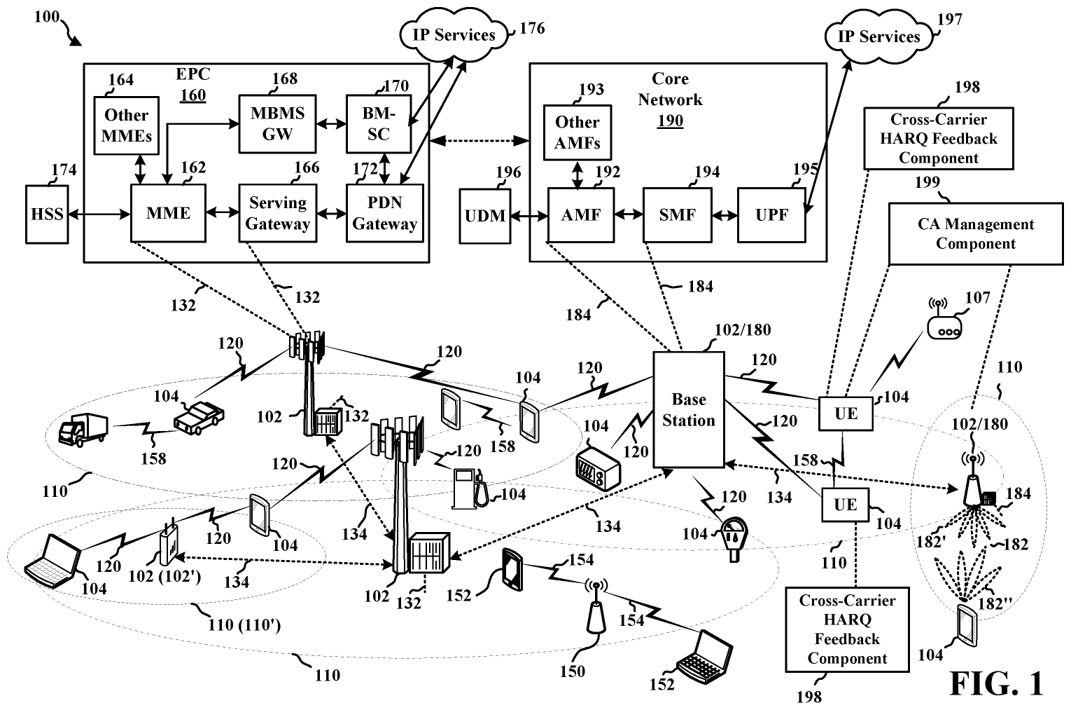

FIG. 1 is a diagram illustrating an example of a wireless communications system and an access network 100 including base stations 102 and 180 and UEs 104. In some examples, a wireless device, such as a UE 104, may be configured to manage one or more aspects of wireless communication by facilitating transmitting cross-carrier feedback in sidelink. As an example, in FIG. 1, the UE 104 may include a cross-carrier HARQ feedback component 198. In certain aspects, the cross-carrier HARQ feedback component 198 may be configured to receive, from a second wireless device, a first sidelink message including a first TB on a first carrier. The example cross-carrier HARQ feedback component 198 may also be configured to generate a first HARQ feedback for the first TB. Additionally, the example cross-carrier HARQ feedback component 198 may be configured to determine a first feedback carrier to transmit cross-carrier feedback. The example cross-carrier HARQ feedback component 198 may also be configured to map the first HARQ feedback for the first TB to the first feedback carrier, the first feedback carrier being different than the first carrier. Additionally, the example cross-carrier HARQ feedback component 198 may be configured to transmit the first HARQ feedback on the first feedback carrier to the second wireless device.

In another configuration, the cross-carrier HARQ feedback component 198 may be configured to receive, from a second wireless device, a first sidelink message including a first TB on a first carrier. The example cross-carrier HARQ feedback component 198 may also be configured to transmit, to the second wireless device on a first feedback carrier, a first HARQ feedback for the first TB, the first feedback carrier being different than the first carrier. Additionally, the example cross-carrier HARQ feedback component 198 may be configured to transmit, to the second wireless device, an indicator on the first feedback carrier, the indicator indicating at least one of the first TB and the first carrier associated with the first TB.

In another configuration, a wireless device, such as the example UE 104, may be configured to manage one or more aspects of wireless communication by facilitating the receiving of cross-carrier HARQ feedback. As an example, in FIG. 1, the UE 104 may additionally or alternatively include a CA management component 199. In certain aspects, the CA management component 199 may be configured to transmit a first sidelink message including a first TB on a first carrier to the first wireless device. The example CA management component 199 may also be configured to receive a first feedback on a first feedback carrier. Further, the example CA management component 199 may be configured to receive a first demapping indicator with the first feedback from the first wireless device. The example CA management component 199 may also be configured to determine at least a first HARQ entity for the first TB based on the first demapping indicator. Further, the example CA management component 199 may be configured to forward the first feedback to the first HARQ entity of a MAC layer of the second wireless device.

In another configuration, the CA management component 199 may be configured to transmit, to the first wireless device, a first sidelink message including a first TB on a first carrier. The example CA management component 199 may also be configured to receive, from the first wireless device, first feedback on a first feedback carrier, the first feedback carrier being different than the first carrier. Additionally, the example CA management component 199 may be configured to receive, from the first wireless device, an indicator on the first feedback carrier, the indicator indicating at least one of the first TB and the first carrier associated with the first feedback. The example CA management component 199 may also be configured to forward, based on the indicator, the first feedback to a first HARQ entity of a MAC layer of the second wireless device, the first HARQ entity associated with processing of the first TB on the first carrier.

The aspects presented herein may enable a UE to transmit cross-carrier HARQ feedback, which may improve reliability and provide timely HARQ feedback in sidelink.

Although the following description provides examples directed to 5G NR, the concepts described herein may be applicable to other similar areas, such as LTE, LTE-A, CDMA, GSM, and/or other wireless technologies, in which a UE may communicate using sidelink.

Certain UEs 104 may communicate with each other using device-to-device (D2D) communication link 158. In some examples, the D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

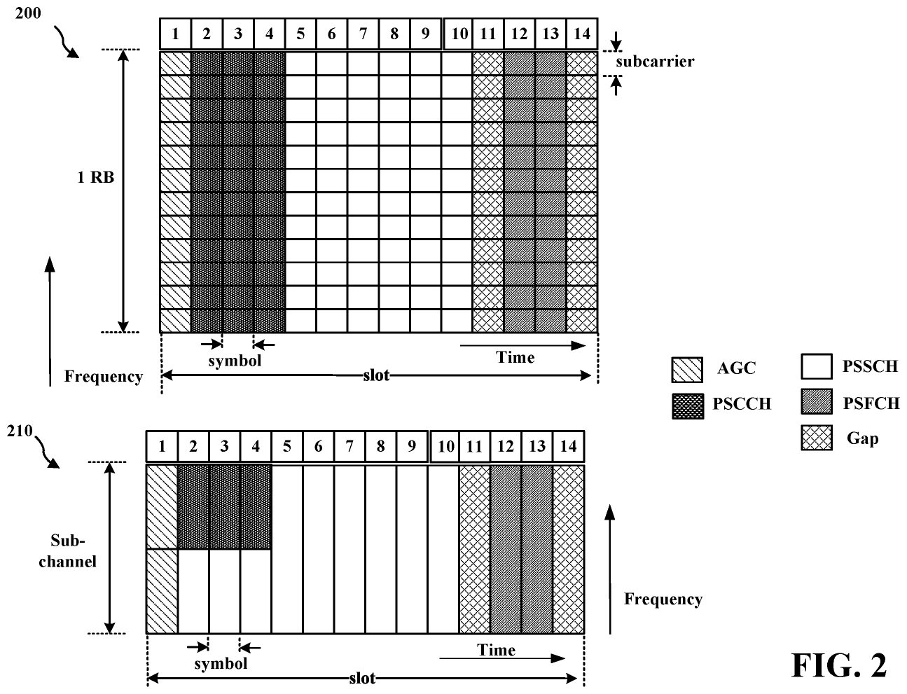

In addition to UEs, sidelink communication may also be transmitted and received by other transmitting and receiving devices, such as Road Side Unit (RSU) 107, etc. Sidelink communication may be exchanged using a PC5 interface, such as described in connection with the example in FIG. 2. Although the following description, including the example slot structure of FIG. 2, may provide examples for sidelink communication in connection with 5G NR, the concepts described herein may be applicable to other similar areas, such as LTE, LTE-A, CDMA, GSM, and other wireless technologies.

The example of the wireless communications system of FIG. 1 (also referred to as a wireless wide area network (WWAN)) includes the base stations 102, the UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming. Similarly, beamforming may be applied for sidelink communication, e.g., between UEs.

Devices may use beamforming to transmit and receive communication. For example, FIG. 1 illustrates that a base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same. Although this example is described for the base station 180 and UE 104, the aspects may be similarly applied between a first device and a second device (e.g., a first UE and a second UE) for sidelink communication. For example, aspects of beamforming may similarly may be applied by UE 104 or RSU 107 to communicate with another UE 104 or RSU 107, such as based on V2X, V2V, or D2D communication.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

FIG. 2 includes diagrams 200 and 210 illustrating example aspects of slot structures that may be used for sidelink communication (e.g., between UEs 104, RSU 107, etc.). The slot structure may be within a 5G/NR frame structure in some examples. In other examples, the slot structure may be within an LTE frame structure. Although the following description may be focused on 5G NR, the concepts described herein may be applicable to other similar areas, such as LTE, LTE-A, CDMA, GSM, and other wireless technologies. The example slot structure in FIG. 2 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 200 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may comprise 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 210 in FIG. 2 illustrates an example in which the PSCCH occupies about 50% of a subchannel, as one example to illustrate the concept of PSCCH occupying a portion of a subchannel. The physical sidelink shared channel (PSSCH) occupies at least one subchannel. The PSCCH may include a first portion of sidelink control information (SCI), and the PSSCH may include a second portion of SCI in some examples.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2, some of the REs may include control information in PSCCH and some REs may include demodulation RS (DMRS). At least one symbol may be used for feedback. FIG. 2 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may comprise the data message described herein. The position of any of the data, DMRS, SCI, feedback, gap symbols, and/or LB T symbols may be different than the example illustrated in FIG. 2. Multiple slots may be aggregated together in some aspects.

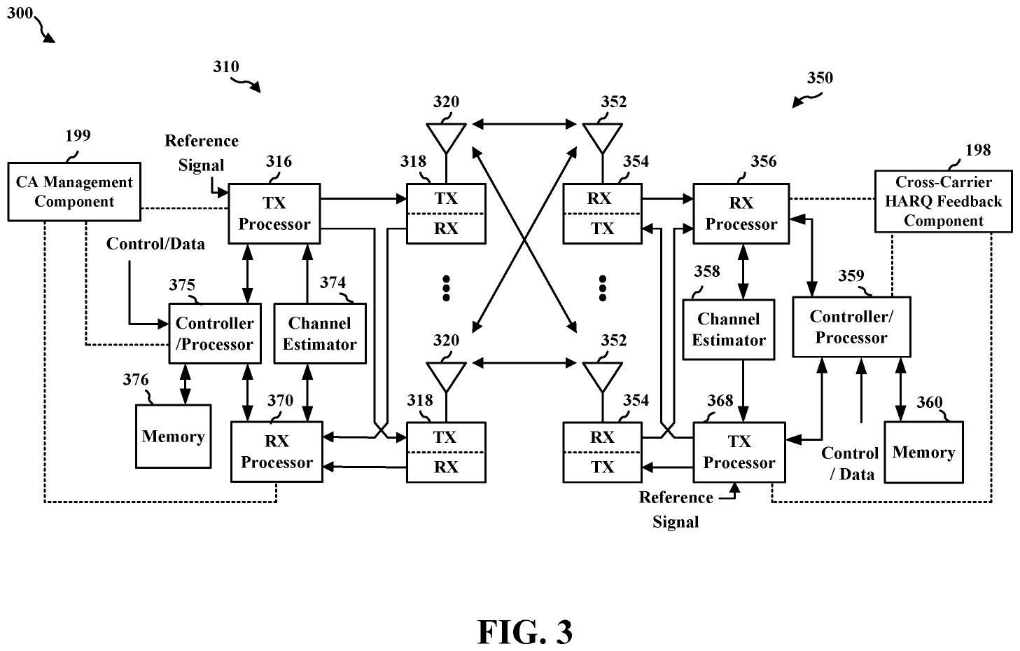

FIG. 3 is a block diagram 300 of a first wireless communication device 310 in communication with a second wireless communication device 350 based on sidelink. In some examples, the devices 310, 350 may communicate based on V2X or other D2D communication. The communication may be based on sidelink using a PC5 interface. The devices 310, 350 may comprise a UE, an RSU, a base station, etc. Packets may be provided to a controller/processor 375 that implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer.

The transmit (TX) processor (e.g., a TX processor 316) and the receive (RX) processor (e.g., an RX processor 370) implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the second wireless communication device 350. Each spatial stream may then be provided to a different antenna 320 via a separate transmitter 318TX. Each transmitter 318TX may modulate an RF carrier with a respective spatial stream for transmission.

At the second wireless communication device 350, each receiver 354RX receives a signal through its respective antenna 352. Each receiver 354RX recovers information modulated onto an RF carrier and provides the information to an RX processor 356. A TX processor 368 and the RX processor 356 implement layer 1 functionality associated with various signal processing functions. The RX processor 356 may perform spatial processing on the information to recover any spatial streams destined for the second wireless communication device 350. If multiple spatial streams are destined for the second wireless communication device 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the first wireless communication device 310. These soft decisions may be based on channel estimates computed by the channel estimator 358. The soft decisions are then decoded and deinterleaved to recover the data and control signals that were originally transmitted by the first wireless communication device 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. The controller/processor 359 may provide demultiplexing between transport and logical channels, packet reassembly, deciphering, header decompression, and control signal processing. The controller/processor 359 is also responsible for error detection using an ACK and/or NACK protocol to support HARQ operations.

Similar to the functionality described in connection with the transmission by the first wireless communication device 310, the controller/processor 359 may provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the first wireless communication device 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The transmission is processed at the first wireless communication device 310 in a manner similar to that described in connection with the receiver function at the second wireless communication device 350. Each receiver 318RX receives a signal through its respective antenna 320. Each receiver 318RX recovers information modulated onto an RF carrier and provides the information to the RX processor 370.

The controller/processor 375 can be associated with a memory 376 that stores program codes and data. The memory 376 may be referred to as a computer-readable medium. The controller/processor 375 provides demultiplexing between transport and logical channels, packet reassembly, deciphering, header decompression, control signal processing. The controller/processor 375 is also responsible for error detection using an ACK and/or NACK protocol to support HARQ operations.

At least one of the TX processor 316 or 368, the RX processor 356 or 370, and the controller/processor 359 or 375 may be configured to perform aspects described in connection with the cross-carrier HARQ feedback component 198 and/or the CA management component 199 of FIG. 1.

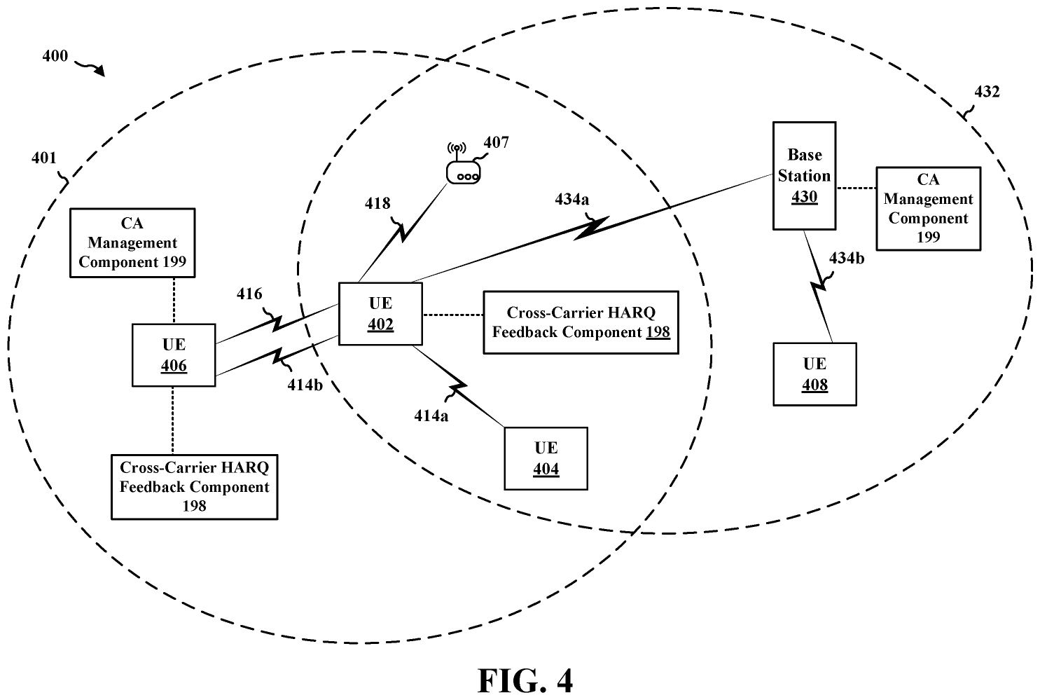

FIG. 4 illustrates an example 400 of sidelink communication between wireless devices. The communication may be based on a slot structure comprising aspects described in connection with FIG. 2 or another sidelink structure. For example, a first UE 402 may transmit a transmission 414a, e.g., comprising a control channel (e.g., a PSCCH) and/or a corresponding data channel (e.g., a PSSCH), that may be received by a second UE 404 and/or a transmission 414b that may be received by a third UE 406 directly from the first UE 402, e.g., without being transmitted through a base station. The UEs 402, 404, 406 may each be capable of operating as a transmitting device in addition to operating as a receiving device. Thus, the third UE 406 is illustrated as transmitting a transmission 416 that is received by the first UE 402. One or more of the transmissions 414a, 414b, 416 may be broadcast or multicast to nearby devices. For example, the first UE 402 may transmit communication intended for receipt by other UEs within a range 401 of the first UE 402. In other examples, one or more of the transmissions 414a, 414b, 416 may be groupcast to nearby devices that are a member of a group. In other examples, one or more of the transmissions 414a, 414b, 416 may be unicast from one UE to another UE. Additionally, or alternatively, an RSU 407 may receive communication from and/or transmit communication to the UEs 402, 404, 406. As shown in FIG. 4, the RSU 407 may transmit a communication 418 to the first UE 402.

The first UE 402 may provide sidelink control information (SCI) with information for decoding the corresponding data channel. The SCI may also include information that a receiving device may use to avoid interference. For example, the SCI may indicate reserved time resources and/or reserved frequency resources that will be occupied by the data transmission, and may be indicated in a control message from the transmitting device.

In some examples, a base station 430 may communicate with one or more communication devices within a range 432 of the base station 430. For example, the base station 430 may communicate with the first UE 402, the second UE 404, a fourth UE 408, and the RSU 407. As shown in FIG. 4, the base station 430 may transmit a first communication 434a to the first UE 402 and may transmit a second communication 434b to the fourth UE 408.

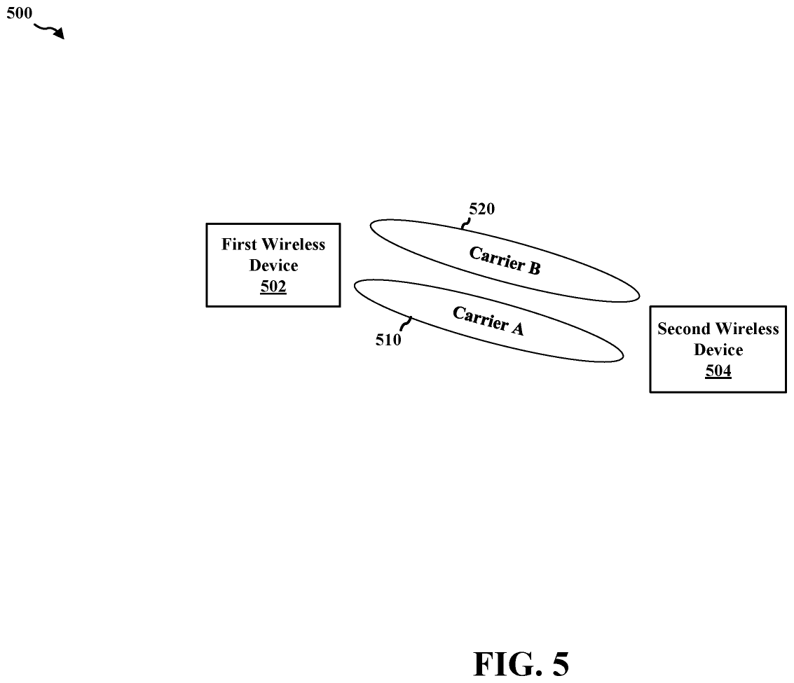

The UE 402, 404, 406, 408 and/or the RSU 407 may include a cross-carrier HARQ feedback component, similar to the cross-carrier HARQ component 198 described in connection with FIG. 1. The UE 402, 404, 406, 408, the RSU 407, and/or the base station 430 may additionally or alternatively include a CA management component, similar to the CA management component 199 described in connection with FIG. 1. FIG. 5 is a diagram illustrating an example of cross-carrier communication 500 between a first wireless device 502 and a second wireless device 504, in accordance with one or more aspects of this disclosure. Aspects of the wireless devices 502, 504 may be implemented by the base station 102/180 and/or the UE 104.

In the illustrated example of FIG. 5, the first wireless device 502 and the second wireless device 504 are in communication. For example, the first wireless device 502 and the second wireless device 504 may transmit and/or receive messages through a first carrier 510 (“Carrier A”). The first wireless device 502 and the second wireless device 504 may additionally or alternatively transmit and/or receive messages through a second carrier 520 (“Carrier B”). Although not shown in the example of FIG. 5, it may be appreciated that each of the respective carriers 510, 520 may be associated with a set of beams. In some examples, the cross-carrier communication 500 of FIG. 5 may correspond to examples of carrier aggregation.

In some examples, a carrier (e.g., the carriers 510, 520) may be associated with an operating band and a frequency range. For example, a first frequency range (FR1) may include frequencies between 410 MHz and 7125 MHz, and a second frequency range (FR2) may include frequencies between 24250 MHz and 52600 MHz. The respective frequency ranges may be further divided into operating bands that define a subset of frequencies. For example, a first operating band within FR1 may include frequencies between 1920 MHz and 1980 MHz for uplink transmissions and frequencies between 2110 MHz and 2170 MHz for downlink transmissions. A second operating band within FR1 may include frequencies between 1850 MHz and 1910 MHz for uplink transmissions and frequencies between 1930 MHz and 1990 MHz for downlink transmissions. The second frequency range (FR2) may also include operating bands. For example, a first operating band within FR2 may include frequencies between 26500 MHz and 29500 MHz for uplink transmissions and downlink transmissions, and a second operating band within FR2 may include frequencies between 24500 MHz and 27500 MHz for uplink transmissions and downlink transmissions. In some examples, a carrier (e.g., the carriers 510, 520) may be associated with licensed frequency spectrum (e.g., FR1, FR2, etc.) and/or an unlicensed frequency spectrum.

In some examples, cross-carrier communication, such as the example cross-carrier communication 500 of FIG. 5, may include inter-band carrier aggregation. For example, the first carrier 510 may be associated with a first frequency range (FR1) and the second carrier 520 may be associated with a second frequency range (FR2). In another example of inter-band carrier aggregation, the first carrier 510 may be associated with the licensed frequency spectrum and the second carrier 520 may be associated with the unlicensed frequency spectrum. In other examples, the cross-carrier communication may include intra-band carrier aggregation. For example, the first carrier 510 may be associated with a first operating band of a first frequency range (FR1, FR2, or unlicensed) and the second carrier 520 may be associated with a second operating band of the first frequency range (FR1, FR2, or unlicensed).

Carrier aggregation may include aggregating two or more component carriers, which facilitates supporting high data-rates. For example, multiple transport blocks may be transmitted in parallel on different carriers for a throughput gain. Referring to the example of FIG. 5, the first wireless device 502 may transmit a first transport block using the first carrier 510 and may transmit a second transport block using the second carrier 520. In the example, the first transport block and the second transport block may be transmitted in parallel, thus allowing two transport blocks to be transmitted by the first wireless device 502 and received by the second wireless device 504 in the time that only one transport block may have been communicated without carrier aggregation.

In sidelink communication, different services may be mapped to different carriers. For example, a UE supporting a first service may be configured to operate with a first carrier and/or a second carrier. Thus, when the UE is scheduled to transmit a transport block associated with the first service, the UE may select the first carrier and/or the second carrier. Additionally, when performing a service, the UE may select resources associated with the respective carrier. Examples of V2X services include basic safety messages, such as, cooperative awareness messages, decentralized environmental notification messages, location information, alarm information, and/or detour information.

However, as capabilities of UEs advance, so to do expectations of the UEs. For example, in V2X scenarios, vehicles, pedestrians, the infrastructure, and the network are expected to cooperate with each other to increase traffic efficiency, increase road safety, and reduce the number of accidents. In order to achieve these goals, UEs gather information about their surroundings, process information, predict potential hazards, and perform protective maneuvers. For example, a vehicle may detect an obstruction in the ground and perform a detour maneuver based on the detected obstruction. The vehicle may also transmit detour information, such as the detected obstruction, the detour maneuver, location information on a map. Although examples are provided for vehicular sidelink communication to illustrate the concept, the aspects presented here are applicable to non-vehicular sidelink-capable devices and are not limited to a vehicle application.

In the above example, the detour information may be graphics-based information. Such detour information may be an example of advanced V2X services that are associated with ultra-reliable and low latency communications (URLLC). For example, the detour information may be transmitted in a short time period after occurring (e.g., low latency) and with high reliability. In some examples, having high bandwidth availability to transmit the detour information may facilitate transmitting with low latency. In some examples, transmitting the information one or more times may facilitate transmitting with reliability. Additionally, having high bandwidth availability may facilitate transmitting the information one or more times.

Carrier aggregation may allow for higher layer applications and/or advanced services that use higher data throughput. Carrier aggregation allows the UE to use multiple carriers to transmit data, thereby increasing the bandwidth available to transmit the data. When a UE is configured for carrier aggregation and supports advanced services, the UE may be configured with a set of carriers to perform the advanced service. For example, an advanced service may be mapped to four different carriers.

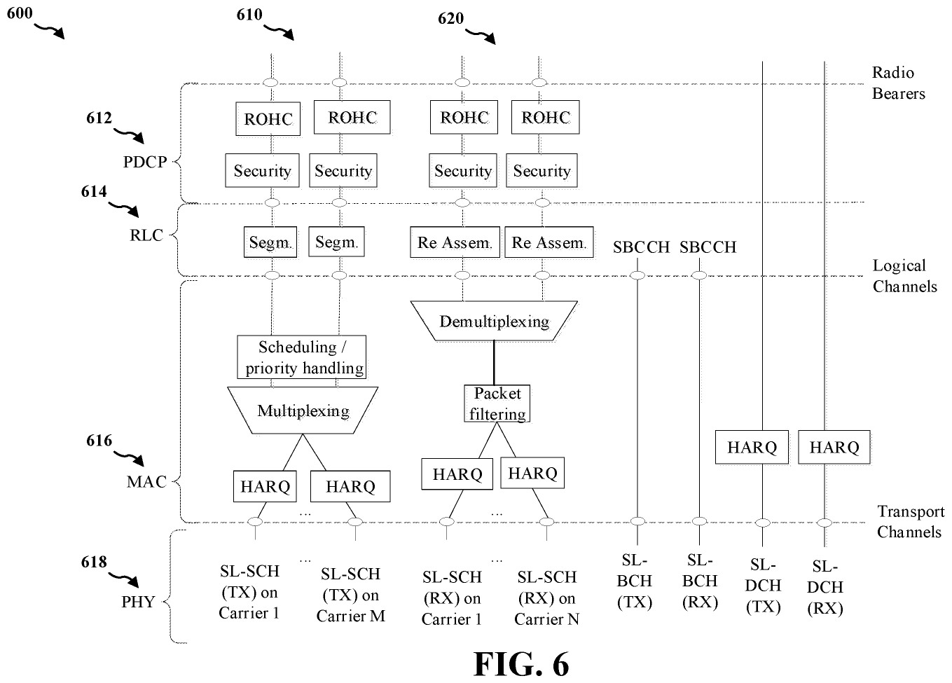

FIG. 6 illustrates an example sidelink user plane architecture 600 facilitating carrier aggregation over sidelink (e.g., PC5 interface),as presented herein. The example sidelink user plane architecture 600 includes a transmitting UE stack 610 and a receiving UE stack 620. At the transmitting UE stack 610, a PDCP layer 612 performs robust head compression (ROHC) operations and security operations. An RLC layer 614 performs segmentation operations. A MAC layer 616 performs scheduling/priority handling operations, multiplexing operations, and HARQ operations. A PHY layer 618 performs mapping to transport channel operations. As shown in FIG. 6, there is a separate HARQ entity for carrier. Thus, data that is transmitted on a particular carrier (e.g., carrier #1) is retransmitted on the same carrier (e.g., carrier #1) if the prior transmission is unsuccessful.

At the receiving UE stack 620, the PHY layer 618 may perform decoding operations. The MAC layer 616 performs HARQ operations for each carrier, packet filtering operations, and demultiplexing operations. The RLC layer 614 performs reassembly operations. The PDCP layer 612 performs security operations and ROHC operations.

As shown in FIG. 6, the interface between the RLC layer 614 and the MAC layer 616 may be referred to logical channels. The interface between the MAC layer 616 and the PHY layer 618 may be referred to as transport channels.

It may be appreciated that each of the PDCP layer 612, the RLC layer 614, the MAC layer 616, and the PHY layer 618 may perform additional or alternative operations.

As shown in FIG. 6, there is an independent HARQ entity per carrier for sidelink communication. Thus, each transport block and any potential retransmissions of the transport block are mapped to a same carrier. Such a scenario may be referred to as in-carrier feedback.

In general, sidelink supports two different resource allocation modes. In a first resource allocation mode, a base station schedules sidelink resources to be used by a UE for sidelink transmissions. Such a resource allocation mode may be referred to as a “centralized resource allocation mechanism.”

In a second resource allocation mode, a transmitting UE autonomously decides resources to use for sidelink transmissions. Such a resource allocation mode may be referred to as a “distributed resource allocation mechanism” or a “decentralized resource allocation mechanism.” The different resource allocation modes are with respect to the transmitting UE and a receiving UE operates the same regardless of whether the transmitting UE employs the first resource allocation mode or the second resource allocation mode.

In the first resource allocation mode, the base station may use a dynamic grant to allocate the resources for sidelink to a transmitting UE. The dynamic grant may also include a carrier indication field (CIF) in the DCI associated with the dynamic grant. In the second resource allocation mode, the transmitting UE applies a sensing procedure to select resources independently on each carrier. The same carrier is used for all transport blocks of the same sidelink process, at least until the process triggers a resource re-selection.

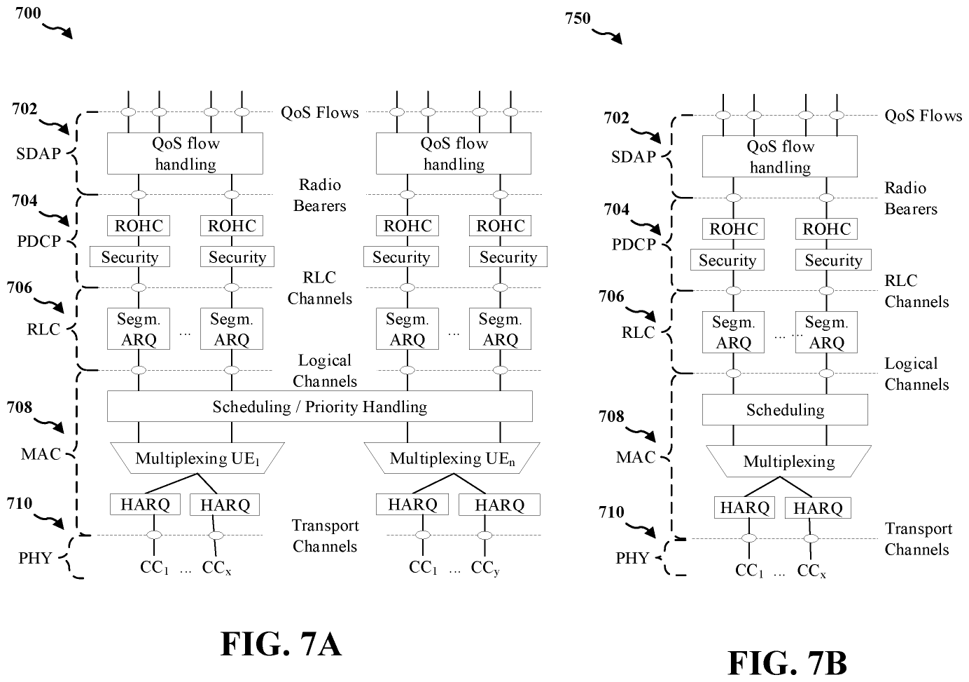

While the example of FIG. 6 illustrates an example of carrier aggregation over a sidelink interface, carrier aggregation may also be performed on Uu interface, such as a link between a base station and a UE. FIGS. 7A and 7B illustrate example downlink user plane architectures 700, 750, respectively, facilitating carrier aggregation on a Uu interface, as presented herein. The example downlink user plane architectures 700, 750 include a service data adaptation protocol (SDAP) layer 702, a PDCP layer 704, an RLC layer 706, a MAC layer 708, and a PHY layer 710.

The SDAP layer 702 performs QoS flow handling operations. The PDCP layer 704 performs ROHC operations and security operations. The RLC layer 706 performs segment automatic repeat request (ARQ) operations. The MAC layer 708 performs scheduling operations, multiplexing operations, and HARQ operations. The PHY layer 710 performs mapping to transport channel operations.

As shown in FIGS. 7A and 7B, the interface between the SDAP layer 702 and the PDCP layer may be referred to as radio bearers. The interface between the PDCP layer 704 and the RLC layer 706 may be referred to as RLC channels. The interface between the RLC layer 706 and the MAC layer 708 may be referred to logical channels. The interface between the MAC layer 708 and the PHY layer 710 may be referred to as transport channels.

It may be appreciated that each of the SDAP layer 702, the PDCP layer 704, the RLC layer 706, the MAC layer 708, and the PHY layer 710 may perform additional or alternative operations.

In the examples of FIGS. 7A and 7B, the multi-carrier nature of the PHY layer 710 is exposed to the MAC layer 708 for which one HARQ entity is associated per serving cell. For example, in both uplink and downlink, there is one independent HARQ entity per serving cell. Additionally, one transport block is generated per assignment/grant per serving cell (e.g., in the absence of spatial multiplexing). In such examples, each transport block and its potential HARQ transmissions are mapped to a single serving cell.

However, the Uu interface may be configured to support cross-carrier scheduling. For example, for an advanced service, a UE may be configured with multiple carriers (e.g., four carriers). Each of the carriers may operate as a cell. For example, if a service is associated with four carriers, one of the carriers may operate as a primary cell (PCell) and the remaining three carriers may operate as secondary cells (SCells). As used herein, the terms “primary cell” and “primary carrier” may be used interchangeably. Similarly, the terms “secondary cell” and “secondary carrier” may be used interchangeably.

In Uu communication, the primary cell may transmit a DCI (e.g. on the primary carrier). The DCI may schedule uplink and/or downlink traffic on the secondary cells. Thus, the primary cell may schedule uplink and/or downlink traffic across carriers (e.g., cross-carrier traffic). For example, the primary cell (e.g., carrier 1) may schedule data on a secondary carrier (e.g., carrier 2). The UE may then use the secondary carrier (e.g., carrier 2) to transmit or receive the data. In the above example, the DCI is transmit using a first resource (e.g., at a first time) and the transmitting or receiving of the data on the secondary carrier is using a second resource (e.g., at a second time different than the first time). Thus, the control information (e.g., DCI) is carried on the primary carrier, but the data (e.g., PUSCH or PDSCH) is carried on the secondary carriers. Additionally, a HARQ feedback from the UE may be transmitted on either the primary carrier or the secondary carrier accordingly.

However, in sidelink, the control information and the data are bundled together in a transport block. For example, the sidelink control information (SCI) and the shared channel (PSSCH) may be bundled together in one time-slot. The bandwidth allocation for the transport block may depend on the size of the transmission.

Since the control information and the data are bundled together, the scheduling information and the data transmission may not be separated. That is, in sidelink, the scheduling information may not be included in one transmission and the data transmission in a second transmission. As a result, in sidelink, the control information and the data are transmitted in a same carrier (e.g., the carrier 1, the carrier 2, etc.), which is different than in the Uu communication example.

However, the SCI transmitted with the current transmission may also indicate one or more resources reserved for retransmissions. For example, a transmitting UE may transmit a first transport block including SCI and data. The SCI may indicate resources for future transmissions (e.g., up to two resources). In the example of sidelink, the future transmissions may be associated with potential retransmissions of the data. For example, if a receiving UE is unsuccessful at decoding the first transport block, the receiving UE may transmit a NACK message. The transmitting UE may then, based on the NACK message, use one (or both) of the reserved resources to retransmit the data.

As described above, advanced services, such as the transmission of detour information, may be associated with high reliability and low latency communication. To support the higher bandwidth associated with advanced services, the UE may use higher frequency spectrums, such as FR2 and/or the unlicensed frequency spectrum. While FR2 provides for higher bandwidth, FR2 signals may also incur blockage and/or attenuation, which may result in dynamic channel conditions compared to the lower frequency spectrum (e.g., FR1). The unlicensed frequency spectrum may be dynamic and also undeterministic based on channel occupancy. For example, the UE may co-exist with Wi-Fi devices and compete with unlicensed channels. That is, even if the UE reserves a resource, a Wi-Fi device may still use the resource.

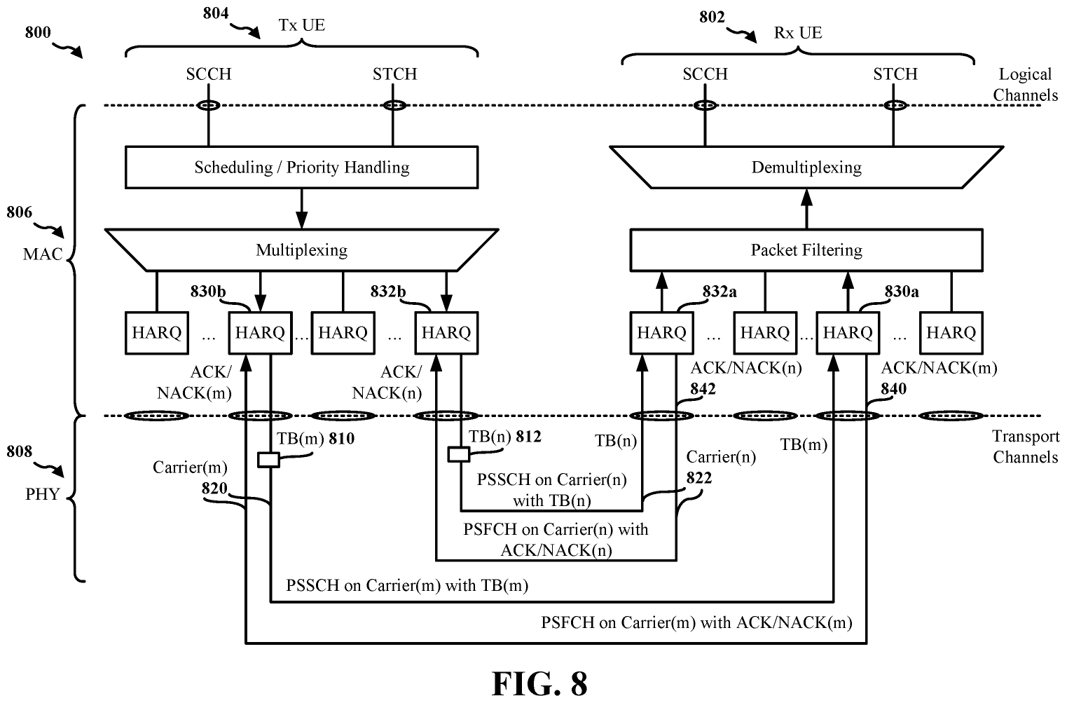

FIG. 8 illustrates an example communication flow 800 between a first wireless device 802 and a second wireless device 804. In the example of FIG. 8, the first wireless device 802 is a receiving UE (Rx UE) and the second wireless device 804 is a transmitting UE (Tx UE). For example, the second wireless device 804 may transmit one or more transport blocks (TBs) that are received by the first wireless device 802. The example communication flow 800 illustrates the processing at a MAC layer 806 and a PHY layer 808 for sidelink communication. Although not shown in the illustrated example of FIG. 8, it may be appreciated that the PHY layer 808 may include decoding operations to facilitate decoding of a received transport block. In the illustrated example, the logical channels include a sidelink control channel (SCCH) and a sidelink traffic channel (STCH). However, other examples may include additional or alternative logical channels.

In the example of FIG. 8, the second wireless device 804 transmits a first transport block 810 (TB(m)) on a first carrier 820 (carrier(m)). The second wireless device 804 also transmits a second transport block 812 (TB(n)) on a second carrier 822 (carrier(n)). For example, the second wireless device 804 may use a shared channel (PSSCH) on the first carrier 820 to transmit the first transport block 810. The second wireless device 804 may also use a shared channel (PSSCH) on the second carrier 822 to transmit the second transport block 812.

The first wireless device 802 receives the transport blocks on the same carriers. For example, the first wireless device 802 receives the first transport block 810 on the first carrier 820. The first wireless device 802 also receives the second transport block 812 on the second carrier 822. The HARQ entities at the first wireless device 802 generate HARQ feedback that is transmitted to the second wireless device 804. For example, a first HARQ entity 830a and a second HARQ entity 832a of the first wireless device 802 receive the transport blocks 810, 812, respectively, and generate ACK/NACK messages based on whether the decoding of the transport blocks 810, 812 is successful.

In the illustrated example, each HARQ entity is associated with a respective carrier. For example, the first HARQ entity 830a is associated with the first carrier 820 and receives the first transport block 810. The second HARQ entity 832a is associated with the second carrier 822 and receives the second transport block 812. As shown in FIG. 8, each HARQ entity generates a respective ACK/NACK message. For example, the first HARQ entity 830a generates a first ACK/NACK message 840 based on whether decoding of the first transport block 810 is successful. In a similar manner, the second HARQ entity 832a generates a second ACK/NACK message 842 based on whether decoding of the second transport block 812 is successful. The first wireless device 802 may use a feedback channel (PSFCH) on the first carrier 820 to transmit the first ACK/NACK message 840. The first wireless device 802 may also use a feedback channel (PSFCH) on the second carrier 822 to transmit the second ACK/NACK message 842.

As shown in FIG. 8, the second wireless device 804 also includes HARQ entities that are associated with respective carriers. For example, the second wireless device 804 includes a first HARQ entity 830b associated with the first carrier 820. The second wireless device 804 also includes a second HARQ entity 832b associated with the second carrier 822.

In the illustrated example of FIG. 8, the first HARQ entity 830b receives the first ACK/NACK message 840 on the first carrier 820. The first HARQ entity 830b may then determine whether to retransmit the first transport block 810 on the first carrier 820 based on the ACK/NACK message 840. In a similar manner, the second HARQ entity 832b receives the second ACK/NACK message 842 on the second carrier 822. The second HARQ entity 832b may then determine whether to retransmit the second transport block 812 on the second carrier 822 based on the ACK/NACK message 842.

As described above, to accommodate traffic associated with high reliability and low latency (e.g., advanced services associated with high data throughput), the transmitting UE (e.g., the second wireless device 804) may use carriers associated with higher frequency ranges, such as FR2 and/or unlicensed frequencies. In such examples, the conditions on the carriers may be changing and/or undeterministic. For example, conditions associated with the first carrier 820 may be acceptable when the second wireless device 804 transmits the first transport block 810, but the conditions associated with the first carrier 820 may be unacceptable or unavailable when the first wireless device 802 transmits the first ACK/NACK message 840 on the first carrier 820. In such examples, the second wireless device 804 may not receive the first ACK/NACK message 840 and, thus, may be unable to determine whether to retransmit the first transport block 810. Additionally, in examples in which the HARQ entities are configured to transmit NACK-only feedback (e.g., no HARQ feedback is provided if decoding of the respective transport block is successful), the absence of the first ACK/NACK message 840 at the first HARQ entity 830b may result in the first HARQ entity 830b determining to forego retransmitting the first transport block 810.

Thus, to improve resource utilization over carriers for HARQ-enabled transmissions and to facilitate reliable and timely HARQ feedback (e.g., for advanced V2X services with stringent performance demands), examples disclosed herein provide techniques for implementing cross-carrier HARQ feedback. For example, aspects disclosed herein provide for a receiving UE to map one or more ACK/NACK messages from respective carriers on to a feedback carrier that is different than the respective carriers. In some examples, different ACK/NACK messages may be mapped on to different feedback carriers. In other examples, different ACK/NACK messages may be aggregated and mapped on to a same feedback carrier.

Examples disclosed herein provide techniques for the transmitting UE to process the cross-carrier HARQ feedback to recover the ACK/NACK message(s) and to forward the ACK/NACK message(s) to the correct HARQ entity (or entities). For example, the cross-carrier HARQ feedback may include an ACK/NACK message associated with a first carrier that is different than the feedback carrier. The transmitting UE may receive the cross-carrier HARQ feedback on the feedback carrier and determine that the cross-carrier HARQ feedback includes the ACK/NACK message associated with the first carrier. The transmitting UE may then forward the ACK/NACK message to the HARQ entity associated with the first carrier to determine whether to retransmit the respective transport block.

The feedback carrier may be associated with relatively more stable (e.g., reliable) conditions than the carriers for which the ACK/NACK messages were generated. For example, when the wireless devices are configured with inter-band carriers, the carriers used to transmit the transport blocks may be associated with higher frequencies with wide bandwidth for high data rate (e.g., FR2) and the feedback carrier(s) may be associated with lower frequencies with narrow bandwidth for reliable HARQ feedback(e.g., FR1). In other examples, the carriers used to transmit the transport blocks may be associated with the unlicensed frequency spectrum with more bandwidth for high data rate and the feedback carrier(s) may be associated with the licensed frequency spectrum for reliable HARQ feedback. In other examples in which the wireless devices are configured for with intra-band carriers, the carriers used to transmit the transport blocks may be associated with higher operating bands and the feedback carrier(s) may be associated with lower operating bands within the same frequency range.

In some examples, the wireless devices may be preconfigured with the feedback carrier to use for the cross-carrier HARQ feedback. In some examples, the wireless devices may be configured with the feedback carrier to use for the cross-carrier HARQ feedback. In some examples, the feedback carrier may be semi-statically selected and activated. For example, the receiving UE may be configured with a carrier configuration including a list of feedback carriers and then receive an activation indication to start using one or more of the feedback carriers of the carrier configuration. In some examples, the feedback carrier may be dynamically selected and indicated. For example, the receiving UE may receive information regarding the feedback carrier to use along with a transport block. The receiving UE may receive the carrier configuration, the activation indication, and/or the information regarding the feedback carrier from the transmitting UE, or another wireless device, such as an RSU, a base station, a group lead, a cluster head, and/or a scheduling UE.

To facilitate the transmitting UE to recover the ACK/NACK message(s) of the cross-carrier HARQ feedback, the receiving UE may transmit a demapping indicator along with the cross-carrier HARQ ACK/NACK feedback. The demapping indicator may indicate the ACK/NACK message(s) included in the cross-carrier HARQ feedback and to which HARQ entity (or entities) and/or carrier(s) the ACK/NACK message(s) are associated. For example, the demapping indicator may indicate that the cross-carrier HARQ feedback includes a first ACK/NACK message associated with a first carrier or a first transport block and a second ACK/NACK message associated with a second carrier or a second transport block. The transmitting UE may use the demapping indicator to determine the respective HARQ entities associated with the carriers of transmitted packets or the transport blocks of the transmitted packets, and to forward the respective ACK/NACK messages to the correct HARQ entities, which may then determine whether to retransmit the corresponding transport block.

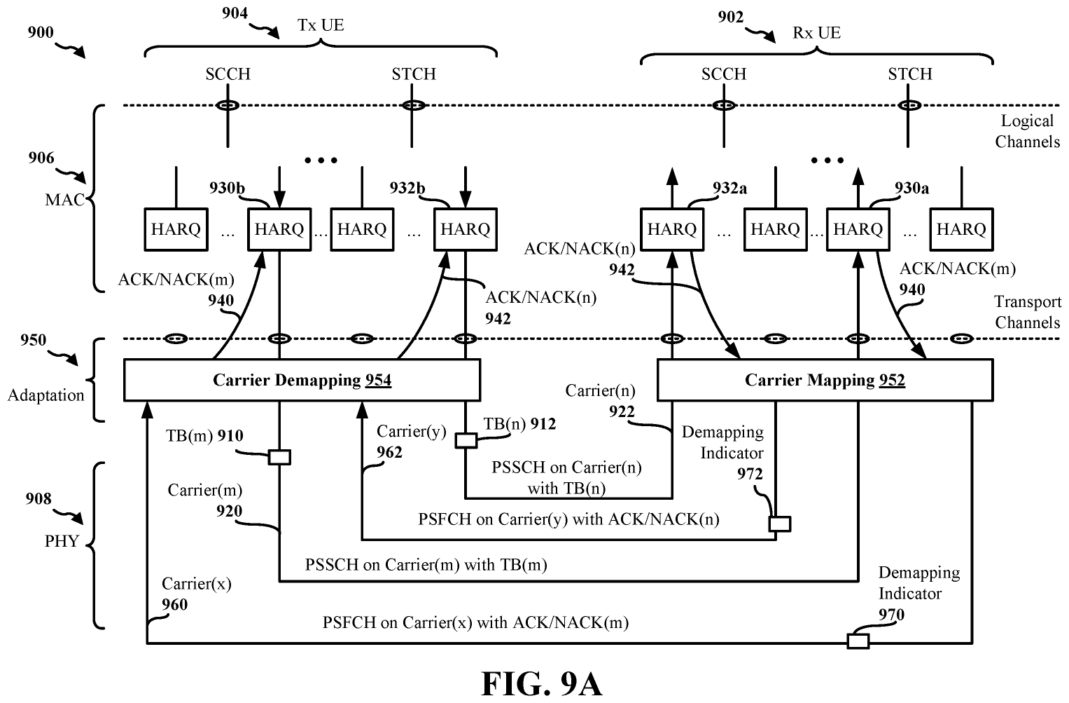

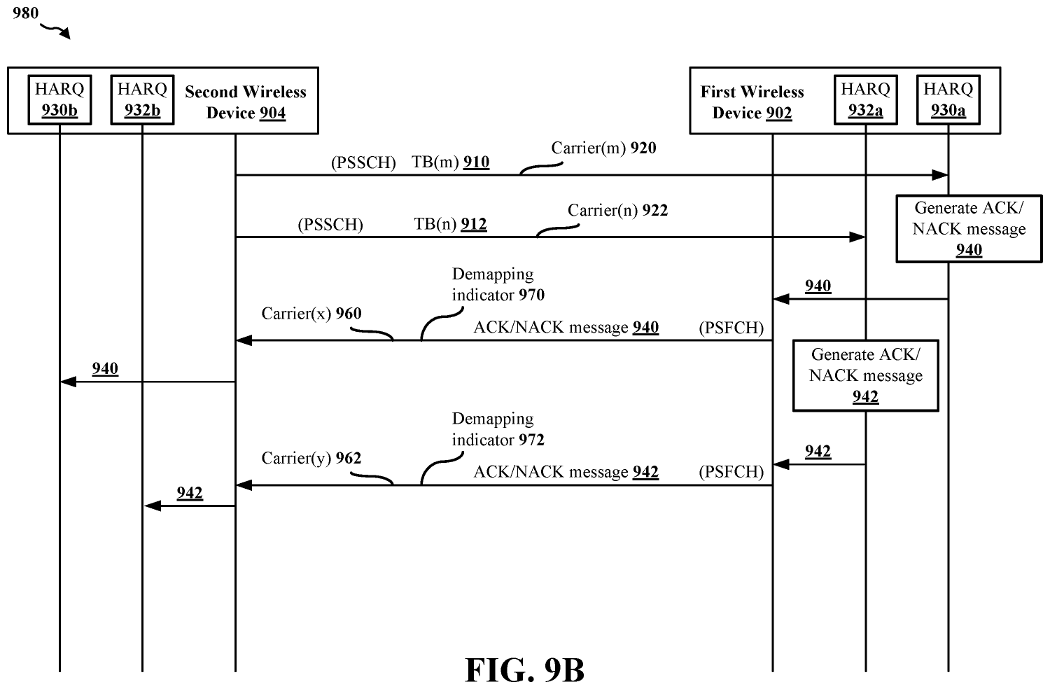

FIG. 9A illustrates an example communication flow 900 between a first wireless device 902 and a second wireless device 904 employing cross-carrier HARQ feedback, as presented herein. FIG. 9B illustrates another example communication flow 980 between the first wireless device 902 and the second wireless device 904 employing cross-carrier feedback, as presented herein. Aspects of FIGS. 9A and 9B are described together herein. In the examples of FIG. 9A and 9B, the first wireless device 902 is a receiving UE (Rx UE) and the second wireless device 904 is a transmitting UE (Tx UE). For example, the second wireless device 904 may transmit one or more transport blocks (TBs) that are received by the first wireless device 902. Similar to the example of FIG. 8, the example communication flow 900 of FIG. 9A illustrates the processing at a MAC layer 906 and a PHY layer 908 for sidelink communication. Although not shown in the illustrated example of FIG. 9A, it may be appreciated that the PHY layer 908 may include decoding operations to facilitate decoding of a received transport block. In the illustrated example, the logical channels include a sidelink control channel (SCCH) and a sidelink traffic channel (STCH). However, other examples may include additional or alternative logical channels. To improve readability, certain operations of the MAC layer 906, as shown in the MAC layer 806 of FIG. 8, have been removed from the illustrated example of FIG. 9A.

Similar to the example of FIG. 8, in the illustrated examples of FIGS. 9A and 9B, the second wireless device 904 transmits a first transport block 910 (TB(m)) on a first carrier 920 (carrier(m)). The second wireless device 904 also transmits a second transport block 912 (TB(n)) on a second carrier 922 (carrier(n)). For example, the second wireless device 904 may use a shared channel (PSSCH) on the first carrier 920 to transmit the first transport block 910. The second wireless device 904 may also use a shared channel (PSSCH) on the second carrier 922 to transmit the second transport block 912.

The first wireless device 902 receives the transport blocks on the same carriers. For example, the first wireless device 902 receives the first transport block 910 on the first carrier 920. The first wireless device 902 also receives the second transport block 912 on the second carrier 922. The HARQ entities at the first wireless device 902 generate HARQ feedback for transmitting to the second wireless device 904. For example, a first HARQ entity 930a and a second HARQ entity 932a of the first wireless device 902 receive the transport blocks 910, 912, respectively, and generate ACK/NACK messages based on whether the decoding of the transport blocks 910, 912 is successful.

Similar to the example of FIG. 8, each HARQ entity of FIGS. 9A and 9B is associated with a respective carrier. For example, the first HARQ entity 930a is associated with the first carrier 920 and/or the received first transport block 910. The second HARQ entity 932a is associated with the second carrier 922 and/or the received second transport block 912. As shown in FIGS. 9A and 9B, each HARQ entity generates a respective ACK/NACK message. For example, the first HARQ entity 930a generates a first ACK/NACK message 940 based on whether decoding of the first transport block 910 is successful. In a similar manner, the second HARQ entity 932a generates a second ACK/NACK message 942 based on whether decoding of the second transport block 912 is successful.

In the illustrated example of FIG. 9A, the generated HARQ feedback is forwarded to a carrier mapping component 952. For example, the first HARQ entity 930a may forward the first ACK/NACK message 940 to the carrier mapping component 952. The second HARQ entity 932a may forward the second ACK/NACK message 942 to the carrier mapping component 952.

The carrier mapping component 952 determines a feedback carrier to use to transmit cross-carrier HARQ feedback to the second wireless device 904. For example, in the illustrated example of FIG. 9A, the carrier mapping component 952 may determine to use a first feedback carrier 960 (carrier(x)) and a second feedback carrier 962 (carrier(y)). As shown in FIG. 9A, the carrier mapping component 952 maps the first ACK/NACK message 940 to the first feedback carrier 960. The carrier mapping component 952 also maps the second ACK/NACK message 942 to the second feedback carrier 962.

The first wireless device 902 may use a feedback channel (PSFCH) on the first feedback carrier 960 to transmit the first ACK/NACK message 940. The first wireless device 902 may also use a feedback channel (PSFCH) on the second feedback carrier 962 to transmit the second ACK/NACK message 942.

To facilitate processing of the cross-carrier HARQ feedback to recover the ACK/NACK messages (e.g., the ACK/NACK messages 940, 942 carried on the feedback carriers 960, 962, respectively), the carrier mapping component 952 may include a demapping indicator with the cross-carrier HARQ feedback. For example, the carrier mapping component 952 may include a first demapping indicator 970 with the first ACK/NACK message 940 on the first feedback carrier 960. The first demapping indicator 970 may indicate that the HARQ feedback carried on the first feedback carrier (e.g., the first ACK/NACK message 940) is associated with the first carrier 920 or the first TB 910. In a similar manner, the carrier mapping component 952 may include a second demapping indicator 972 with the second ACK/NACK message 940 on the second feedback carrier 962 indicating a relationship between the HARQ feedback and the carrier or the TB.

As shown in FIG. 9A, the second wireless device 904 includes a carrier demapping component 954 that is configured to recover one or more ACK/NACK messages from cross-carrier HARQ feedback received on a feedback carrier. For example, the carrier demapping component 954 may use the demapping indicator included with cross-carrier HARQ feedback to determine a HARQ entity associated with handling the respective ACK/NACK message. In the illustrated example of FIG. 9A, the carrier demapping component 954 may receive the first ACK/NACK message 940 and the first demapping indicator 970 on the first feedback carrier 960. The carrier demapping component 954 may determine, based on the first demapping indicator 970, that the first ACK/NACK message 940 corresponds to the first transport block 910 on the first carrier 920. The carrier demapping component 954 may then forward the first ACK/NACK message 940 to a first HARQ entity 930b associated with the first carrier 920 or the first TB 910. In a similar manner, the carrier demapping component 954 may determine, based on the second demapping indicator 972, that the second ACK/NACK message 942 corresponds to the second transport block 912 on the second carrier 922. The carrier demapping component 954 may then forward the second ACK/NACK message 942 to a second HARQ entity 932b associated with the second carrier 922 or the second TB 912. The first HARQ entity 930b and the second HARQ entity 932b may then determine whether to retransmit their respective transport blocks based on the ACK/NACK messages.

In the illustrated example of FIG. 9A, the carrier mapping component 952 and the carrier demapping component 954 are implemented by an adaptation layer 950 (or a function or sub-layer). Although the adaptation layer 950, the carrier mapping 952, and the carrier demapping component 954 are depicted as separate entities between the MAC layer 906 and the PHY layer 908, in other examples, the adaptation layer 950, the carrier mapping component 952, and/or the carrier demapping component 954 may be a sub-layer or functions of another layer. For example, the adaptation layer 950, the carrier mapping component 952, and/or the carrier demapping component 954 may be implemented by a lower sub-layer or functions of the MAC layer 906. In other examples, the adaptation layer 950, the carrier mapping component 952, and/or the carrier demapping component 954 may be implemented by an upper sub-layer or functions of the PHY layer 908.

As shown in FIG. 9A, the carrier mapping component 952 may map HARQ feedback from a first carrier on to a second carrier (e.g., a feedback carrier). Thus, the carrier mapping component 952 facilitates breaking the one-to-one mapping of the transport block and the HARQ feedback with a same carrier. Although the example of FIGS. 9A and 9B describe using different feedback carriers for different ACK/NACK messages, in other examples, the carrier mapping component 952 may aggregate different ACK/NACK messages on to a single feedback carrier. For example, in the illustrated example of FIG. 9A, the carrier mapping component 952 maps the first ACK/NACK message 940 on to the first feedback carrier 960 and maps the second ACK/NACK message 942 on to the second feedback carrier 962. Thus, the first wireless device 902 transmits the first ACK/NACK message 940 on the first feedback carrier 960. The first wireless device 902 also transmits the second ACK/NACK message 942 on the second feedback carrier 962.

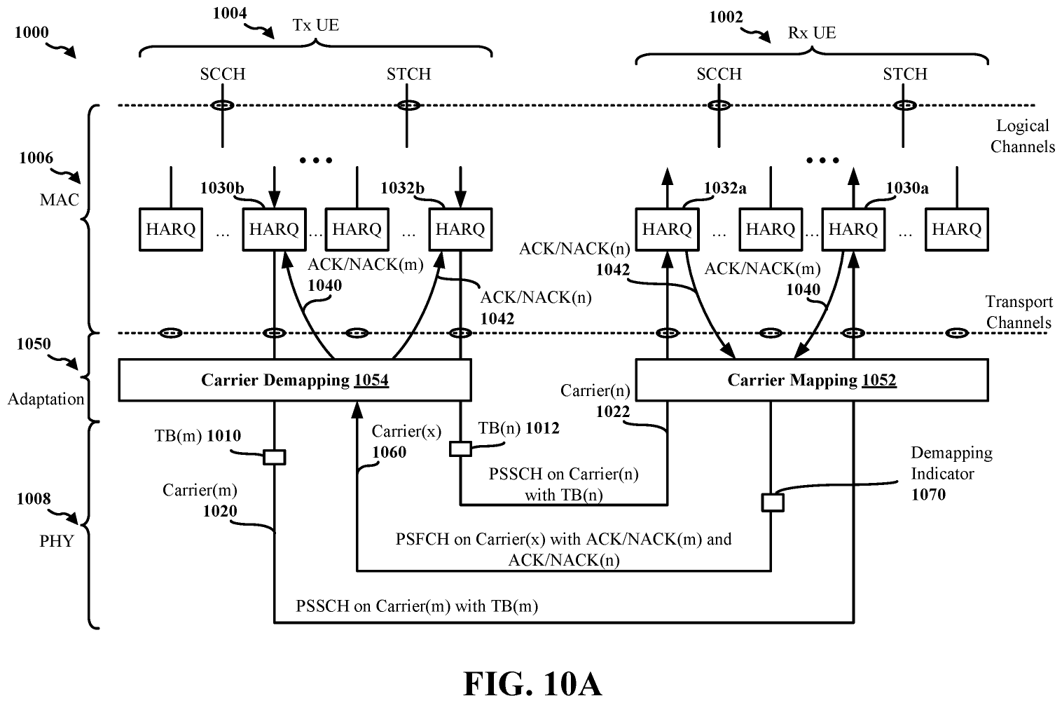

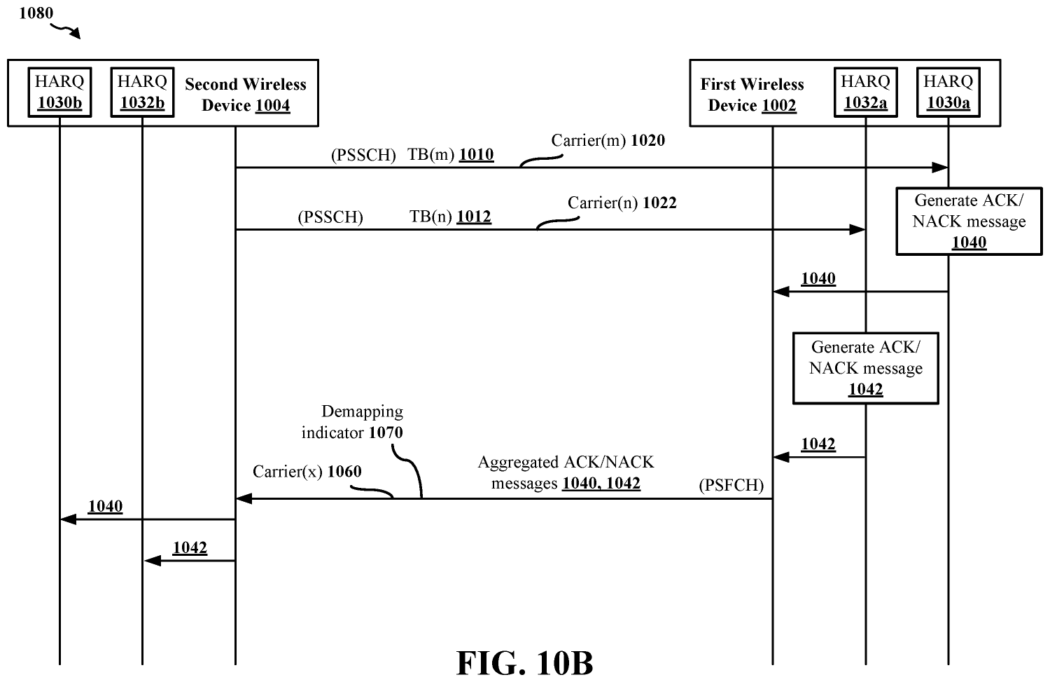

FIG. 10A illustrates another example communication flow 1000 between a first wireless device 1002 and a second wireless device 1004 employing cross-carrier HARQ feedback, as presented herein. FIG. 10B illustrates another example communication flow 1080 between the first wireless device 1002 and the second wireless device 1004 employing cross-carrier feedback, as presented herein. Aspects of FIGS. 10A and 10B are described together herein. In the illustrated examples of FIGS. 10A and 10B, aspects of the first wireless device 1002 and the second wireless device 1004 may be similar to the first wireless device 902 and the second wireless device 904 of FIGS. 9A and 9B. Similar to the examples of FIGS. 8, 9A, and 9B, the example communication flow 1000 illustrates the processing at a MAC layer 1006 and a PHY layer 1008 for sidelink communication.

In the illustrated examples, the second wireless device 1004 may transmit a first transport block 1010 (TB(m)) on a first carrier 1020 (carrier(m)) and a second transport block 1012 (TB(n)) on a second carrier 1022 (carrier(n)). For example, the second wireless device 1004 may use a shared channel (PSSCH) on the first carrier 1020 to transmit the first transport block 1010. The second wireless device 1004 may also use a shared channel (PSSCH) on the second carrier 1022 to transmit the second transport block 1012.

Similar to the examples of FIGS. 9A and 9B, the first wireless device 1002 receives the transport blocks on the same carriers. For example, the first wireless device 1002 receives the first transport block 1010 on the first carrier 1020, and also receives the second transport block 1012 on the second carrier 1022. The HARQ entities at the first wireless device 1002 generate HARQ feedback for transmitting to the second wireless device 1004. For example, a first HARQ entity 1030a and a second HARQ entity 1032a of the first wireless device 1002 receive the transport blocks 1010, 1012, respectively, and generate ACK/NACK messages based on whether the decoding of the transport blocks 1010, 1012 is successful.

In the illustrated example, the first HARQ entity 1030a is associated with the first carrier 1020 and/or the received first transport block 1010. The second HARQ entity 1032a is associated with the second carrier 1022 and/or the received second transport block 1012. As shown in FIGS. 10A and 10B, each HARQ entity generates a respective ACK/NACK message. For example, the first HARQ entity 1030a generates a first ACK/NACK message 1040 based on whether decoding of the first transport block 1010 is successful. In a similar manner, the second HARQ entity 1032a generates a second ACK/NACK message 1042 based on whether decoding of the second transport block 1012 is successful.

Similar to the example of FIG. 9A, the generated HARQ feedback is forwarded to a carrier mapping component 1052. For example, the first HARQ entity 1030a may forward the first ACK/NACK message 1040 to the carrier mapping component 1052. The second HARQ entity 1032a may forward the second ACK/NACK message 1042 to the carrier mapping component 1052.

The carrier mapping component 1052 determines a feedback carrier to use to transmit cross-carrier HARQ feedback to the second wireless device 1004. For example, in the illustrated example of FIG. 10A, the carrier mapping component 1052 may determine to use a feedback carrier 1060 (carrier(x)). As shown in FIG. 10A, the carrier mapping component 1052 maps the first ACK/NACK message 1040 and the second ACK/NACK message 1042 to the feedback carrier 1060. For example, the carrier mapping component 1052 may aggregate the first ACK/NACK message 1040 and the second ACK/NACK message 1042 and map the aggregated ACK/NACK messages to the feedback carrier 1060.

The first wireless device 1002 may use a feedback channel (PSFCH) on the feedback carrier 1060 to transmit the aggregated ACK/NACK messages (e.g., the first ACK/NACK message 1040 and the second ACK/NACK message 1042). To facilitate demapping of the cross-carrier HARQ feedback (e.g., the aggregated ACK/NACK messages 1040, 1042 carried on the feedback carrier 1060), the carrier mapping component 1052 may include a demapping indicator with the cross-carrier HARQ feedback. For example, the carrier mapping component 1052 may include a demapping indicator 1070 with the cross-carrier HARQ feedback (e.g., the aggregated ACK/NACK messages 1040, 1042) on the feedback carrier 1060. The demapping indicator 1070 may indicate that the HARQ feedback carried on the feedback carrier 1060 includes the first ACK/NACK message 1040 and the second ACK/NACK message 1042. The demapping indicator 1070 may also indicate that the first ACK/NACK message 1040 is associated with the first carrier 1020 or the first TB 1010 and that the second ACK/NACK message 1042 is associated with the second carrier 1022 or the second TB 1012. In some example, the demapping indicator 1070 may be implicitly indicated via the order of ACKs/NACKs aggregated, e.g., the HARQ feedback may aggregate the ACKs/NACKs with the order of {first ACK/NACK for first carrier or first transport black, second ACK/NACK for second carrier or second transport black, . . . }.

As shown in FIG. 10A, the second wireless device 1004 includes a carrier demapping component 1054 that is configured to recover one or more ACK/NACK messages from cross-carrier HARQ feedback received on a feedback carrier. For example, the carrier demapping component 1054 may use the demapping indicator included with cross-carrier HARQ feedback to determine a HARQ entity associated with handling the respective ACK/NACK message. In the illustrated example of FIG. 10A, the carrier demapping component 1054 may receive the aggregated ACK/NACK messages 1040, 1042 and the demapping indicator 1070 on the feedback carrier 1060. The carrier demapping component 1054 may determine, based on the demapping indicator 1070, that the cross-carrier HARQ feedback includes the first ACK/NACK message 1040 and the second ACK/NACK message 1042. The carrier demapping component 1054 may also determine, based on the demapping indicator 1070, that the first ACK/NACK message 1040 is associated with the first carrier 1020 or the first TB 1010 and that the second carrier 1022 or the second TB 1012. The carrier demapping component 1054 may then forward the first ACK/NACK message 1040 to a first HARQ entity 1030b associated with the first carrier 1020 or the first TB 1010. In a similar manner, the carrier demapping component 1054 may also forward the second ACK/NACK message 1042 to a second HARQ entity 1032b associated with the second carrier 1022 or the second TB 1012. The first HARQ entity 1030b and the second HARQ entity 1032b may then determine whether to retransmit their respective transport blocks based on the ACK/NACK messages.

Similar to the example of FIG. 9A, the carrier mapping component 1052 and the carrier demapping component 1054 are implemented by an adaptation layer 1050 (or function or sub-layer). Although the adaptation layer 1050, the carrier mapping component 1052, and the carrier demapping component 1054 are depicted as separate entities between the MAC layer 1006 and the PHY layer 1008, in other examples, the adaptation layer 1050, the carrier mapping component 1052, and/or the carrier demapping component 1054 may be a sub-layer or functions of another layer. For example, the adaptation layer 1050, the carrier mapping component 1052, and/or the carrier demapping component 1054 may be implemented by a lower sub-layer or functions of the MAC layer 1006. In other examples, the adaptation layer 1050, the carrier mapping component 1052, and/or the carrier demapping component 1054 may be implemented by an upper sub-layer or functions of the PHY layer 1008.

As shown in FIG. 10A, the carrier mapping component 1052 may map HARQ feedback from different carriers on to a feedback carrier (e.g., the HARQ feedback associated with the first carrier or the first TB and the second carrier or second TB on to a feedback carrier). Thus, the carrier mapping component 1052 facilitates breaking the one-to-one mapping of the transport block and the HARQ feedback with a same carrier.

In the illustrated examples of FIGS. 9A, 9B, 10A and 10B, the feedback carriers may be associated with relatively more stable channel conditions than the traffic carriers (e.g., the non-feedback carriers). For example, when the wireless devices are configured with inter-band carriers, the feedback carriers (e.g., the first feedback carrier 960, the second feedback carrier 962, and the feedback carrier 1060) may be associated with a lower frequency range (e.g., FR1) compared to the traffic carriers (e.g., the first carriers 920, 1020, and the second carriers 922, 1022), which may be associated with a higher frequency range (e.g., FR2). In other examples, the feedback carriers (e.g., the first feedback carrier 960, the second feedback carrier 962, and the feedback carrier 1060) may be associated with a licensed frequency spectrum while the traffic carriers (e.g., the first carriers 920, 1020, and the second carriers 922, 1022) may be associated with the unlicensed frequency spectrum. In examples in which the wireless devices are configured with intra-band carriers, the feedback carriers (e.g., the first feedback carrier 960, the second feedback carrier 962, and the feedback carrier 1060) may be associated with a lower operating band of a frequency range and the traffic carriers (e.g., the first carriers 920, 1020, and the second carriers 922, 1022) may be associated with a higher operating band of the frequency range. The higher frequency ranges associated with the traffic carriers may facilitate high data throughput, while the lower frequency ranges associated with the feedback carriers may facilitate improved reliability and timely HARQ feedback for determining whether to retransmit a transport block.

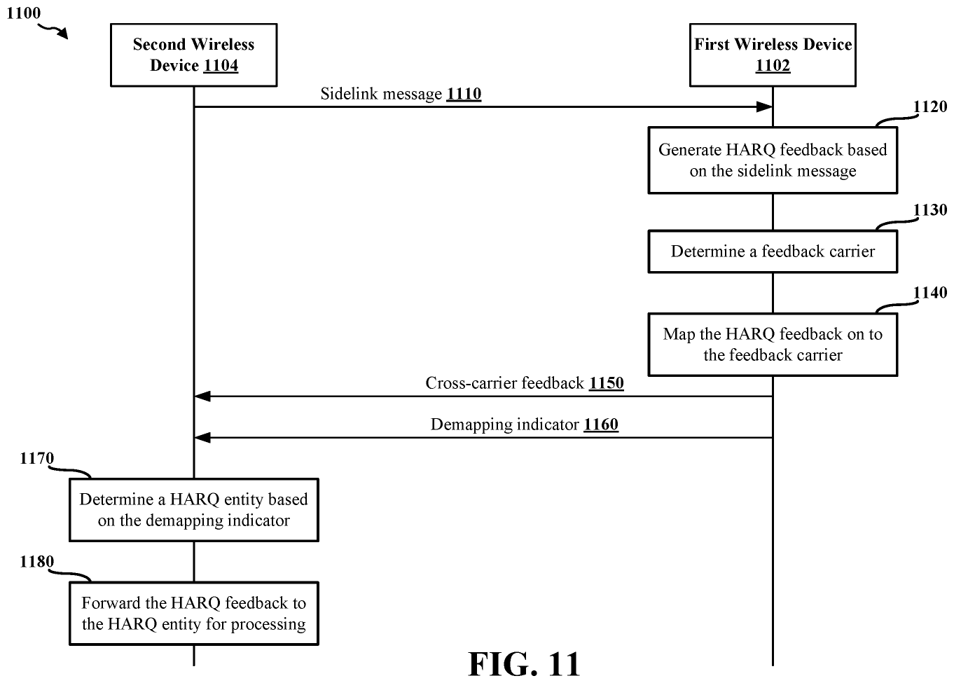

FIG. 11 illustrates an example communication flow 1100 between a first wireless device 1102 and a second wireless device 1104, as presented herein. In the illustrated example, the communication flow 1100 facilitates cross-carrier HARQ feedback in sidelink. Aspects of the first wireless device 1102 may be implemented by the wireless devices 310, 350 of FIG. 3, the first wireless device 902 of FIGS. 9A, 9B, and/or the first wireless device 1002 of FIGS. 10A, 10B. Aspects of the second wireless device 1104 may be implemented by the wireless devices 310, 350 of FIG. 3, the second wireless device 904 of FIGS. 9A, 9B, and/or the second wireless device 1004 of FIGS. 10A, 10B.

In the illustrated example of FIG. 11, the first wireless device 1102 is a receiving UE that receives transport block(s) from the second wireless device 1104 (e.g., a transmitting UE). For example, the second wireless device 1104 transmits a sidelink message 1110 that is received by the first wireless device 1102. The sidelink message 1110 may include a transport block on a traffic carrier. For example, and referring to the examples of FIGS. 9A, 9B, 10A, and/or 10B, the sidelink message 1110 may include a first transport block 910, 1010 on a first carrier 920, 1020. The traffic carrier may be associated with a high data throughput. The second wireless device 1104 may use a shared channel (PSSCH) on the traffic carrier to transmit the sidelink message 1110.

At 1120, the first wireless device 1102 generates feedback based on the sidelink message 1110. For example, a HARQ entity associated with the traffic carrier may generate an ACK/NACK message based on whether the transport block on the traffic carrier is successfully processed. For example, the first wireless device 1102 may generate an ACK message when the transport block is successfully processed. The first wireless device 1102 may generate a NACK message when the transport block is unsuccessfully processed.

At 1130, the first wireless device 1102 determines a feedback carrier to use for cross-carrier HARQ feedback. The feedback carrier may be associated with relatively stable channel conditions than the traffic carrier. For example, the feedback carrier may be associated with a lower frequency spectrum, a licensed frequency spectrum, or a lower operational band of a frequency range. The determining of the feedback carrier, at 1130, may be performed at an abstraction layer (e.g., the abstraction layers 950, 1050) or function (e.g., the carrier mapping component 952, 1052). In some examples, the abstraction layer or function may be a sub-layer or function of a MAC layer. In other examples, the abstraction layer may be a sub-layer or function of a PHY layer.

At 1140, the first wireless device 1102 maps the HARQ feedback on to the feedback carrier. In some examples, the first wireless device 1102 may select different feedback carriers for different HARQ feedback. For example, and referring to the example of FIGS. 9A and 9B, the first wireless device 1102 may map the first ACK/NACK message 940 on to the first feedback carrier 960 and may map the second ACK/NACK message 942 on to the second feedback carrier 962. In some examples, the first wireless device 1102 may determine to aggregate one or more HARQ feedback on to a feedback carrier. For example, and referring to the example of FIGS. 10A and 10B, the first wireless device 1102 may aggregate the first ACK/NACK message 1040 and the second ACK/NACK message 1042 on to the feedback carrier 1060. The mapping of the HARQ feedback on to the feedback carrier, at 1140, may be performed at an abstraction layer (e.g., the abstraction layers 950, 1050) or a function (e.g., the carrier demapping component 952, 1052). In some examples, the abstraction layer or function may be a sub-layer or function of a MAC layer. In other examples, the abstraction layer may be a sub-layer or function of a PHY layer.

As shown in FIG. 11, the first wireless device 1102 transmits cross-carrier feedback 1150 that is received by the second wireless device 1104. The first wireless device 1102 transmits the cross-carrier feedback 1150 on the feedback carrier. The first wireless device 1102 may use a feedback channel (PSFCH) on the feedback carrier to transmit the cross-carrier feedback 1150. In some examples, the cross-carrier feedback 1150 may be transmitted on different feedback carrier, as described in connection with FIGS. 9A and 9B. In some examples, the cross-carrier feedback 1150 may include aggregated ACK/NACK messages, as described in connection with FIGS. 10A and 10B.

The first wireless device 1102 also transmits a demapping indicator 1160 that is received by the second wireless device 1104. The demapping indicator 1160 facilitates recovering the HARQ feedback from the cross-carrier feedback 1150 and forwarding the HARQ feedback to the appropriate HARQ entity for processing. Although the cross-carrier feedback 1150 and the demapping indicator 1160 are illustrated as separate transmissions in the example of FIG. 11, in other examples, the cross-carrier feedback 1150 and the demapping indicator 1160 may be transmitted in a single transmission, as described above in connection with FIGS. 9A, 9B, 10A, and/or 10B.

At 1170, the second wireless device 1104 determines a HARQ entity for processing the HARQ feedback of the cross-carrier feedback 1150. For example, the second wireless device 1104 may use the demapping indicator 1160 to determine the HARQ entity. The HARQ entity may be configured to handle the processing of an ACK/NACK message associated with a carrier or a TB. For example, and referring to the examples of FIGS. 9A, 9B, 10A, and/or 10B, the first HARQ entities 930b, 1030b are associated with the first carriers 920, 1020, or first TBs 910, 1010, respectively, and are configured to handle the processing of the first ACK/NACK messages 940, 1040 associated with the first transport blocks 910, 1010 carried on the respective first carriers 920, 1020. The determining of the HARQ entity for processing, at 1170, may be performed at an abstraction layer (e.g., the abstraction layers 950, 1050) or function (e.g., the carrier mapping component 954, 1054). In some examples, the abstraction layer or function may be a sub-layer or function of a MAC layer. In other examples, the abstraction layer or function may be a sub-layer or function of a PHY layer.

At 1180, the second wireless device 1104 forward the HARQ feedback to the HARQ entity for processing. For example, the second wireless device 1104 may forward the first ACK/NACK message 940 to the first HARQ entity 930b and may forward the second ACK/NACK message 942 to the second HARQ entity 932b. The HARQ entities may then determine whether to retransmit the respective transport blocks based on the received ACK/NACK messages.

Although the example of FIG. 11 includes a single sidelink message, in other examples, the second wireless device 1104 may transmit any suitable quantity of sidelink messages that may be received by the first wireless device 1102. Additionally, the second wireless device 1104 may use any suitable quantity of carriers to transmit the sidelink messages.

As described in FIG. 11, the first wireless device 1102 determines, at 1130, a feedback carrier to use for transmitting the cross-carrier feedback 1150. In some examples, the first wireless device 1102 may be pre-configured or configured (e.g., by the network) with one or more sidelink carrier components for feedback. In some examples, the feedback carrier may be semi-statically selected and activated/deactivated by the network or a third device. In some examples, the feedback carrier may be dynamically selected and indicated by the network, a third device, the transmitting UE, the receiving UE, and/or a field replaceable unit (FRU).

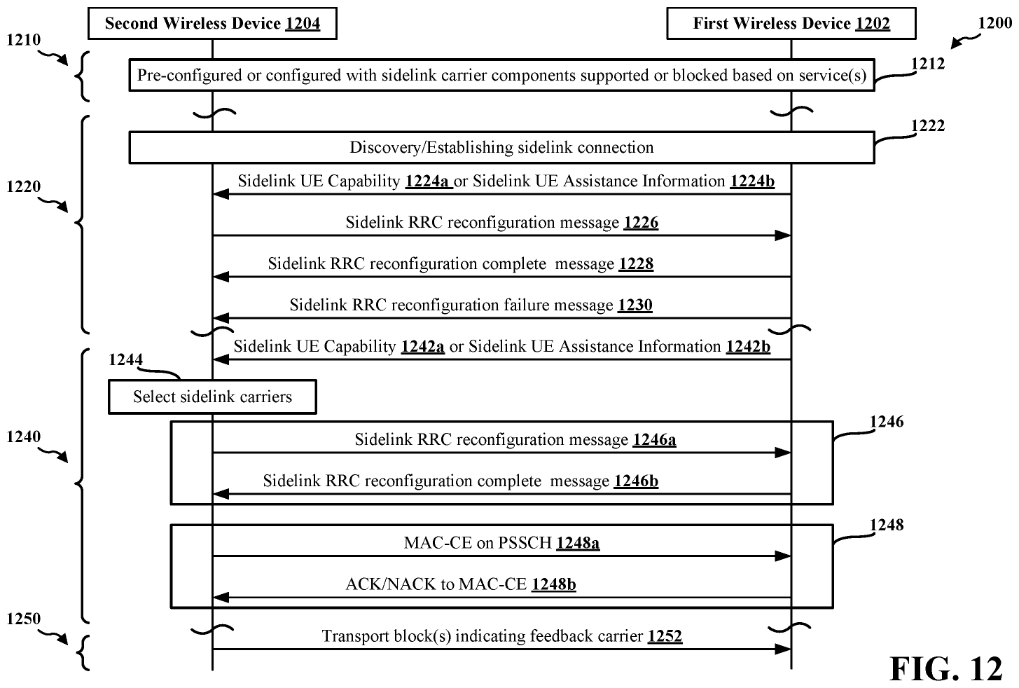

FIG. 12 illustrates an example communication flow 1200 between a first wireless device 1202 and a second wireless device 1204 employing cross-carrier feedback, as presented herein. In the illustrated example, the communication flow 1200 facilitates determining a feedback carrier to use for cross-carrier HARQ feedback in sidelink (e.g., at 1130 of FIG. 11). In the illustrated example, the transmissions between the first wireless device 1202 and the second wireless device 1204 are unicast. Aspects of the first wireless device 1202 may be implemented by the wireless devices 310, 350 of FIG. 3, the first wireless device 902 of FIGS. 9A and 9B, the first wireless device 1002 of FIGS. 10A and 10B, and/or the first wireless device 1102 of FIG. 11. Aspects of the second wireless device 1204 may be implemented by the wireless devices 310, 350 of FIG. 3, the second wireless device 904 of FIGS. 9A and 9B, the second wireless device 1004 of FIGS. 10A and 10B, and/or the second wireless device 1104 of FIG. 11.

In a first aspect 1210, the wireless devices 1202, 1204 may be pre-configured or configured (e.g., via a network) with sidelink carrier components to use for feedback. In some examples, the wireless devices 1202, 1204 may be pre-configured with sidelink carrier components, for example, when the first wireless device 1202 and/or second device 1204 is out-of-coverage. In some examples, the wireless devices 1202, 1204 may be configured, by the network when in network coverage, with the sidelink carrier components.

As shown in FIG. 12, at 1212, the wireless devices 1202, 1204 may be pre-configured or configured with sidelink carrier components supported or blocked based on service(s). For example, the wireless devices 1202, 1204 may be configured with a sidelink carrier aggregation enabled parameter (e.g., which may be referred to as “sl-nr-ca” or by another name), a sidelink carrier component(s) for feedback parameter (e.g., which may be referred to as “sl-nr-ca-carrier-feedback-list” or by another name), a sidelink carrier components supported parameter (e.g., which may be referred to as “sl-nr-ca-carrier-list,” as “sl-nr-ca-carrier-combined-list,” or by another name), and/or a sidelink carrier components blocked parameter (e.g., which may be referred to as “sl-nr-ca-carrier-block-list,” as “sl-nr-ca-carrier-combined-block-list,” or by another name).

The sidelink carrier aggregation enabled parameter may enable or disable carrier aggregation at a wireless device. For example, for an advanced V2X service (e.g., detour information), the sidelink carrier aggregation enabled parameter may configure the first wireless device 1202 to use aggregation when mapping cross-carrier feedback, as described in connection with FIGS. 10A and 10B, or to use different feedback carriers when mapping cross-carrier feedback, as described in connection with FIGS. 9A and 9B.

The sidelink carrier component(s) for feedback parameter may indicate a list of one or more sidelink feedback carriers that are available to use as a feedback carrier for a service. For example, for the V2X service, the sidelink carrier component(s) for feedback parameter may configure the first wireless device 1202 to use a first feedback carrier, a second feedback carrier, etc.

The sidelink carrier components supported parameter may indicate one or more sidelink carrier components to use for a service. For example, for the V2X service, the sidelink carrier components supported parameter may configure the wireless devices 1202, 1204 to use one or more traffic carriers.

The sidelink carrier components blocked parameter may indicate one or more sidelink carrier components to avoid using for a service. For example, for the V2X service, the sidelink carrier components blocked parameter may configure the wireless devices 1202, 1204 to avoid using one or more traffic carriers.

In a second aspect 1220, the wireless devices 1202, 1204 may configure sidelink carrier components via sidelink RRC signaling. For example, at 1222, the first wireless device 1202 and the second wireless device 1204 may discover and/or establish a sidelink connection. For example, the first wireless device 1202 may transmit capability information 1224a including sidelink carrier components information, which may include security information, radio bearers based on QoS flow, etc. The sidelink carrier components information may also include parameters similar to the parameters discussed in connection with 1212, such as a sidelink carrier aggregation enabled parameter (e.g., which may be referred to as “sl-nr-ca-UE” or by another name), a sidelink carrier component(s) for feedback parameter (e.g., which may be referred to as “sl-nr-ca-carrier-feedback-UE-list” or by another name), a sidelink carrier components supported parameter (e.g., which may be referred to as “sl-nr-ca-carrier-UE-list,” as “sl-nr-ca-carrier-combined-UE-list,” or by another name), and/or a sidelink carrier components blocked parameter (e.g., which may be referred to as “sl-nr-ca-carrier-block-UE-list,” as “sl-nr-ca-carrier-combined-block-UE-list,” or by another name).

In other examples, the first wireless device 1202 may transmit sidelink UE assistance information 1224b that is received by the second wireless device 1204. The sidelink UE assistance information 1224b (e.g., which may be referred to as “UEAssistanceInformationSidelink” or by another name) may include sidelink carrier components information, or additionally with the associated measurements (e.g., reference signal received power (RSRP) or received signal strength indicator (RSSI) or channel busy ratio (CBR)). The sidelink UE assistance information 1224b may include parameters similar to the parameters discussed in connection with 1222, such as a sidelink carrier aggregation enabled parameter (e.g., which may be referred to as “sl-nr-ca-UE” or by another name), a sidelink carrier component(s) for feedback parameter (e.g., which may be referred to as “sl-nr-ca-carrier-feedback-UE-list” or by another name), a sidelink carrier components supported parameter (e.g., which may be referred to as “sl-nr-ca-carrier-UE-list,” as “sl-nr-ca-carrier-combined-UE-list,” or by another name), and/or a sidelink carrier components blocked parameter (e.g., which may be referred to as “sl-nr-ca-carrier-block-UE-list,” as “sl-nr-ca-carrier-combined-block-UE-list,” or by another name).

The second wireless device 1204 may transmit a sidelink RRC reconfiguration message 1226 that is received by the first wireless device 1202. The sidelink RRC configuration message 1226 (e.g., which may be referred to as “RRCReconfigurationSidelink” or by another name) may include at least sidelink carrier components that are supported or blocked (e.g., which may be referred to as “sl-nr-ca-carrier-list1” or by another name) and sidelink feedback carriers (e.g., which may be referred to as “sl-nr-ca-carrier-feedback-list1” or by another name). The sidelink carrier components and the sidelink feedback carriers may each include a list of one or more carriers.

The first wireless device 1202 may transmit a sidelink RRC reconfiguration complete message 1228 (e.g., which may be referred to as “RRCReconfigurationCompleteSidelink” or by another name) when the first wireless device 1202 accepts the carriers indicated by the sidelink RRC configuration message 1226. Alternatively, the first wireless device 1202 may transmit a sidelink RRC reconfiguration failure message 1230 (e.g., which may be referred to as “RRCReconfigurationFailureSidelink” or by another name) when the first wireless device 1202 rejects one or more of the carrier components. The sidelink RRC reconfiguration failure message 1230 may also include one or more alternate suitable carrier components or additionally with the associated measurements (e.g., RSRP, RSSI, or CBR) or the reason for rejection. Alternatively, the first wireless device 1202 may propose one or more alternate suitable carrier components or additionally with the associated measurements (e.g., RSRP, RSSI, or CBR) via another sidelink UE assistance information message.

In some examples, the sidelink UE capability 1224a or the sidelink UE assistance information 1224b may be transmitted by the second wireless device 1204 and the sidelink RRC configuration message 1226 may be transmitted by the first wireless device 1202.

In a third aspect 1240, the wireless devices 1202, 1204 may be configured to select and configure and/or activate sidelink carrier components via sidelink RRC signaling or sidelink MAC-CE. For example, the first wireless device 1202 may transmit sidelink UE capability information 1242a or sidelink UE assistance information 1242b that is received by the second wireless device 1204. The sidelink UE capability information 1242a or the sidelink UE assistance information 1242b (e.g., which may be referred to as “UEAssistanceInformationSidelink” or by another name) may include sidelink carrier components information. Aspects of the sidelink UE capability information 1242a and/or the sidelink UE assistance information 1242b may be similar to the sidelink UE capability information 1224a or the sidelink UE assistance information 1224b.

At 1244, the second wireless device 1204 may select sidelink carriers (e.g., sidelink traffic carriers and sidelink feedback carriers) to use for communication with the first wireless device 1202. For example, the second wireless device 1204 may measure a channel busy ratio (CBR) over carrier candidates for transmissions and/or feedback based on the sidelink carrier components information of the sidelink UE capability information 1242a and/or the sidelink UE assistance information 1242b. The second wireless device 1204 may then select one or more of the candidate carriers as traffic carriers and/or feedback carriers. For example, the second wireless device 1204 may measure RSRP or RSSI or CBR over the candidate carriers and select the one or more candidate carriers with a measured RSRP or RS SI that satisfies a threshold for RSRP or RSSI or CBR. In some examples, the second wireless device 1204 may select a candidate carrier when the measured RSRP or RSSI or CBR for the candidate carrier is less than a threshold for RSRP or RSSI or CBR.

The second wireless device 1204 may then configure NR carrier components via sidelink RRC signaling (e.g., at 1246) or may activate/deactivate NR carrier components via MAC-CE (e.g., at 1248). For example, at 1246, the second wireless device 1204 may transmit a sidelink RRC reconfiguration message 1246a that is received by the first wireless device 1202. The sidelink RRC reconfiguration message 1246a (e.g., which may be referred to as “RRCReconfigurationSidelink” or by another name) may include sidelink carrier components (e.g., for transmitting traffic) and sidelink feedback carrier components (e.g., for transmitting feedback). The sidelink carrier components and/or the sidelink feedback carrier components may each include one or more carrier components. The first wireless device 1202 may respond to the sidelink RRC reconfiguration message 1246a by transmitting a sidelink RRC reconfiguration complete message 1246b that is received by the second wireless device 1204. The sidelink RRC reconfiguration complete message 1246b (e.g., which may be referred to as “RRCReconfigurationCompleteSidelink” or by another name) may indicate that the first wireless device 1202 accepts the sidelink carrier components and the sidelink feedback carrier components of the sidelink RRC reconfiguration message 1246a.

In another example, at 1248, the second wireless device 1204 may activate/deactivate NR carrier components via MAC-CE. For example, the second wireless device 1204 may transmit a MAC-CE 1248a on PSSCH that is received by the first wireless device 1202. The MAC-CE 1248a may activate or deactivate sidelink carrier components (e.g., for transmitting traffic) and sidelink feedback carrier components (e.g., for transmitting feedback). The sidelink carrier components and/or the sidelink feedback carrier components may each include one or more carrier components. The first wireless device 1202 may respond to the MAC-CE 1248a by transmitting an ACK/NACK message 1248b to the MAC-CE 1248a. The ACK/NACK message 1248b may indicate that the first wireless device 1202 received the sidelink carrier components and the sidelink feedback carrier components of the MAC-CE 1248a.

In some examples, the sidelink UE capability information 1242a and/or the sidelink UE assistance information 1242b may be transmitted by the second wireless device 1204 and the sidelink RRC configuration message 1246a or sidelink MAC CE 1248a may be transmitted by the first wireless device 1202.

In a fourth aspect 1250, the second wireless device 1204 may indicate sidelink carrier component(s) for feedback. For example, the second wireless device 1204 may indicate the feedback carrier with the transport blocks. For example, the second wireless device 1204 may indicate the feedback carrier(s) with each transport block 1252. Referring to the example of FIGS. 9A and 9B, the second wireless device 1204 may transmit an indication of the first feedback carrier 960 with the first transport block 910. In some examples, the second wireless device 1204 may include the indication of the feedback carrier(s) via SCI-2. In some examples, the second wireless device 1204 may include the indication of the feedback carrier(s) via a MAC-CE.

In some examples, the feedback carrier may be indicated by the first wireless device 1202, e.g., the first wireless devices 1202 schedules a sidelink message to be transmitted by the second wireless device 1204.

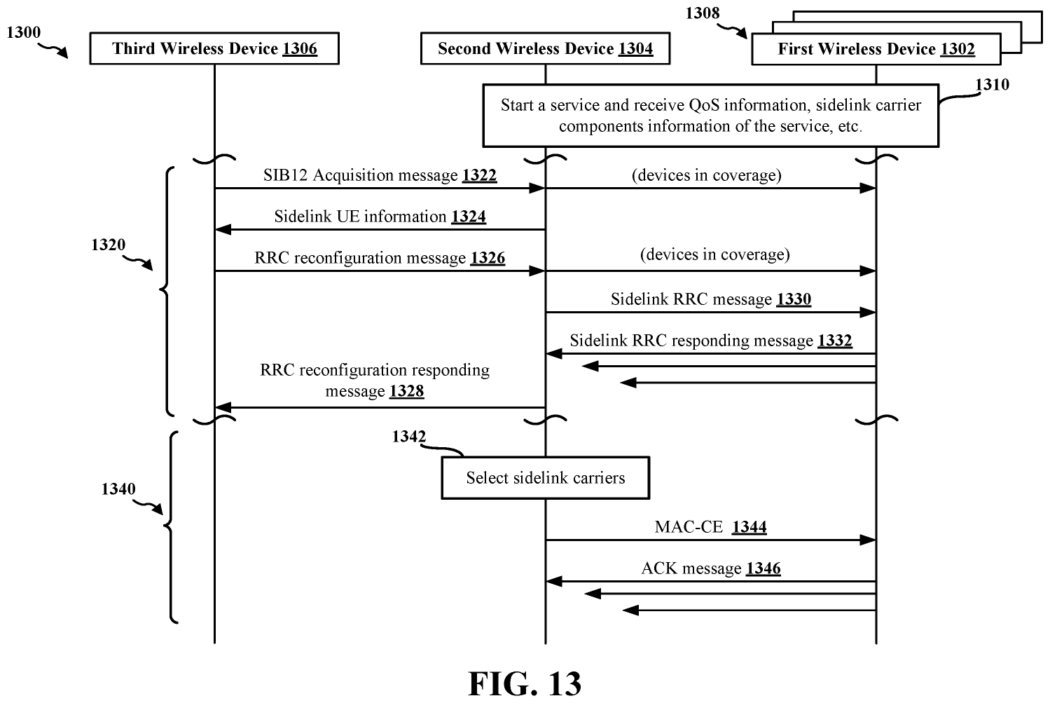

FIG. 13 illustrates an example communication flow 1300 between a first wireless device 1302, a second wireless device 1304, and a third wireless device 1306 employing cross-carrier feedback, as presented herein. In the illustrated example, the communication flow 1300 facilitates determining a feedback carrier to use for cross-carrier HARQ feedback in sidelink (e.g., at 1130 of FIG. 11). In the illustrated example, the transmissions from the second wireless device 1304 are groupcast and may be received by one or more groupcast wireless devices 1308 including the first wireless device 1302. Aspects of the first wireless device 1302 and the groupcast wireless devices 1308 may be implemented by the wireless devices 310, 350 of FIG. 3, the first wireless device 902 of FIGS. 9A and 9B, the first wireless device 1002 of FIGS. 10A and 10B, the first wireless device 1102 of FIG. 11, and/or the first wireless device 1202 of FIG. 12. Aspects of the second wireless device 1304 may be implemented by the wireless devices 310, 350 of FIG. 3, the second wireless device 904 of FIGS. 9A and 9B, the second wireless device 1004 of FIGS. 10A and 10B, the second wireless device 1104 of FIG. 11, and/or the second wireless device 1204 of FIG. 12.

In the illustrated example of FIG. 13, the second wireless device 1304 and the third wireless device 1306 are connected via a Uu interface. For example, the third wireless device 1306 may include a base station or base station-like-RSU in communication with a UE, as described in connection with the base station 430 or a base station-like-RSU and the first UE 402 of FIG. 4. The groupcast wireless devices 1308, including the first wireless device 1302, are receiving UEs for a transmission by the second wireless device 1304. In some examples, one or more of the groupcast wireless devices 1308 may be in coverage of the third wireless device 1306 and receive the transmissions from the third wireless device 1306. For example, and referring again to the example of FIG. 4, the first UE 402, the second UE 404, and the fourth UE 408 may receive the transmissions from the base station 430. In other examples, one or more of the groupcast wireless devices 1308 may be out-of-coverage of the third wireless device 1306. For example, and referring again to the example of FIG. 4, the third UE 406 may be out-of-coverage of the base station 430. In such examples, the third UE 406 may not receive transmissions directly from the base station 430. However, the first UE 402 may forward transmissions from the base station 430 to the third UE 406.

As shown in FIG. 13, at 1310, the groupcast wireless devices 1308 and the second wireless device 1304 start a service with associated QoS information, sidelink carrier components information, etc. For example, the first wireless device 1302 and the second wireless device 1304 may exchange information while forming or joining a group similar to the information exchanged at 1222 of FIG. 12.

In a first aspect 1320, the third wireless device 1306 transmits, via the Uu interface, a SIB message (e.g., a SIB12 message) 1322 that is received by the second wireless device 1304 via SIB acquisition (and one or more of the groupcast wireless devices 1308 that are in coverage of the third wireless device 1306). The SIB message 1322 (e.g., which may be referred to as “sl-ConfigCommonNR” or by another name) may indicate sidelink carrier components information of services.

The second wireless device 1304 transmits, via the Uu interface, sidelink UE information 1324 that is received by the third wireless device 1306. The sidelink UE information 1324 (e.g., which may be referred to as “SidelinkUEInformationNR” or by another name) may include sidelink carrier components information. In some examples, the sidelink UE information 1324 may include UE capability information of one or more of the groupcast wireless devices 1308 and/or the second wireless device 1304. In some examples, the sidelink UE information 1324 may include sidelink UE assistance information of one or more of the groupcast wireless devices 1308 and/or the second wireless device 1304. Aspects of the sidelink UE information 1324 may be similar to the sidelink UE capability information 1224a, 1242a or the sidelink UE assistance information 1224b, 1242b of FIG. 12 from the first wireless device.

The third wireless device 1306 transmits, via the Uu interface, an RRC reconfiguration message 1326 that is received by the second wireless device 1304 and any of the groupcast wireless devices 1308 in-coverage of the third wireless device 1306. The RRC reconfiguration message 1326 may include sidelink carrier components information. Aspects of the RRC reconfiguration message 1326 may be similar to the sidelink RRC reconfiguration message 1226 of FIG. 12.

As shown in FIG. 13, the second wireless device 1304 may then transmit, via the sidelink interface, a sidelink RRC message 1330. The second wireless device 1304 may transmit the sidelink RRC message 1330 as a groupcast message that is received by the groupcast wireless devices 1308 including the first wireless device 1302. The sidelink RRC message 1330 may include the sidelink carrier components information configured by the third wireless device 1306. In some examples, the second wireless device 1304 may transmit the sidelink RRC message 1330 via a signaling radio bearer (SRB). For example, the second wireless device 1304 may transmit the sidelink RRC message 1330 via an SRB0 that may be a shared radio bearer. In some examples, the second wireless device 1304 may transmit the sidelink RRC message 1330 via a group SRB (e.g., which may be referred to as “SRBg” or by another name). The group SRB may be an SRB that is shared by the wireless devices of the groupcast.

In the illustrated example, one or more of the groupcast wireless devices 1308 may be transmit a sidelink RRC responding message 1332 that is received by the second wireless device 1304. The sidelink RRC responding message 1332 may indicate that the respective wireless devices of the groupcast wireless devices 1308 accept the sidelink carrier components information. The groupcast wireless devices 1308 may transmit the RRC responding message 1332 via an SRB, such as the SRB0 or the group SRB or a PC5 RRC link (e.g., unicast between the second wireless device 1304 and the first device 1302 or one of groupcast wireless devices 1308. In some examples, an accepting or ACK from the first device 1302 and each of groupcast wireless devices 1308 are transmitted. In some examples, at least one rejecting or NACK from at least the first device 1302 or one of groupcast wireless devices 1308 is transmitted. In some examples, the responding message to be transmitted or not based on the distance and/or required communication range.

The second wireless device 1304 transmits, via the Uu interface, an RRC reconfiguration responding message 1328 that is received by the third wireless device 1306. The RRC reconfiguration responding message 1328 may indicate that the sidelink carrier components information is accepted or not by the second wireless device 1304, which may be based on the sidelink RRC responding message 1332.

In a second aspect 1340, the second wireless device 1304 may activate sidelink carrier components and sidelink feedback carrier components. For example, at 1342, the second wireless device 1304 may select sidelink carriers (e.g., sidelink traffic carriers and sidelink feedback carriers) to use for communication with the groupcast wireless devices 1308. For example, the second wireless device 1304 may measure RSRP or RSSI or CBR over carrier candidates for transmissions and/or feedback based on the sidelink carrier components information configured by the third wireless device 1306. In some example, the second wireless device 1304 may receive the RSRP or RSSI or CBR measurements from the first wireless device 1302 or of the groupcast wireless devices 1308. The second wireless device 1304 may then select one or more of the candidate carriers as traffic carriers and/or feedback carriers. Aspects of selecting the one or more candidate carriers may be similar to the selecting of the one or more candidate carriers at 1244 of FIG. 12.

The second wireless device 1304 may then activate/deactivate NR carrier components via MAC-CE. For example, the second wireless device 1304 may transmit a MAC-CE 1344 on PSSCH that is received by the groupcast wireless devices 1308. The MAC-CE 1344 may activate or deactivate sidelink carrier components (e.g., for transmitting traffic) and sidelink feedback carrier components (e.g., for transmitting feedback). The sidelink carrier components and/or the sidelink feedback carrier components may each include one or more carrier components. Each of the groupcast wireless devices 1308 may respond to the MAC-CE 1344 by transmitting a respective ACK/NACK message 1346 to the MAC-CE 1344. The ACK/NACK messages 1346 may indicate that the respective groupcast wireless devices 1308 received the sidelink carrier components and the sidelink feedback carrier components of the MAC-CE 1344.

In some examples, the first wireless device 1302 or one of groupcast wireless devices 1308 may select the sidelink carriers based on the measurements over the carrier candidates.

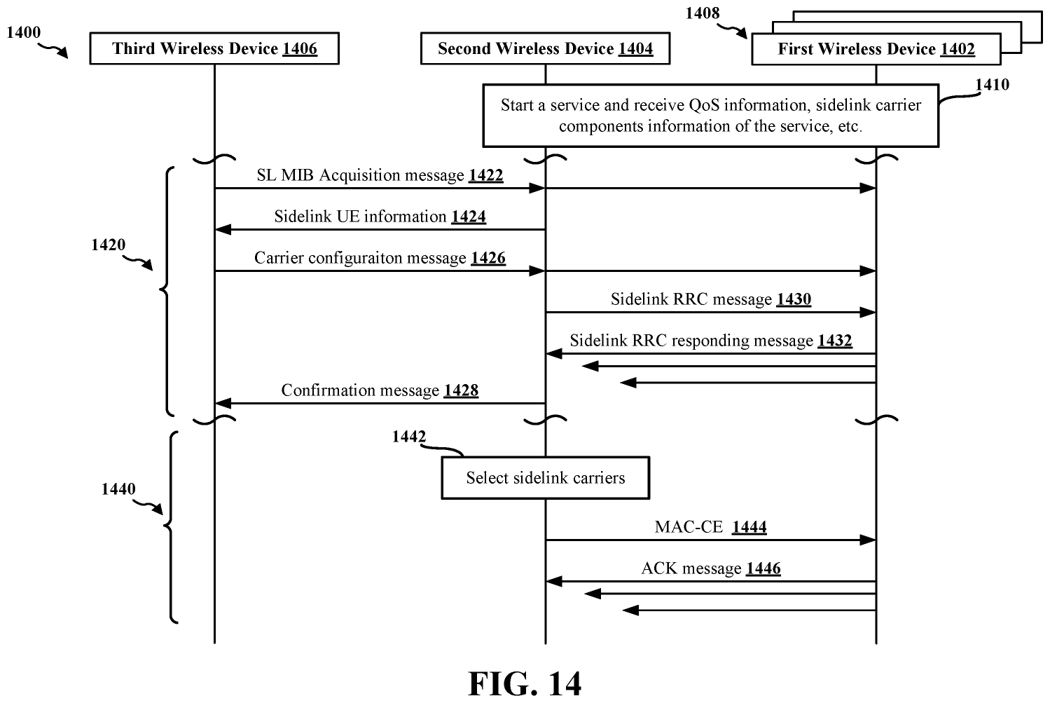

In the example of FIG. 13, the connection between the third wireless device 1306 and the second wireless device 1304 is a Uu interface. In other examples, the connection between the third wireless device and the second wireless device may be via a sidelink interface, as described in connection with FIG. 14.

FIG. 14 illustrates an example communication flow 1400 between a first wireless device 1402, a second wireless device 1404, and a third wireless device 1406 employing cross-carrier feedback, as presented herein. In the illustrated example, the communication flow 1400 facilitates determining a feedback carrier to use for cross-carrier HARQ feedback in sidelink (e.g., at 1130 of FIG. 11). In the illustrated example, the transmissions from the second wireless device 1404 are groupcast and may be received by one or more groupcast wireless devices 1408 including the first wireless device 1402. Aspects of the first wireless device 1402 and the groupcast wireless devices 1408 may be implemented by the wireless devices 310, 350 of FIG. 3, the first wireless device 902 of FIGS. 9A and 9B, the first wireless device 1002 of FIGS. 10A and 10B, the first wireless device 1102 of FIG. 11, the first wireless device 1202 of FIG. 12, and/or the first wireless device 1302 of FIG. 13. Aspects of the second wireless device 1404 may be implemented by the wireless devices 310, 350 of FIG. 3, the second wireless device 904 of FIGS. 9A and 9B, the second wireless device 1004 of FIGS. 10A and 10B, the second wireless device 1104 of FIG. 11, the second wireless device 1204 of FIG. 12, and/or the second wireless device 1304 of FIG. 13.

In the illustrated example of FIG. 14, the second wireless device 1404 and the third wireless device 1406 are connected via a sidelink interface, such as a PC5 interface. For example, the third wireless device 1406 may include an RSU as a special UE, a group lead, a cluster head, a scheduling device, a receiving UE, and/or an FRU. Similar to the example of FIG. 13, the groupcast wireless devices 1408, including the first wireless device 1402, are controlled by the second wireless device 1304.

As shown in FIG. 14, at 1410, the groupcast wireless devices 1408 and the second wireless device 1404 start a service with associated QoS information, sidelink carrier components information, etc. For example, the first wireless device 1402 and the second wireless device 1404 may exchange information while forming or joining a group similar to the information exchanged at 1222 of FIG. 12.

In a first aspect 1420, the third wireless device 1406 transmits, via the sidelink interface, a sidelink MIB or SIB or other sidelink SI message 1422 that is received by the second wireless device 1404 via sidelink SI acquisition (and one or more of the groupcast wireless devices 1408 that are in coverage of the third wireless device 1406). The sidelink MIB or SIB other sidelink SI message 1422 may indicate sidelink carrier components information of services.

The second wireless device 1404 transmits, via the sidelink interface, sidelink UE information 1424 that is received by the third wireless device 1406. The sidelink UE information 1424 (e.g., which may be referred to as “SidelinkUEInformationNR” or by another name) may include sidelink carrier components information. In some examples, the sidelink UE information 1424 may include UE capability information of one or more of the groupcast wireless devices 1408 and/or the second wireless device 1404. In some examples, the sidelink UE information 1424 may include sidelink UE assistance information of one or more of the groupcast wireless devices 1408 and/or the second wireless device 1404. Aspects of the sidelink UE information 1424 may be similar to the sidelink UE capability information 1224a, 1242a or the sidelink UE assistance information 1224b, 1242b of FIG. 12 from the first wireless device.

The third wireless device 1406 transmits, via the sidelink interface, a carrier configuration message 1426 that is received by the second wireless device 1404 and any of the groupcast wireless devices 1408 in-coverage of the third wireless device 1406. The carrier configuration message 1426 may include sidelink carrier components information. In some examples, the third wireless device 1406 may transmit the carrier configuration message 1426 via a sidelink RRC reconfiguration message (e.g., which may be referred to as a “RRCReconfigurationSidelink” or by another name). In some examples, the third wireless device 1406 may transmit the carrier configuration message 1426 via a sidelink MAC-CE activation or deactivation. Aspects of the carrier configuration message 1426 may be similar to the sidelink RRC reconfiguration message 1226 of FIG. 12.

As shown in FIG. 14, the second wireless device 1404 may then transmit, via the sidelink interface, a sidelink RRC message 1430. The second wireless device 1404 may transmit the sidelink RRC message 1430 as a groupcast message that is received by the groupcast wireless devices 1408 including the first wireless device 1402. The sidelink RRC message 1430 may include the sidelink carrier components information configured by the third wireless device 1406. In some examples, the second wireless device 1404 may transmit the sidelink RRC message 1430 via a signaling radio bearer (SRB). For example, the second wireless device 1404 may transmit the RRC forwarding message 1430 via an SRB0 that may be a shared radio bearer. In some examples, the second wireless device 1404 may transmit the sidelink RRC message 1430 via a group SRB (e.g., which may be referred to as “SRBg” or by another name). The group SRB may be an SRB that is shared by the wireless devices of the groupcast.

In the illustrated example, one or more of the groupcast wireless devices 1408 may be transmit an RRC responding message 1432 that is received by the second wireless device 1404. The RRC responding message 1432 may indicate that the respective wireless devices of the groupcast wireless devices 1408 accept the sidelink carrier components information. The groupcast wireless devices 1408 may transmit the RRC responding message 1432 via an SRB, such as the SRB0 or the group SRB or a PC5 RRC link (e.g., unicast between the second wireless device 1404 and the first device 1402 or one of groupcast wireless devices 1408. In some examples, an accepting or ACK from the first device 1402 and each of groupcast wireless devices 1408 are transmitted. In some examples, at least one rejecting or NACK from at least the first device 1402 or one of groupcast wireless devices 1408 is transmitted. In some examples, the responding message to be transmitted or not based on the distance and/or required communication range.

The second wireless device 1404 transmits, via the sidelink interface, a confirmation message 1428 that is received by the third wireless device 1406. The confirmation message 1428 may indicate the second wireless device 1404 received the carrier configuration message 1426 and accepts the configuration. In some examples, the second wireless device 1404 may transmit the confirmation message 1428 via a sidelink RRC reconfiguration message (e.g., which may be referred to as “RRCReconfigurationCompleteSidelink” or by another name). In some examples, the second wireless device 1404 may transmit the confirmation message 1428 via an ACK/NACK message to a MAC-CE. Aspects of the confirmation message 1428 may be similar to the sidelink RRC reconfiguration complete message 1246b and/or the ACK/NACK message 1248b of FIG. 12.

In a second aspect 1440, the second wireless device 1404 may activate sidelink carrier components and sidelink feedback carrier components. For example, at 1442, the second wireless device 1404 may select sidelink carriers (e.g., sidelink traffic carriers and sidelink feedback carriers) to use for communication with the groupcast wireless devices 1408. For example, the second wireless device 1404 may measure RSRP or RSSI or CBR over carrier candidates for transmissions and/or feedback based on the sidelink carrier components information configured by the third wireless device 1406. In some example, the second wireless device 1404 may receive the RSRP or RSSI or CBR measurements from the first wireless device 1402 or of the groupcast wireless devices 1408. The second wireless device 1404 may then select one or more of the candidate carriers as traffic carriers and/or feedback carriers. Aspects of selecting the one or more candidate carriers may be similar to the selecting of the one or more candidate carriers at 1244 of FIG. 12.

The second wireless device 1404 may then activate/deactivate NR carrier components via MAC-CE. For example, the second wireless device 1404 may transmit a MAC-CE 1444 on PSSCH that is received by the groupcast wireless devices 1408. The MAC-CE 1444 may activate or deactivate sidelink carrier components (e.g., for transmitting traffic) and sidelink feedback carrier components (e.g., for transmitting feedback). The sidelink carrier components and/or the sidelink feedback carrier components may each include one or more carrier components. Each of the groupcast wireless devices 1408 may respond to the MAC-CE 1444 by transmitting a respective ACK/NACK message 1446 to the MAC-CE 1444. The ACK/NACK messages 1446 may indicate that the respective groupcast wireless devices 1408 received the sidelink carrier components and the sidelink feedback carrier components of the MAC-CE 1444.

In some examples, the first wireless device 1402 or one of groupcast wireless devices 1408 may select the sidelink carriers based on the measurements over the carrier candidates.

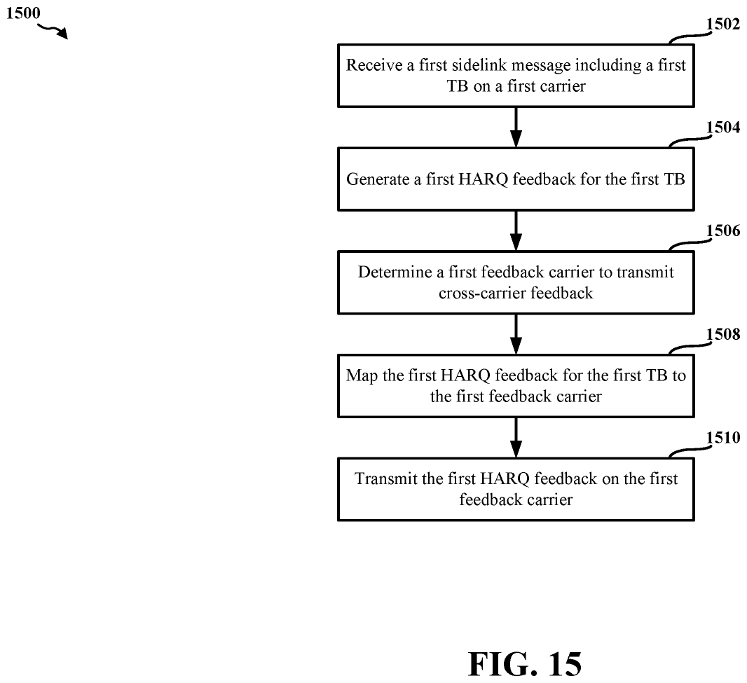

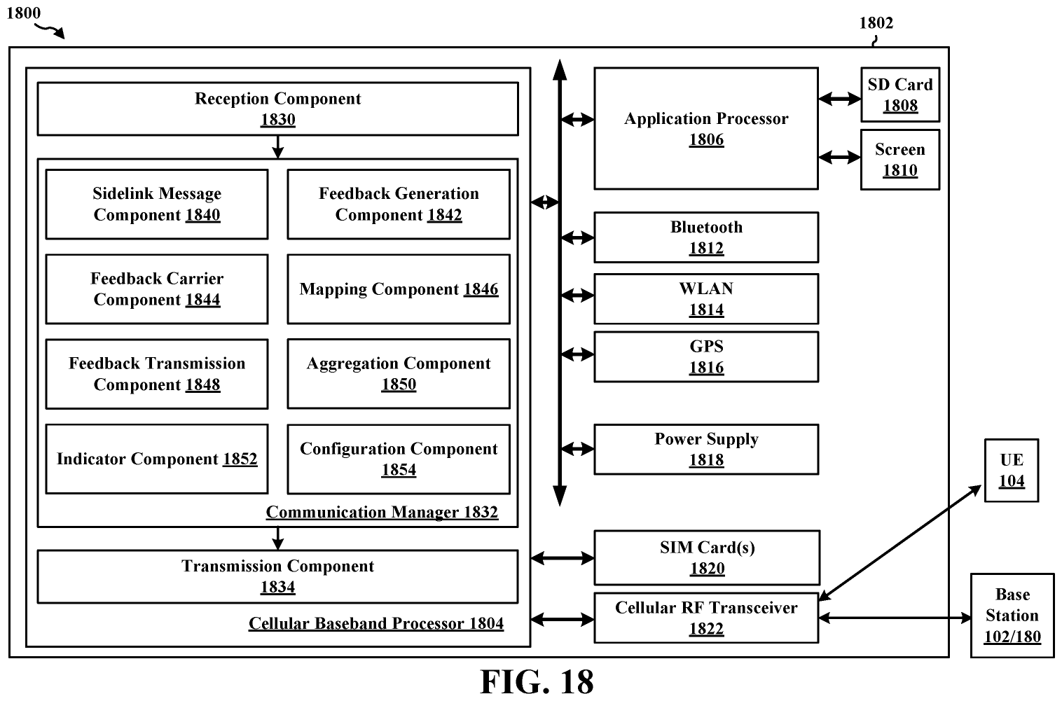

FIG. 15 is a flowchart 1500 of a method of wireless communication. The method may be performed by a first wireless device (e.g., the UE 104, the wireless devices 310, 350, the first wireless devices 902, 1002, 1102, 1202, 1302, 1402, and/or an apparatus 1802 of FIG. 18). The method may facilitate improving cell coverage and/or increased throughput by improving reliability and timely HARQ feedback in sidelink.

At 1502, the first wireless device receives a first sidelink message including a first TB on a first carrier, as described in connection with the sidelink message 1110 of FIG. 11, the first transport block 910 on the first carrier 920 of FIGS. 9A and 9B, and/or the first transport block 1010 on the first carrier 1020 of FIGS. 10A and 10B. For example, 1502 may be performed by a sidelink message component 1840 of the apparatus 1802 of FIG. 18.

At 1504, the first wireless device generates a first HARQ feedback for the first TB, as described in connection with 1120 of FIG. 11, the first ACK/NACK message 940 of FIGS. 9A and 9B, and/or the first ACK/NACK message 1040 of FIGS. 10A and 10B. For example, 1504 may be performed by a feedback generation component 1842 of the apparatus 1802 of FIG. 18.

At 1506, the first wireless device determines a first feedback carrier to transmit cross-carrier feedback, as described in connection with 1130 of FIG. 11. For example, 1506 may be performed by a feedback carrier component 1844 of the apparatus 1802 of FIG. 18.

At 1508, the first wireless device maps the first HARQ feedback for the first TB to the first feedback carrier, as described in connection with 1140 of FIG. 11. For example, 1508 may be performed by a mapping component 1846 of the apparatus 1802 of FIG. 18. Aspects of the mapping of the first HARQ feedback may be similar to the carrier mapping component 952 of FIG. 9A and/or the carrier mapping component 1052 of FIG. 10A. In some examples, mapping to the first feedback carrier may be performed at a sub-layer of a MAC layer. In some examples, mapping to the first feedback carrier may be performed at a sub-layer of a PHY layer.

At 1510, the first wireless device transmits the first HARQ feedback on the first feedback carrier, as described in connection with the cross-carrier feedback 1150 of FIG. 11 and/or the first ACK/NACK message 940 on the first feedback carrier 960 of FIGS. 9A and 9B. For example, 1510 may be performed by a feedback transmission component 1848 of the apparatus 1802 of FIG. 18.

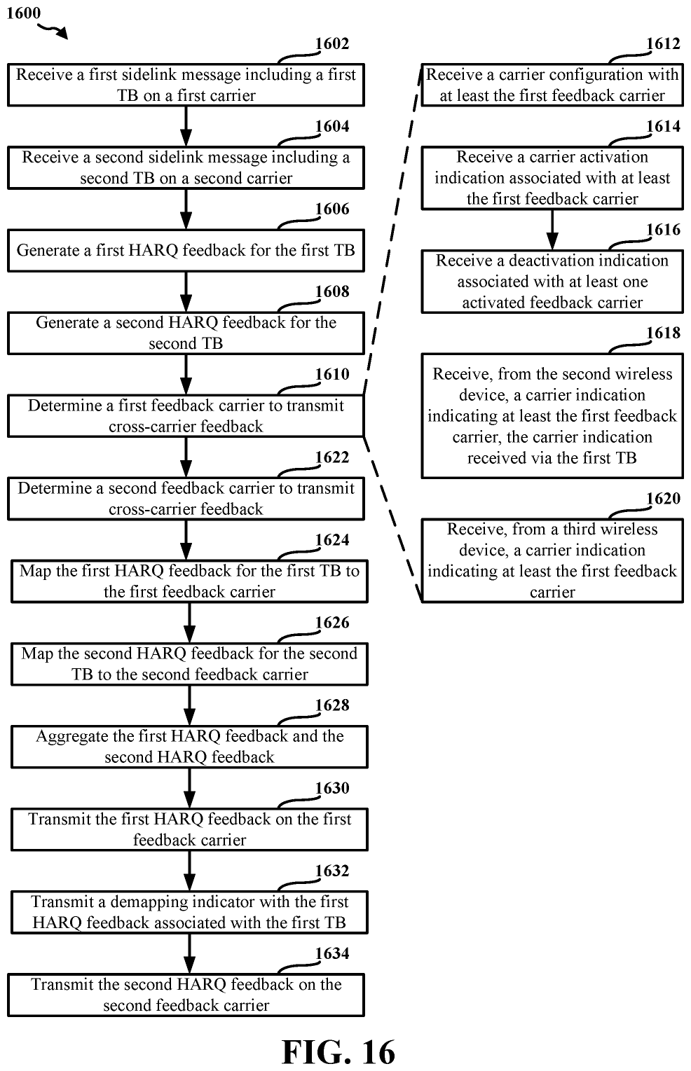

FIG. 16 is a flowchart 1600 of a method of wireless communication. The method may be performed by a first wireless device (e.g., the UE 104, the wireless devices 310, 350, the first wireless devices 902, 1002, 1102, 1202, 1302, 1402, and/or an apparatus 1802 of FIG. 18). The method may facilitate improving cell coverage and/or increased throughput by improving reliability and timely HARQ feedback in sidelink.

At 1602, the first wireless device receives a first sidelink message including a first TB on a first carrier, as described in connection with the sidelink message 1110 of FIG. 11, the first transport block 910 on the first carrier 920 of FIGS. 9A and 9B, and/or the first transport block 1010 on the first carrier 1020 of FIGS. 10A and 10B. For example, 1602 may be performed by a sidelink message component 1840 of the apparatus 1802 of FIG. 18.

At 1604, the first wireless device may receive a second sidelink message including a second TB on a second carrier, as described in connection with the second transport block 912 on the second carrier 922 of FIGS. 9A and 9B, and/or the second transport block 1012 on the second carrier 1022 of FIGS. 10A and 10B. For example, 1604 may be performed by the sidelink message component 1840 of the apparatus 1802 of FIG. 18.

At 1606, the first wireless device generates a first HARQ feedback for the first TB, as described in connection with 1120 of FIG. 11, the first ACK/NACK message 940 of FIGS. 9A and 9B, and/or the first ACK/NACK message 1040 of FIGS. 10A and 10B. For example, 1606 may be performed by a feedback generation component 1842 of the apparatus 1802 of FIG. 18.

At 1608, the first wireless device may generate a second HARQ feedback for the second TB, as described in connection with the second ACK/NACK message 942 of FIGS. 9A and 9B, and/or the second ACK/NACK message 1042 of FIGS. 10A and 10B. For example, 1608 may be performed by the feedback generation component 1842 of the apparatus 1802 of FIG. 18.

At 1610, the first wireless device determines a first feedback carrier to transmit cross-carrier feedback, as described in connection with 1130 of FIG. 11. For example, 1610 may be performed by a feedback carrier component 1844 of the apparatus 1802 of FIG. 18.

In some examples, the first wireless device may be configured to transmit the cross-carrier feedback on the first feedback carrier. In some examples, at 1612, the first wireless device may receive a carrier configuration with at least the first feedback carrier, as described in connection with the example aspects 1210, 1220, 1240, 1250 of FIG. 12. For example, 1612 may be performed by a configuration component 1854 of the apparatus 1802 of FIG. 18.

In some examples, at 1614, the first wireless device may receive a carrier activation indication associated with at least the first feedback carrier, as described in connection with the third aspect 1240 of FIG. 12. For example, 1614 may be performed by the configuration component 1854 of the apparatus 1802 of FIG. 18. In some examples, the first wireless device may receive the carrier activation indication via a MAC-CE. The first wireless device may receive the carrier activation indication from at least one of an RSU, a group lead device, a cluster lead device, a scheduling device, the second wireless device, and the first wireless device.

In some examples, at 1616, the first wireless device may receive a deactivation indication associated with at least one activated feedback carrier, as described in connection with 1248 of FIG. 12. For example, 1616 may be performed by the configuration component 1854 of the apparatus 1802 of FIG. 18.

In some examples, at 1618, the first wireless device may receive, from the second wireless device, a carrier indication indicating at least the first feedback carrier, the carrier indication received via the first TB, as described in connection with the fourth aspect 1250 of FIG. 12. For example, 1618 may be performed by the configuration component 1854 of the apparatus 1802 of FIG. 18. In some examples, the first wireless device may receive the carrier indication via SCI associated with the first TB. For example, the first wireless device may receive the carrier indication via SCI-2.

In some examples, at 1620, the first wireless device may receive, from a third wireless device, a carrier indication indicating at least the first feedback carrier, as described in connection with the communication flow 1300 of FIG. 13 and/or the communication flow 1400 of FIG. 14. For example, 1620 may be performed by the configuration component 1854 of the apparatus 1802 of FIG. 18. The third wireless device may include at least one of an RSU, a group lead, a cluster head, a scheduling UE, and a receiving (Rx) UE.

At 1622, the first wireless device may determine a second feedback carrier to transmit cross-carrier feedback, as described in connection with 1130 of FIG. 11. For example, 1622 may be performed by the feedback carrier component 1844 of the apparatus 1802 of FIG. 18. In some examples, the second feedback carrier may be different than the first feedback carrier. In some examples, the second feedback carrier and the first feedback carrier may be a same feedback carrier.

At 1624, the first wireless device maps the first HARQ feedback for the first TB to the first feedback carrier, as described in connection with 1140 of FIG. 11. For example, 1624 may be performed by a mapping component 1846 of the apparatus 1802 of FIG. 18. Aspects of the mapping of the first HARQ feedback may be similar to the carrier mapping component 952 of FIG. 9A and/or the carrier mapping component 1052 of FIG. 10A. In some examples, mapping to the first feedback carrier may be performed at a sub-layer of a MAC layer. In some examples, mapping to the first feedback carrier may be performed at a sub-layer of a PHY layer.

At 1626, the first wireless device may map the second HARQ feedback for the second TB to the second feedback carrier, as described in connection with the mapping of the second ACK/NACK message 942 on to the second feedback carrier 962 of FIGS. 9A and 9B. For example, 1626 may be performed by the mapping component 1846 of the apparatus 1802 of FIG. 18.

In some examples, at 1628, the first wireless device may aggregate the first HARQ feedback and the second HARQ feedback on the first feedback carrier or the second feedback carrier or on an aggregated feedback carrier, as described in connection with the aggregated ACK/NACK messages 1040, 1042 of FIGS. 10A and 10B. For example, 1628 may be performed by an aggregation component 1850 of the apparatus 1802 of FIG. 18.

At 1630, the first wireless device transmits the first HARQ feedback on the first feedback carrier, as described in connection with the cross-carrier feedback 1150 of FIG. 11 and/or the first ACK/NACK message 940 on the first feedback carrier 960 of FIGS. 9A and 9B. For example, 1630 may be performed by a feedback transmission component 1848 of the apparatus 1802 of FIG. 18.

At 1632, the first wireless device may transmit a demapping indicator with the first HARQ feedback associated with the first TB, as described in connection with the demapping indicator 1160 of FIG. 11 and/or the first demapping indicator 970 of FIGS. 9A and 9B. For example, 1632 may be performed by an indicator component 1852 of the apparatus 1802 of FIG. 18.

At 1634, the first wireless device may transmit the second HARQ feedback on the second feedback carrier, as described in connection with the second ACK/NACK message on the second feedback carrier 962 of FIGS. 9A and 9B. For example, 1634 may be performed by the feedback transmission component 1848 of the apparatus 1802 of FIG. 18. In some examples, the first wireless device may transmit the second HARQ feedback and the first HARQ feedback on a same feedback carrier, as described in connection with the aggregated ACK/NACK messages 1040, 1042 of FIGS. 10A and 10B.

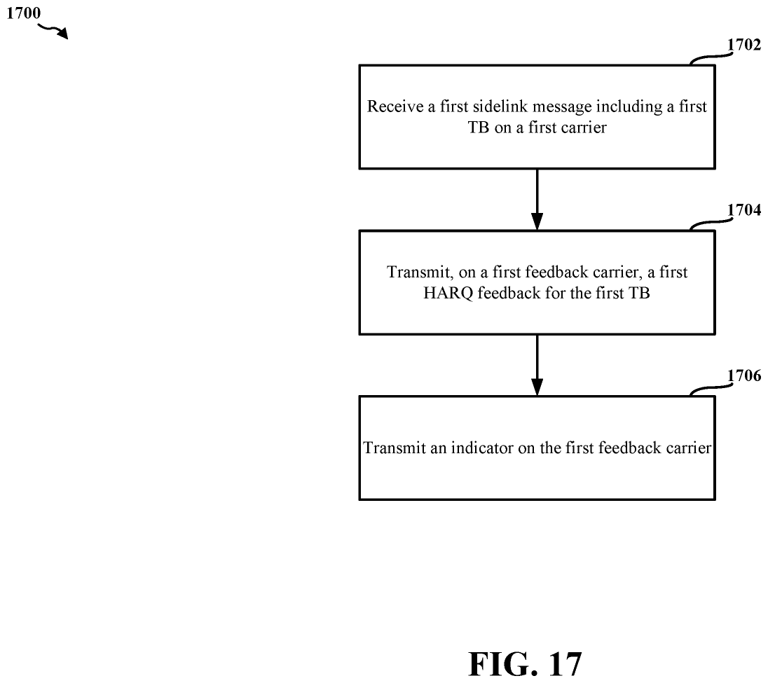

FIG. 17 is a flowchart 1700 of a method of wireless communication. The method may be performed by a first wireless device (e.g., the UE 104, the wireless devices 310, 350, the first wireless devices 902, 1002, 1102, 1202, 1302, 1402, and/or an apparatus 1802 of FIG. 18). The method may facilitate improving cell coverage and/or increased throughput by improving reliability and timely HARQ feedback in sidelink.

At 1702, the first wireless device receives a first sidelink message including a first TB on a first carrier, as described in connection with the sidelink message 1110 of FIG. 11, the first transport block 910 on the first carrier 920 of FIGS. 9A and 9B, and/or the first transport block 1010 on the first carrier 1020 of FIGS. 10A and 10B. For example, 1502 may be performed by a sidelink message component 1740 of the apparatus 1702 of FIG. 17.

At 1704, the first wireless device transmits, on a first feedback carrier, a first HARQ feedback for the first TB, as described in connection with the cross-carrier feedback 1150 of FIG. 11 and/or the first ACK/NACK message 940 on the first feedback carrier 960 of FIGS. 9A and 9B. For example, 1510 may be performed by a feedback transmission component 1848 of the apparatus 1802 of FIG. 18.

At 1706, the first wireless device transmits an indicator on the first feedback carrier, as described in connection with the demapping indicator 1160 of FIG. 11 and/or the first demapping indicator 970 of FIGS. 9A and 9B. For example, 1632 may be performed by an indicator component 1852 of the apparatus 1802 of FIG. 18.

FIG. 18 is a diagram 1800 illustrating an example of a hardware implementation for an apparatus 1802. The apparatus 1802 may be a first wireless device, such as a UE, a component of a UE, or may implement UE functionality. In some aspects, the apparatus 1802 may include a cellular baseband processor 1804 (also referred to as a modem) coupled to a cellular RF transceiver 1822. In some aspects, the apparatus 1802 may further include one or more subscriber identity modules (SIM) cards 1820, an application processor 1806 coupled to a secure digital (SD) card 1808 and a screen 1810, a Bluetooth module 1812, a wireless local area network (WLAN) module 1814, a Global Positioning System (GPS) module 1816, or a power supply 1818. The cellular baseband processor 1804 communicates through the cellular RF transceiver 1822 with the UE 104 and/or base station 102/180. The cellular baseband processor 1804 may include a computer-readable medium/memory. The computer-readable medium/memory may be non-transitory. The cellular baseband processor 1804 is responsible for general processing, including the execution of software stored on the computer-readable medium/memory. The software, when executed by the cellular baseband processor 1804, causes the cellular baseband processor 1804 to perform the various functions described supra. The computer-readable medium/memory may also be used for storing data that is manipulated by the cellular baseband processor 1804 when executing software. The cellular baseband processor 1804 further includes a reception component 1830, a communication manager 1832, and a transmission component 1834. The communication manager 1832 includes the one or more illustrated components. The components within the communication manager 1832 may be stored in the computer-readable medium/memory and/or configured as hardware within the cellular baseband processor 1804. The cellular baseband processor 1804 may be a component of the second wireless device 350 and may include the memory 360 and/or at least one of the TX processor 368, the RX processor 356, and the controller/processor 359. In one configuration, the apparatus 1802 may be a modem chip and include just the baseband processor 1804, and in another configuration, the apparatus 1802 may be the entire UE (e.g., see the second wireless device 350 of FIG. 3) and include the additional modules of the apparatus 1802.

The communication manager 1832 includes a sidelink message component 1840 that is configured to receive a first sidelink message including a first TB on a first carrier, for example, as described in connection with 1502 of FIG. 15 and/or 1602 of FIG. 16. The example sidelink message component 1840 may also be configured to receive a second sidelink message including a second TB on a second carrier, for example, as described in connection with 1604 of FIG. 16. The example sidelink message component 1840 may also be configured to receive a first sidelink message including a first TB on a first carrier, for example, as described in connection with 1702 of FIG. 17.

The communication manager 1832 also includes a feedback generation component 1842 that is configured to generate a first HARQ feedback for the first TB, for example, as described in connection with 1504 of FIG. 15 and/or 1606 of FIG. 16. The example feedback generation component 1842 may also be configured to generate a second HARQ feedback for the second TB, for example, as described in connection with 1608 of FIG. 16.

The communication manager 1832 also includes a feedback carrier component 1844 that is configured to determine a first feedback carrier to transmit cross-carrier feedback, for example, as described in connection with 1506 of FIG. 15 and/or 1610 of FIG. 16. The example feedback carrier component 1844 may also be configured to determine a second feedback carrier to transmit cross-carrier feedback, for example, as described in connection with 1622 of FIG. 16.

The communication manager 1832 also includes a mapping component 1846 that is configured to map the first HARQ feedback for the first TB to the first feedback carrier, for example, as described in connection with 1508 of FIG. 15 and/or 1624 of FIG. 16. The example mapping component 1846 may also be configured to map the second HARQ feedback for the second TB to the second feedback carrier, for example, as described in connection with 1626 of FIG. 16.

The communication manager 1832 also includes a feedback transmission component 1848 that is configured to transmit the first HARQ feedback on the first feedback carrier, for example, as described in connection with 1510 of FIG. 15 and/or 1630 of FIG. 16. The example feedback transmission component 1848 may also be configured to transmit the second HARQ feedback on the second feedback carrier, for example, as described in connection with 1634 of FIG. 16. The example feedback transmission component 1848 may also be configured to transmit, on a first feedback carrier, a first HARQ feedback for the first TB, for example, as described in connection with 1704 of FIG. 17.

The communication manager 1832 also includes an aggregation component 1850 that is configured to aggregate the first HARQ feedback and the second HARQ feedback, for example, as described in connection with 1628 of FIG. 16.

The communication manager 1832 also includes an indicator component 1852 that is configured to transmit a demapping indicator with the first HARQ feedback associated with the first TB, for example, as described in connection with 1632 of FIG. 16. The example indicator component 1852 may also be configured to transmit an indicator on the first feedback carrier, for example, as described in connection with 1706 of FIG. 17.

The communication manager 1832 also includes a configuration component 1854 that is configured to receive a carrier configuration with at least the first feedback carrier, for example, as described in connection with 1612 of FIG. 16. The example configuration component 1854 may also be configured to receive a carrier activation indication associated with at least the first feedback carrier, for example, as described in connection with 1614 of FIG. 16. The example configuration component 1854 may also be configured to receive a deactivation indication associated with at least one activated feedback carrier, for example, as described in connection with 1616 of FIG. 16. The example configuration component 1854 may also be configured to receive, from the second wireless device, a carrier indication indicating at least the first feedback carrier, the carrier indication received via the first TB, for example, as described in connection with 1618 of FIG. 16. The example configuration component 1854 may also be configured to receive, from a third wireless device, a carrier indication indicating at least the first feedback carrier, for example, as described in connection with 1620 of FIG. 16.

The apparatus may include additional components that perform each of the blocks of the algorithm in the flowcharts of FIGS. 15, 16, and/or 17. As such, each block in the flowcharts of FIGS. 15, 16, and/or 17 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1802 may include a variety of components configured for various functions. In one configuration, the apparatus 1802, and in particular the cellular baseband processor 1804, includes means for receiving, from a second wireless device, a first sidelink message including a first TB on a first carrier. The example apparatus 1802 also includes means for generating a first HARQ feedback for the first TB. The example apparatus 1802 also includes means for determining a first feedback carrier to transmit cross-carrier feedback. The example apparatus 1802 also includes means for mapping the first HARQ feedback for the first TB to the first feedback carrier, the first feedback carrier being different than the first carrier. The example apparatus 1802 also includes means for transmitting the first HARQ feedback on the first feedback carrier to the second wireless device.

In another configuration, the example apparatus 1802 also includes means for receiving, from the second wireless device, a second sidelink message including a second TB on a second carrier. The example apparatus 1802 also includes means for generating a second HARQ feedback for the second TB. The example apparatus 1802 also includes means for determining a second feedback carrier. The example apparatus 1802 also includes means for mapping the second HARQ feedback for the second TB to the second feedback carrier, the second feedback carrier being different than the second carrier. The example apparatus 1802 also includes means for transmitting the second HARQ feedback on the second feedback carrier to the second wireless device. In another configuration, the example apparatus 1802 also includes means for aggregating the second HARQ feedback with the first HARQ feedback on the first feedback carrier or the second feedback carrier. In another configuration, the example apparatus 1802 also includes means for transmitting a demapping indicator with the first HARQ feedback associated with the first TB.

In another configuration, the example apparatus 1802 also includes means for receiving a carrier configuration to configure the first wireless device with at least the first feedback carrier for the cross-carrier feedback.

In another configuration, the example apparatus 1802 also includes means for receiving a carrier activation indication associated with at least the first feedback carrier for the cross-carrier feedback.

In another configuration, the example apparatus 1802 also includes means for receiving a deactivation indication associated with at least one activated feedback carrier for the cross-carrier feedback.

In another configuration, the example apparatus 1802 also includes means for receiving, from the second wireless device, a carrier indication indicating at least the first feedback carrier for the cross-carrier feedback, the carrier indication received via the first TB.

In another configuration, the example apparatus 1802 also includes means for receiving, from a third wireless device, a carrier indication indicating at least the first feedback carrier for the cross-carrier feedback, wherein the third wireless device includes at least one of an RSU, a group lead, a cluster head, a scheduling UE, and a receiving UE.

In another configuration, the example apparatus 1802 also includes means for receiving, from a second wireless device, a first sidelink message including a first TB on a first carrier. The example apparatus 1802 also includes means for transmitting, to the second wireless device on a first feedback carrier, a first HARQ feedback for the first TB, the first feedback carrier being different than the first carrier. The example apparatus 1802 also includes means for transmitting, to the second wireless device, an indicator on the first feedback carrier, the indicator indicating at least one of the first TB and the first carrier associated with the first TB.

The means may be one or more of the components of the apparatus 1802 configured to perform the functions recited by the means. As described supra, the apparatus 1802 may include the TX processor 368, the RX processor 356, and the controller/processor 359. As such, in one configuration, the means may be the TX processor 368, the RX processor 356, and the controller/processor 359 configured to perform the functions recited by the means.

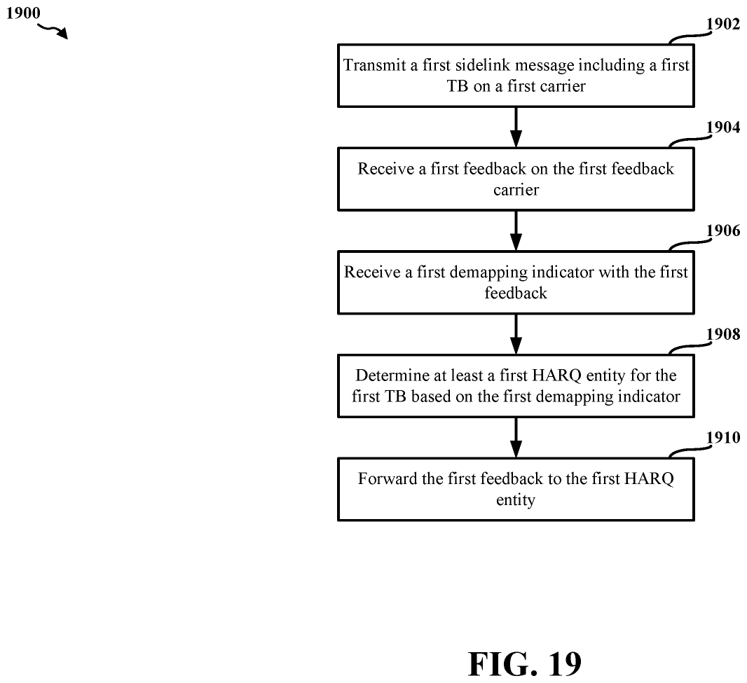

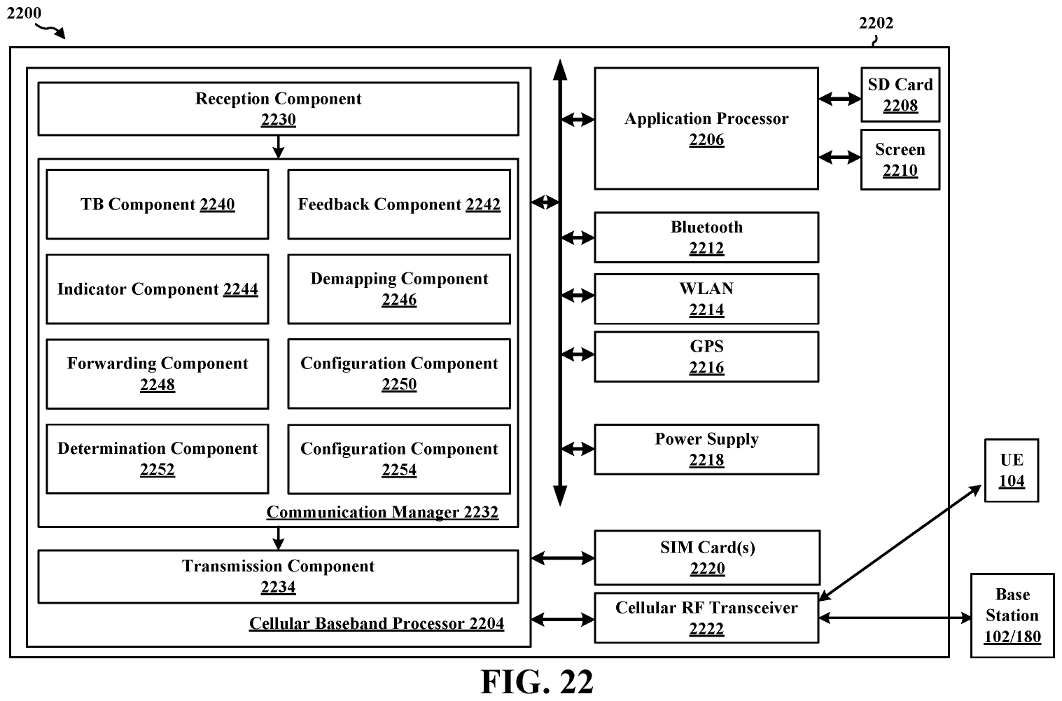

FIG. 19 is a flowchart 1900 of a method of wireless communication with a first wireless device at a second wireless device. The method may be performed by a second wireless device (e.g., the UE 104, the wireless devices 310, 350, the second wireless devices 904, 1004, 1104, 1204, 1304, 1404, and/or an apparatus 2202 of FIG. 22). The method may facilitate improving cell coverage and/or increased throughput by improving reliability and timely HARQ feedback in sidelink.

At 1902, the second wireless device transmits a first sidelink message including a first TB on a first carrier, as described in connection with sidelink message 1110 of FIG. 11, the first transport block 910 on the first carrier 920 of FIGS. 9A and 9B, and/or the first transport block 1010 on the first carrier 1020 of FIGS. 10A and 10B. For example, 1902 may be performed by a TB component 2240 of the apparatus 2202 of FIG. 22.

At 1904, the second wireless device receives a first feedback on the first feedback carrier, as described in connection with the cross-carrier feedback 1150 of FIG. 11, the first ACK/NACK message 940 on the first feedback carrier 960, and/or the first ACK/NACK message 1040 on the first feedback carrier 1060 of FIGS. 10A and 10B. For example, 1904 may be performed by a feedback component 2242 of the apparatus 2202 of FIG. 22.

At 1906, the second wireless device receives a first demapping indicator with the first feedback, as described in connection with the demapping indicator 1160 of FIG. 11, the first demapping indicator 970 of FIGS. 9A and 9B, and/or the demapping indicator 1070 of FIGS. 10A and 10B. For example, 1906 may be performed by an indicator component 2244 of the apparatus 2202 of FIG. 22.

At 1908, the second wireless device determines at least a first HARQ entity for the first TB based on the first demapping indicator, as described in connection with 1180 of FIG. 11. For example, 1908 may be performed by a demapping component 2246 of the apparatus 2202 of FIG. 22. Aspects of the determining of at least the first HARQ entity may be performed at a carrier demapping component 954 of FIG. 9A and/or the carrier demapping component 1054 of FIG. 10A. In some examples, the determining of at least the first HARQ entity may be performed at an adaptation layer (e.g., the adaptation layer 950 of FIG. 9A and/or the adaptation layer 1050 of FIG. 10A). In some examples, the determining of at least the first HARQ entity may be performed at a sub-layer of the MAC layer. In some examples, the determining of at least the first HARQ entity may be performed at a sub-layer of the PHY layer.

At 1910, the second wireless device forwards the first feedback to the first HARQ entity, as described in connection with 1180 of FIG. 11. For example, 1910 may be performed by a forwarding component 2248 of the apparatus 2202 of FIG. 22. For example, the second wireless device may forward the first ACK/NACK message 940 to the first HARQ entity 930b of FIGS. 9A and 9B, and/or may forward the first ACK/NACK message 1040 to the first HARQ entity 1030b of FIGS. 10A and 10B.

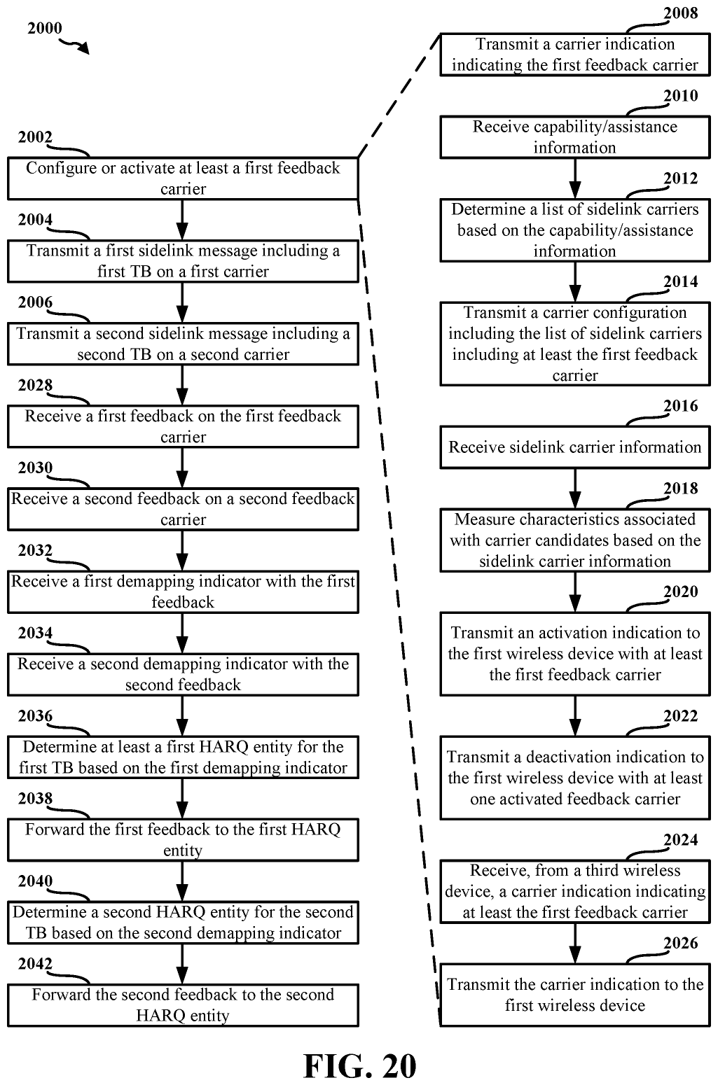

FIG. 20 is a flowchart 2000 of a method of wireless communication with a first wireless device at a second wireless device. The method may be performed by a second wireless device (e.g., the UE 104, the wireless devices 310, 350, the second wireless devices 904, 1004, 1104, 1204, 1304, 1404, and/or an apparatus 2202 of FIG. 22). The method may facilitate improving cell coverage and/or increased throughput by improving reliability and timely HARQ feedback in sidelink.

At 2002, the second wireless device may configure or activate at least a first feedback carrier, as described in connection with the communication flow 1200 of FIG. 12, the communication flow 1300 of FIG. 13, and/or the communication 1400 of FIG. 14. For example, 2002 may be performed by a configuration component 2250 of the apparatus 2202 of FIG. 22.

At 2004, the second wireless device transmits a first sidelink message including a first TB on a first carrier, as described in connection with sidelink message 1110 of FIG. 11, the first transport block 910 on the first carrier 920 of FIGS. 9A and 9B, and/or the first transport block 1010 on the first carrier 1020 of FIGS. 10A and 10B. For example, 2004 may be performed by a TB component 2240 of the apparatus 2202 of FIG. 22.

At 2006, the second wireless device may transmit a second sidelink message including a second TB on a second carrier, as described in connection with the second transport block 912 on the second carrier 922 of FIGS. 9A and 9B, and/or the second transport block 1012 on the second carrier 1022 of FIGS. 10A and 10B. For example, 2006 may be performed by the TB component 2240 of the apparatus 2202 of FIG. 22.

In some examples, the second wireless device may be configured to receive cross-carrier feedback on the first feedback carrier.

In some examples, at 2008, the second wireless device may transmit a carrier indication indicating the first feedback carrier, as described in connection with the fourth aspect 1250 of FIG. 12. For example, 2008 may be performed by the configuration component 2250 of the apparatus 2202 of FIG. 22. For example, the second wireless device may transmit, via at least one of the first TB and the second TB, a carrier indication indicating the first feedback carrier for cross-carrier feedback. In some examples, the second wireless device may transmit the carrier indication via sidelink control information, such as SCI-2. In some examples, the second wireless device may transmit the carrier indication via a MAC-CE.

In some examples, at 2010, the second wireless device may receive capability or assistance information, as described in connection with the sidelink UE assistance information 1242 of FIG. 12. For example, 2010 may be performed by a determination component 2252 of the apparatus 2202 of FIG. 22.

At 2012, the second wireless device may determine a list of sidelink carriers based on the capability or assistance information, as described in connection with 1244 of FIG. 12. For example, 2012 may be performed by the determination component 2252 of the apparatus 2202 of FIG. 22. In some examples, the second wireless device may determine the list of sidelink carriers based on received capability information with at least one carrier (e.g., the sidelink UE assistance information 1242). In some examples, the second wireless device may determine the list of sidelink carriers based on measuring characteristics associated with at least one candidate carrier indicated by the capability information, as described in connection with 1244 of FIG. 12.

At 2014, the second wireless device may transmit a carrier configuration including the list of sidelink carriers including at least the first feedback carrier, as described in connection with sidelink RRC reconfiguration message 1246a of FIG. 12. For example, 2014 may be performed by the configuration component 2250 of the apparatus 2202 of FIG. 22.

In some examples, at 2016, the second wireless device may receive sidelink carrier information, the sidelink UE assistance information 1242 of FIG. 12. For example, 2016 may be performed by the determination component 2252 of the apparatus 2202 of FIG. 22.

At 2018, the second wireless device may measure characteristics associated with carrier candidates based on the sidelink carrier information, as described in connection with 1244 of FIG. 12. For example, 2018 may be performed by the determination component 2252 of the apparatus 2202 of FIG. 22.

At 2020, the second wireless device may transmit an activation indication to the first wireless device with at least the first feedback carrier, as described in connection with the MAC-CE on PSSCH 1248a of FIG. 12. For example, 2020 may be performed by the configuration component 2250 of the apparatus 2202 of FIG. 22.

At 2022, the second wireless device may transmit a deactivation indication to the first wireless device with at least one activated feedback carrier, as described in connection with the MAC-CE on PSSCH 1248a of FIG. 12. For example, 2022 may be performed by the configuration component 2250 of the apparatus 2202 of FIG. 22.

In some examples, at 2024, the second wireless device may receive, from a third wireless device, a carrier indication indicating at least the first feedback carrier, as described in connection with the example communication flow 1300 of FIG. 13 and/or the communication flow 1400 of FIG. 14. For example, 2024 may be performed by the determination component 2252 of the apparatus 2202 of FIG. 22. For example, the second wireless device may receive a carrier indication via the RRC reconfiguration message 1326 of FIG. 13 and/or the carrier configuration message 1426 of FIG. 14. The third wireless device may include at least one of an RSU, a group lead, a cluster head, a scheduling UE, and a receiving (Rx) UE.

At 2026, the second wireless device may transmit the carrier indication to the first wireless device, as described in connection with the RRC forwarding message 1330 of FIG. 13 and/or the RRC forwarding message 1430 of FIG. 14. For example, 2026 may be performed by the configuration component 2250 of the apparatus 2202 of FIG. 22.

At 2028, the second wireless device receives a first feedback on the first feedback carrier, as described in connection with the cross-carrier feedback 1150 of FIG. 11, the first ACK/NACK message 940 on the first feedback carrier 960, and/or the first ACK/NACK message 1040 on the first feedback carrier 1060 of FIGS. 10A and 10B. For example, 2028 may be performed by a feedback component 2242 of the apparatus 2202 of FIG. 22.

At 2030, the second wireless device may receive a second feedback on a second feedback carrier, as described in connection with the second ACK/NACK message 942 on the second feedback carrier 962 and/or second first ACK/NACK message 1042 on the first feedback carrier 1060 of FIGS. 10A and 10B. For example, 2030 may be performed by the feedback component 2242 of the apparatus 2202 of FIG. 22.

At 2032, the second wireless device receives a first demapping indicator with the first feedback, as described in connection with the demapping indicator 1160 of FIG. 11, the first demapping indicator 970 of FIGS. 9A and 9B, and/or the demapping indicator 1070 of FIGS. 10A and 10B. For example, 2032 may be performed by an indicator component 2244 of the apparatus 2202 of FIG. 22.

At 2034, the second wireless device may receive a second demapping indicator with the second feedback, as described in connection with the second demapping indicator 972 of FIGS. 9A and 9B. For example, 2034 may be performed by the indicator component 2244 of the apparatus 2202 of FIG. 22.

At 2036, the second wireless device determines at least a first HARQ entity for the first TB based on the first demapping indicator, as described in connection with 1180 of FIG. 11. For example, 2036 may be performed by a demapping component 2246 of the apparatus 2202 of FIG. 22. Aspects of the determining of at least the first HARQ entity may be performed at a carrier demapping component 954 of FIG. 9A and/or the carrier demapping component 1054 of FIG. 10A. In some examples, the determining of at least the first HARQ entity may be performed at an adaptation layer (e.g., the adaptation layer 950 of FIG. 9A and/or the adaptation layer 1050 of FIG. 10A). In some examples, the determining of at least the first HARQ entity may be performed at a sub-layer of the MAC layer. In some examples, the determining of at least the first HARQ entity may be performed at a sub-layer of the PHY layer.

At 2038, the second wireless device forwards the first feedback to the first HARQ entity, as described in connection with 1180 of FIG. 11. For example, 2038 may be performed by a forwarding component 2248 of the apparatus 2202 of FIG. 22. For example, the second wireless device may forward the first ACK/NACK message 940 to the first HARQ entity 930b of FIGS. 9A and 9B and/or may forward the first ACK/NACK message 1040 to the first HARQ entity 1030b of FIGS. 10A and 10B.

At 2040, the second wireless device may determine a second HARQ entity for the second TB based on the second demapping indicator, as described in connection with 1180 of FIG. 11. For example, 2040 may be performed by the demapping component 2246 of the apparatus 2202 of FIG. 22.

At 2042, the second wireless device may forward the second feedback to the second HARQ entity, as described in connection with 1180 of FIG. 11. For example, 2042 may be performed by the forwarding component 2248 of the apparatus 2202 of FIG. 22. For example, the second wireless device may forward the second ACK/NACK message 942 to the second HARQ entity 932b of FIGS. 9A and 9B, and/or may forward the second ACK/NACK message 1042 to the first HARQ entity 1030b of FIGS. 10A and 10B.

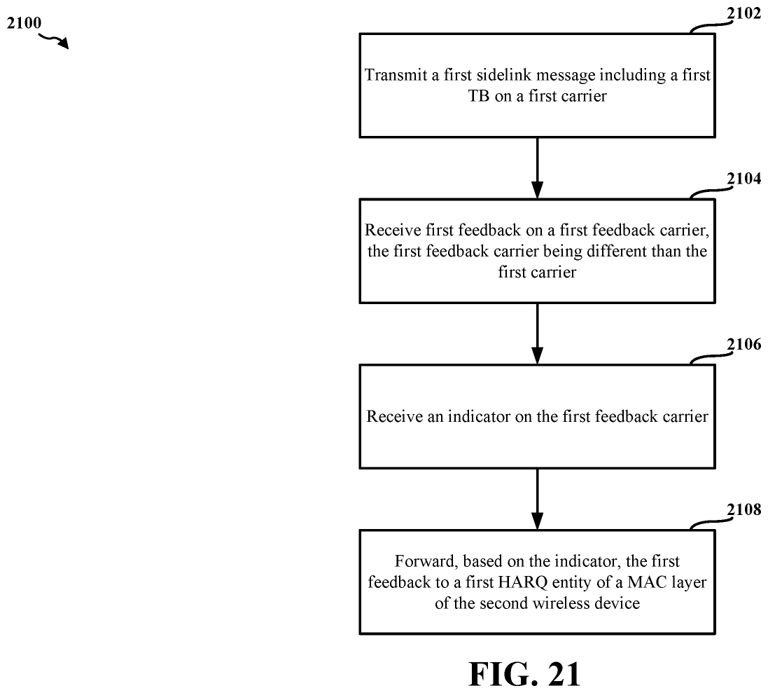

FIG. 21 is a flowchart 2100 of a method of wireless communication with a first wireless device at a second wireless device. The method may be performed by a second wireless device (e.g., the UE 104, the wireless devices 310, 350, the second wireless devices 904, 1004, 1104, 1204, 1304, 1404, and/or an apparatus 2202 of FIG. 22). The method may facilitate improving cell coverage and/or increased throughput by improving reliability and timely HARQ feedback in sidelink.

At 2102, the second wireless device transmits a first sidelink message including a first TB on a first carrier, as described in connection with sidelink message 1110 of FIG. 11, the first transport block 910 on the first carrier 920 of FIGS. 9A and 9B, and/or the first transport block 1010 on the first carrier 1020 of FIGS. 10A and 10B. For example, 1902 may be performed by a TB component 2240 of the apparatus 2202 of FIG. 22.

At 2104, the second wireless device receives a first feedback on the first feedback carrier, as described in connection with the cross-carrier feedback 1150 of FIG. 11, the first ACK/NACK message 940 on the first feedback carrier 960, and/or the first ACK/NACK message 1040 on the first feedback carrier 1060 of FIGS. 10A and 10B. For example, 2104 may be performed by a feedback component 2242 of the apparatus 2202 of FIG. 22.

At 2106, the second wireless device receives an indicator on the first feedback carrier, as described in connection with the demapping indicator 1160 of FIG. 11, the first demapping indicator 970 of FIGS. 9A and 9B, and/or the demapping indicator 1070 of FIGS. 10A and 10B. For example, 2106 may be performed by an indicator component 2244 of the apparatus 2202 of FIG. 22.

At 2108, the second wireless device forwards, based on the indicator, the first feedback to a first HARQ entity of a MAC layer of the second wireless device, as described in connection with 1180 of FIG. 11. For example, 2108 may be performed by a forwarding component 2248 of the apparatus 2202 of FIG. 22. For example, the second wireless device may forward the first ACK/NACK message 940 to the first HARQ entity 930b of FIGS. 9A and 9B, and/or may forward the first ACK/NACK message 1040 to the first HARQ entity 1030b of FIGS. 10A and 10B.

FIG. 22 is a diagram 2200 illustrating an example of a hardware implementation for an apparatus 2202. The apparatus 2202 may be a second wireless device, such as a UE, a component of a UE, or may implement UE functionality. In some aspects, the apparatus 2002 may include a cellular baseband processor 2204 (also referred to as a modem) coupled to a cellular RF transceiver 2222. In some aspects, the apparatus 2202 may further include one or more subscriber identity modules (SIM) cards 2220, an application processor 2206 coupled to a secure digital (SD) card 2208 and a screen 2210, a Bluetooth module 2212, a wireless local area network (WLAN) module 2214, a Global Positioning System (GPS) module 2216, or a power supply 2218. The cellular baseband processor 2204 communicates through the cellular RF transceiver 2222 with the UE 104 and/or base station 102/180. The cellular baseband processor 2204 may include a computer-readable medium/memory. The computer-readable medium/memory may be non-transitory. The cellular baseband processor 2204 is responsible for general processing, including the execution of software stored on the computer-readable medium/memory. The software, when executed by the cellular baseband processor 2204, causes the cellular baseband processor 2204 to perform the various functions described supra. The computer-readable medium/memory may also be used for storing data that is manipulated by the cellular baseband processor 2204 when executing software. The cellular baseband processor 2204 further includes a reception component 2230, a communication manager 2232, and a transmission component 2234. The communication manager 2232 includes the one or more illustrated components. The components within the communication manager 2232 may be stored in the computer-readable medium/memory and/or configured as hardware within the cellular baseband processor 2204. The cellular baseband processor 2204 may be a component of the UE 350 and may include the memory 360 and/or at least one of the TX processor 368, the RX processor 356, and the controller/processor 359. In one configuration, the apparatus 2202 may be a modem chip and include just the baseband processor 2204, and in another configuration, the apparatus 2202 may be the entire UE (e.g., see the UE 350 of FIG. 3) and include the additional modules of the apparatus 2202.

The communication manager 2232 includes a TB component 2240 that is configured to transmit a first sidelink message including a first TB on a first carrier, for example, as described in connection with 1902 of FIG. 19 and/or 2002 of FIG. 20. The example TB component 2240 may also be configured to transmit a second sidelink message including a second TB on a second carrier, for example, as described in connection with 2004 of FIG. 20. The example TB component 2240 may also be configured to transmit, to the first wireless device, a first sidelink message including a first TB on a first carrier, for example, as described in connection with 2102 of FIG. 21.

The communication manager 2232 also includes a feedback component 2242 that is configured to receive a first feedback on the first feedback carrier, for example, as described in connection with 1904 of FIG. 19 and/or 2028 of FIG. 20. The example feedback component 2242 may also be configured to receive a second feedback on a second feedback carrier, for example, as described in connection with 2030 of FIG. 20. The example feedback component 2242 may also be configured to receive, from the first wireless device, first feedback on a first feedback carrier, the first feedback carrier being different than the first carrier, for example, as described in connection with 2104 of FIG. 21.

The communication manager 2232 also includes an indicator component 2244 that is configured to receive a first demapping indicator with the first feedback, for example, as described in connection with 1906 of FIG. 19 and/or 2032 of FIG. 20. The example indicator component 2244 may also be configured to receive a second demapping indicator with the second feedback, for example, as described in connection with 2034 of FIG. 20. The example indicator component 2244 may also be configured to receive, from the first wireless device, an indicator on the first feedback carrier, the indicator indicating at least one of the first TB and the first carrier associated with the first feedback, for example, as described in connection with 2106 of FIG. 21.

The communication manager 2232 also includes a demapping component 2246 that is configured to determine at least a first HARQ entity for the first TB based on the first demapping indicator, for example, as described in connection with 1908 of FIG. 19 and/or 2036 of FIG. 20. The example demapping component 2246 may also be configured to determine a second HARQ entity for the second TB based on the second demapping indicator, for example, as described in connection with 2040 of FIG. 20.

The communication manager 2232 also includes a forwarding component 2248 that is configured to forward the first feedback to the first HARQ entity, for example, as described in connection with 1910 of FIG. 19 and/or 2038 of FIG. 20. The example forwarding component 2248 may also be configured to forward the second feedback to the second HARQ entity, for example, as described in connection with 2042 of FIG. 20. The example forwarding component 2248 may also be configured to forward, based on the indicator, the first feedback to a first HARQ entity of a MAC layer of the second wireless device, the first HARQ entity associated with processing of the first TB on the first carrier, for example, as described in connection with 2108 of FIG. 21.

The communication manager 2232 also includes a configuration component 2250 that is configured to configure or activate at least a first feedback carrier, for example, as described in connection with 2006 of FIG. 20. The example configuration component 2250 may also be configured to transmit a carrier indication indicating the first feedback carrier, for example, as described in connection with 2008 of FIG. 20. The example configuration component 2250 may also be configured to transmit a carrier configuration including the list of sidelink carriers including at least the first feedback carrier, for example, as described in connection with 2014 of FIG. 20. The example configuration component 2250 may also be configured to transmit an activation indication to the first wireless device with at least the first feedback carrier, for example, as described in connection with 2020 of FIG. 20. The example configuration component 2250 may also be configured to transmit a deactivation indication to the first wireless device with at least one activated feedback carrier, for example, as described in connection with 2022 of FIG. 20. The example configuration component 2250 may also be configured to transmit the carrier indication to the first wireless device, for example, as described in connection with 2026 of FIG. 20.

The communication manager 2232 also includes a determination component 2252 that is configured to receive capability information, for example, as described in connection with 2010 of FIG. 20. The example determination component 2252 may also be configured to determine a list of sidelink carriers based on the capability information, for example, as described in connection with 2012 of FIG. 20. The example determination component 2252 may also be configured to receive sidelink carrier information, for example, as described in connection with 2016 of FIG. 20. The example determination component 2252 may also be configured to measure characteristics associated with carrier candidates based on the sidelink carrier information, for example, as described in connection with 2018 of FIG. 20. The example determination component 2252 may also be configured to receive, from a third wireless device, a carrier indication indicating at least the first feedback carrier, for example, as described in connection with 2024 of FIG. 20.

The apparatus may include additional components that perform each of the blocks of the algorithm in the flowcharts of FIGS. 19, 20, and/or 21. As such, each block in the flowcharts of FIGS. 18, 19, and/or 20 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 2202 may include a variety of components configured for various functions. In one configuration, the apparatus 2202, and in particular the cellular baseband processor 2204, includes means for transmitting a first sidelink message including a first TB on a first carrier to the first wireless device. The example apparatus 2202 also includes means for receiving a first feedback on a first feedback carrier. The example apparatus 2202 also includes means for receiving a first demapping indicator with the first feedback from the first wireless device. The example apparatus 2202 also includes means for determining at least a first HARQ entity for the first TB based on the first demapping indicator. The example apparatus 2202 also includes means for forwarding the first feedback to the first HARQ entity of a MAC layer of the second wireless device.

In another configuration, the example apparatus 2202 also includes means for transmitting, to the first wireless device, a second sidelink message including a second TB on a second carrier. The example apparatus 2202 also includes means for receiving a second feedback on a second feedback carrier. The example apparatus 2202 also includes means for receiving a second demapping indicator with the second feedback from the first wireless device. The example apparatus 2202 also includes means for determining a second HARQ entity for the second TB based on the second demapping indicator. The example apparatus 2202 also includes means for forwarding the second feedback to the second HARQ entity of the MAC layer of the second wireless device.

In another configuration, the example apparatus 2202 also includes means for transmitting, via at least one of the first TB and the second TB, a carrier indication indicating the first feedback carrier for cross-carrier feedback.

In another configuration, the example apparatus 2202 also includes means for receiving capability information from the first wireless device. The example apparatus 2202 also includes means for determining a list of sidelink carriers based on the capability information. The example apparatus 2202 also includes means for transmitting, to the first wireless device, a carrier configuration including the list of sidelink carriers including at least the first feedback carrier.

In another configuration, the example apparatus 2202 also includes means for receiving, from the first wireless device, sidelink carrier information. The example apparatus 2202 also includes means for measuring characteristics associated with carrier candidates based on the sidelink carrier information, the carrier candidates including at least the first feedback carrier. The example apparatus 2202 also includes means for transmitting an activation indication to the first wireless device with at least the first feedback carrier for cross-carrier feedback based on measured characteristics. The example apparatus 2202 also includes means for transmitting a deactivation indication to the first wireless device with at least one activated feedback carrier for the cross-carrier feedback.

In another configuration, the example apparatus 2202 also includes means for receiving, from a third wireless device, a carrier indication indicating at least the first feedback carrier, wherein the third wireless device may include at least one of an RSU, a group lead, a cluster head, a scheduling UE, and a receiving (Rx) UE. The example apparatus 2202 also includes means for transmitting the carrier indication to the first wireless device for cross-carrier feedback.

In another configuration, the apparatus 2202, and in particular the cellular baseband processor 2204, includes means for transmitting, to the first wireless device, a first sidelink message including a first TB on a first carrier. The example apparatus 2202 also includes means for receiving, from the first wireless device, first feedback on a first feedback carrier, the first feedback carrier being different than the first carrier. The example apparatus 2202 also includes means for receiving, from the first wireless device, an indicator on the first feedback carrier, the indicator indicating at least one of the first TB and the first carrier associated with the first feedback. The example apparatus 2202 also includes means for forwarding, based on the indicator, the first feedback to a first HARQ entity of a MAC layer of the second wireless device, the first HARQ entity associated with processing of the first TB on the first carrier.

The means may be one or more of the components of the apparatus 2202 configured to perform the functions recited by the means. As described supra, the apparatus 2202 may include the TX processor 368, the RX processor 356, and the controller/processor 359. As such, in one configuration, the means may be the TX processor 368, the RX processor 356, and the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.
Aspect 1 is an apparatus for wireless communication at a first wireless device including at least one processor coupled to a memory and configured to receive, from a second wireless device, a first sidelink message including a first TB on a first carrier; generate a first HARQ feedback for the first TB; map the first HARQ feedback for the first TB to a first feedback carrier, the first feedback carrier being different than the first carrier, first feedback carrier to transmit cross-carrier feedback; and transmit the first HARQ feedback on the first feedback carrier to the second wireless device.
Aspect 2 is the apparatus of aspect 1, further including that the memory and the at least one processor are further configured to: receive, from the second wireless device, a second sidelink message including a second TB on a second carrier; generate a second HARQ feedback for the second TB; map the second HARQ feedback for the second TB to a second feedback carrier, the second feedback carrier being different than the second carrier; and transmit the second HARQ feedback on the second feedback carrier to the second wireless device.
Aspect 3 is the apparatus of any of aspects 1 and 2, further including that the second feedback carrier is different than the first feedback carrier.
Aspect 4 is the apparatus of any of aspects 1 to 3, further including that the second feedback carrier and the first feedback carrier are a same feedback carrier.
Aspect 5 is the apparatus of any of aspects 1 to 4, further including that to transmit the second HARQ feedback on the second feedback carrier, the memory and the at least one processor are configured to: aggregate the second HARQ feedback with the first HARQ feedback on the first feedback carrier or the second feedback carrier.
Aspect 6 is the apparatus of any of aspects 1 to 5, further including that the memory and the at least one processor are configured to: transmit a demapping indicator with the first HARQ feedback associated with the first TB.
Aspect 7 is the apparatus of any of aspects 1 to 6, further including a sub-layer of a MAC layer to map the first HARQ feedback for the first TB to the first feedback carrier.
Aspect 8 is the apparatus of any of aspects 1 to 6, further including a sub-layer of a PHY layer to map the first HARQ feedback for the first TB to the first feedback carrier.
Aspect 9 is the apparatus of any of aspects 1 to 8, further including that the memory and the at least one processor are configured to transmit the cross-carrier feedback.
Aspect 10 is the apparatus of any of aspects 1 to 9, further including that the memory and the at least one processor are configured to: receive a carrier configuration to configure the first wireless device with at least the first feedback carrier for the cross-carrier feedback to facilitate determining the first feedback carrier.
Aspect 11 is the apparatus of any of aspects 1 to 10, further including that the memory and the at least one processor are configured to: receive a carrier activation indication associated with at least the first feedback carrier for the cross-carrier feedback to facilitate determining the first feedback carrier.
Aspect 12 is the apparatus of any of aspects 1 to 11, further including that the memory and the at least one processor are configured to receive the carrier activation indication via a MAC-CE.
Aspect 13 is the apparatus of any of aspects 1 to 12, further including that the memory and the at least one processor are configured to: receive a deactivation indication associated with at least one activated feedback carrier for the cross-carrier feedback.
Aspect 14 is the apparatus of any of aspects 1 to 13, further including that the memory and the at least one processor are configured to receive the carrier activation indication from at least one of: an RSU, a group lead device, a cluster lead device, a scheduling device, the second wireless device, and the first wireless device.
Aspect 15 is the apparatus of any of aspects 1 to 14, further including that the memory and the at least one processor are configured to: receive, from the second wireless device, a carrier indication indicating at least the first feedback carrier for the cross-carrier feedback, the carrier indication received via the first TB to facilitate determining the first feedback carrier.
Aspect 16 is the apparatus of any of aspects 1 to 15, further including that the memory and the at least one processor are configured to receive the carrier indication via SCI associated with the first TB.
Aspect 17 is the apparatus of any of aspects 1 to 16, further including that the memory and the at least one processor are configured to: receive, from a third wireless device, a carrier indication indicating at least the first feedback carrier for the cross-carrier feedback to facilitate determining the first feedback carrier, wherein the third wireless device includes at least one of an RSU, a group lead, a cluster head, a scheduling UE, a receiving UE, and an FRU.
Aspect 18 is the apparatus of any of aspects 1 to 17, further including that the.
Aspect 19 is the apparatus of any of aspects 1 to 18, further including a transceiver coupled to the at least one processor.
Aspect 20 is a method of wireless communication for implementing any of aspects 1 to 19.
Aspect 21 is an apparatus for wireless communication including means for implementing any of aspects 1 to 19.
Aspect 22 is a non-transitory computer-readable storage medium storing computer executable code, where the code, when executed, causes a processor to implement any of aspects 1 to 19.
Aspect 23 is an apparatus for wireless communication with a first wireless device at a second wireless device including at least one processor coupled to a memory and configured to transmit a first sidelink message including a first TB on a first carrier to the first wireless device; receive a first feedback on a first feedback carrier; receive a first demapping indicator with the first feedback from the first wireless device; and forward, based on the demapping indicator, the first feedback to a first HARQ entity of a MAC layer of the second wireless device.
Aspect 24 is the apparatus of aspect 23, further including that the memory and the at least one processor are configured to: transmit, to the first wireless device, a second sidelink message including a second TB on a second carrier; receive a second feedback on a second feedback carrier; receive a second demapping indicator with the second feedback from the first wireless device; and forward, based on the second demapping indicator, the second feedback to a second HARQ entity of the MAC layer of the second wireless device.
Aspect 25 is the apparatus of any of aspects 23 and 24, further including that the memory and the at least one processor are configured to: transmit, via at least one of the first TB and the second TB, a carrier indication indicating the first feedback carrier for cross-carrier feedback.
Aspect 26 is the apparatus of any of aspects 23 to 25, further including that the memory and the at least one processor are configured to transmit the carrier indication via sidelink control information.
Aspect 27 is the apparatus of any of aspects 23 to 26, further including that the memory and the at least one processor are configured to transmit the carrier indication via a MAC-CE.
Aspect 28 is the apparatus of any of aspects 23 to 27, further including a sub-layer of the MAC layer to determine at least the first HARQ entity.
Aspect 29 is the apparatus of any of aspects 23 to 27, further including a PHY layer to determine at least the first HARQ entity is performed at a sub-layer of.
Aspect 30 is the apparatus of any of aspects 23 to 29, further including that the memory and the at least one processor are configured to receive cross-carrier feedback on the first feedback carrier.
Aspect 31 is the apparatus of any of aspects 23 to 30, further including that the memory and the at least one processor are configured to: receive capability information from the first wireless device; determine a list of sidelink carriers based on the capability information; and transmit, to the first wireless device, a carrier configuration including the list of sidelink carriers including at least the first feedback carrier.
Aspect 32 is the apparatus of any of aspects 23 to 31, further including that the memory and the at least one processor are configured to determine the list of sidelink carriers based on received capability information with at least one carrier.
Aspect 33 is the apparatus of any of aspects 23 to 32, further including that the memory and the at least one processor are configured to determine the list of sidelink carriers based on measuring characteristics associated with at least one candidate carrier indicated by the capability information.
Aspect 34 is the apparatus of any of aspects 23 to 33, further including that the memory and the at least one processor are configured to transmit the carrier configuration via RRC signaling.
Aspect 35 is the apparatus of any of aspects 23 to 34, further including that the memory and the at least one processor are configured to: receive, from the first wireless device, sidelink carrier information; measure characteristics associated with carrier candidates based on the sidelink carrier information, the carrier candidates including at least the first feedback carrier; and transmit an activation indication to the first wireless device with at least the first feedback carrier for cross-carrier feedback based on the measured characteristics.
Aspect 36 is the apparatus of any of aspects 23 to 35, further including that the memory and the at least one processor are configured to: transmit a deactivation indication to the first wireless device with at least one activated feedback carrier for the cross-carrier feedback.
Aspect 37 is the apparatus of any of aspects 23 to 36, further including that the memory and the at least one processor are configured to transmit the activation indication via a MAC-CE.
Aspect 38 is the apparatus of any of aspects 23 to 37, further including that the memory and the at least one processor are configured to: receive, from a third wireless device, a carrier indication indicating at least one feedback carrier, wherein the third wireless device may include at least one of an RSU, a group lead, a cluster head, a scheduling UE, and a receiving UE; and transmit the carrier indication to the first wireless device for cross-carrier feedback.
Aspect 39 is the apparatus of any of aspects 23 to 38, further including that a transceiver coupled to the at least one processor.
Aspect 40 is a method of wireless communication for implementing any of aspects 23 to 39.
Aspect 41 is an apparatus for wireless communication including means for implementing any of aspects 23 to 39.
Aspect 42 is a non-transitory computer-readable storage medium storing computer executable code, where the code, when executed, causes a processor to implement any of aspects 23 to 39.
Aspect 43 is an apparatus for wireless communication at a first wireless device including at least one processor coupled to a memory and configured to receive, from a second wireless device, a first sidelink message including a first TB on a first carrier; transmit, to the second wireless device on a first feedback carrier, a first HARQ feedback for the first TB, the first feedback carrier being different than the first carrier; and transmit, to the second wireless device, an indicator on the first feedback carrier, the indicator indicating at least one of the first TB and the first carrier associated with the first TB.
Aspect 44 is the apparatus of aspect 43, further including a transceiver coupled to the at least one processor.
Aspect 45 is a method of wireless communication for implementing any of aspects 43 to 44.
Aspect 46 is an apparatus for wireless communication including means for implementing any of aspects 43 to 44.
Aspect 47 is a non-transitory computer-readable storage medium storing computer executable code, where the code, when executed, causes a processor to implement any of aspects 43 to 44.
Aspect 48 is an apparatus for wireless communication with a first wireless device at a second wireless device including at least one processor coupled to a memory and configured to transmit, to the first wireless device, a first sidelink message including a first TB on a first carrier; receive, from the first wireless device, first feedback on a first feedback carrier, the first feedback carrier being different than the first carrier; receive, from the first wireless device, an indicator on the first feedback carrier, the indicator indicating at least one of the first TB and the first carrier associated with the first feedback; and forward, based on the indicator, the first feedback to a first HARQ entity of a MAC layer of the second wireless device, the first HARQ entity associated with processing of the first TB on the first carrier.
Aspect 49 is the apparatus of aspect 48, further including a transceiver coupled to the at least one processor.
Aspect 50 is a method of wireless communication for implementing any of aspects 48 to 49.
Aspect 51 is an apparatus for wireless communication including means for implementing any of aspects 48 to 49.
Aspect 52 is a non-transitory computer-readable storage medium storing computer executable code, where the code, when executed, causes a processor to implement any of aspects 48 to 49.

What is claimed is:

1. An apparatus for wireless communication at a first wireless device, comprising:
a memory; and
at least one processor coupled to the memory, the memory and the at least one processor configured to:
receive, from a second wireless device, a first sidelink message including a first transport block (TB) on a first carrier;
generate a first Hybrid Automatic Repeat Request (HARQ) feedback for the first TB;
map the first HARQ feedback for the first TB to a first feedback carrier, the first feedback carrier being different than the first carrier, first feedback carrier to transmit cross-carrier feedback; and
transmit the first HARQ feedback on the first feedback carrier to the second wireless device.

2. The apparatus of claim 1, wherein the memory and the at least one processor are further configured to:
receive, from the second wireless device, a second sidelink message including a second TB on a second carrier;
generate a second HARQ feedback for the second TB;
map the second HARQ feedback for the second TB to a second feedback carrier, the second feedback carrier being different than the second carrier; and
transmit the second HARQ feedback on the second feedback carrier to the second wireless device.

3. The apparatus of claim 2, wherein the second feedback carrier is different than the first feedback carrier.

4. The apparatus of claim 2, wherein the second feedback carrier and the first feedback carrier are a same feedback carrier.

5. The apparatus of claim 2, wherein to transmit the second HARQ feedback on the second feedback carrier, the memory and the at least one processor are configured to:
aggregate the second HARQ feedback with the first HARQ feedback on the first feedback carrier or the second feedback carrier.

6. The apparatus of claim 1, wherein the memory and the at least one processor are configured to:
transmit a demapping indicator with the first HARQ feedback associated with the first TB.

7. The apparatus of claim 1, further comprising a sub-layer of a medium access control (MAC) layer to map the first HARQ feedback for the first TB to the first feedback carrier.

8. The apparatus of claim 1, further comprising a sub-layer of a physical (PHY) layer to map the first HARQ feedback for the first TB to the first feedback carrier.

9. The apparatus of claim 1, wherein the memory and the at least one processor are configured to:
receive a carrier configuration to configure the first wireless device with at least the first feedback carrier for the cross-carrier feedback to facilitate determining the first feedback carrier.

10. The apparatus of claim 1, wherein the memory and the at least one processor are configured to:
receive a carrier activation indication associated with at least the first feedback carrier for the cross-carrier feedback to facilitate determining the first feedback carrier.

11. The apparatus of claim 10, wherein the memory and the at least one processor are configured to:
receive a deactivation indication associated with at least one activated feedback carrier for the cross-carrier feedback.

12. The apparatus of claim 1, wherein, the memory and the at least one processor are configured to:
receive, from the second wireless device, a carrier indication indicating at least the first feedback carrier for the cross-carrier feedback, the carrier indication received via the first TB to facilitate determining the first feedback carrier.

13. The apparatus of claim 12, wherein the memory and the at least one processor are configured to receive the carrier indication via sidelink control information (SCI) associated with the first TB.

14. The apparatus of claim 1, wherein the memory and the at least one processor are configured to:
receive, from a third wireless device, a carrier indication indicating at least the first feedback carrier for the cross-carrier feedback to facilitate determining the first feedback carrier, wherein the third wireless device includes at least one of a roadside unit (RSU), a group lead, a cluster head, a scheduling user equipment (UE), a receiving (Rx) UE, and a field replaceable unit (FRU).

15. The apparatus of claim 1, further comprising a transceiver coupled to the at least one processor.

16. An apparatus for wireless communication with a first wireless device at a second wireless device, comprising:
a memory; and
at least one processor coupled to the memory, the memory and the at least one processor configured to:
transmit a first sidelink message including a first transport block (TB) on a first carrier to the first wireless device;
receive a first feedback on a first feedback carrier;
receive a first demapping indicator with the first feedback from the first wireless device; and
forward, based on the demapping indicator, the first feedback to a first HARQ entity of a medium access control (MAC) layer of the second wireless device.

17. The apparatus of claim 16, wherein the memory and the at least one processor are configured to:
transmit, to the first wireless device, a second sidelink message including a second TB on a second carrier;
receive a second feedback on a second feedback carrier;
receive a second demapping indicator with the second feedback from the first wireless device; and
forward, based on the second demapping indicator, the second feedback to a second HARQ entity of the MAC layer of the second wireless device.

18. The apparatus of claim 17, wherein the memory and the at least one processor are configured to:
transmit, via at least one of the first TB and the second TB, a carrier indication indicating the first feedback carrier for cross-carrier feedback.

19. The apparatus of claim 16, further comprising a sub-layer of the MAC layer to determine at least the first HARQ entity.

20. The apparatus of claim 16, further comprising a physical (PHY) layer to determine at least the first HARQ entity is performed at a sub-layer of.

21. The apparatus of claim 16, wherein the memory and the at least one processor are configured to receive cross-carrier feedback on the first feedback carrier.

22. The apparatus of claim 16, wherein the memory and the at least one processor are configured to:
receive capability information from the first wireless device;
determine a list of sidelink carriers based on the capability information; and
transmit, to the first wireless device, a carrier configuration including the list of sidelink carriers including at least the first feedback carrier.

23. The apparatus of claim 16, wherein the memory and the at least one processor are configured to:
receive, from the first wireless device, sidelink carrier information;
measure characteristics associated with carrier candidates based on the sidelink carrier information, the carrier candidates including at least the first feedback carrier; and
transmit an activation indication to the first wireless device with at least the first feedback carrier for cross-carrier feedback based on the measured characteristics.

24. The apparatus of claim 23, wherein the memory and the at least one processor are configured to:
transmit a deactivation indication to the first wireless device with at least one activated feedback carrier for the cross-carrier feedback.

25. The apparatus of claim 16, wherein the memory and the at least one processor are configured to:
receive, from a third wireless device, a carrier indication indicating at least one feedback carrier, wherein the third wireless device may include at least one of a roadside unit (RSU), a group lead, a cluster head, a scheduling user equipment (UE), and a receiving (Rx) UE; and
transmit the carrier indication to the first wireless device for cross-carrier feedback.

26. The apparatus of claim 16, further comprising a transceiver coupled to the at least one processor.

27. An apparatus for wireless communication at a first wireless device, comprising:
a memory; and
at least one processor coupled to the memory, the memory and the at least one processor configured to:
receive, from a second wireless device, a first sidelink message including a first transport block (TB) on a first carrier;
transmit, to the second wireless device on a first feedback carrier, a first Hybrid Automatic Repeat Request (HARQ) feedback for the first TB, the first feedback carrier being different than the first carrier; and
transmit, to the second wireless device, an indicator on the first feedback carrier, the indicator indicating at least one of the first TB and the first carrier associated with the first TB.

28. The apparatus of claim 27, further comprising a transceiver coupled to the at least one processor.

29. An apparatus for wireless communication with a first wireless device at a second wireless device, comprising:
a memory; and
at least one processor coupled to the memory, the memory and the at least one processor configured to:
transmit, to the first wireless device, a first sidelink message including a first transport block (TB) on a first carrier;
receive, from the first wireless device, first feedback on a first feedback carrier, the first feedback carrier being different than the first carrier;
receive, from the first wireless device, an indicator on the first feedback carrier, the indicator indicating at least one of the first TB and the first carrier associated with the first feedback; and
forward, based on the indicator, the first feedback to a first Hybrid Automatic Repeat Request (HARQ) entity of a medium access control (MAC) layer of the second wireless device, the first HARQ entity associated with processing of the first TB on the first carrier.

30. The apparatus of claim 29, further comprising a transceiver coupled to the at least one processor.
